(19) United States
(12) Patent Application Publication
(10) Pub. No.: US 2012/0238363 A1
(43) Pub. Date: Sep. 20, 2012

(54) INFORMATION PROCESSING SYSTEM, INFORMATION PROCESSING APPARATUS, STORAGE MEDIUM HAVING INFORMATION PROCESSING PROGRAM STORED THEREIN, AND IMAGE DISPLAY METHOD

(75) Inventors: Atsushi WATANABE, Kyoto-shi (JP); Eizi KAWAI, Kyoto-shi (JP)

(73) Assignee: NINTENDO CO., LTD., Kyoto (JP)

(21) Appl. No.: 13/352,103

(22) Filed: Jan. 17, 2012

(30) Foreign Application Priority Data
Mar. 16, 2011 (JP) 2011-057705

(51) Int. Cl. A63F 13/00

(52) U.S. Cl. 463/31

(57) ABSTRACT

An example game system includes a stationary game apparatus and a terminal device allowing a user to perform an input operation. The game apparatus is capable of connecting to a network and communicates with a predetermined external device via the network. An image included in reception data obtained via communication is outputted to a television. In addition, the game apparatus outputs an operation image for use in an operation related to the image to the terminal device. The game apparatus acquires operation data representing an operation on the operation image from the terminal device. The game apparatus executes information processing related to an image displayed on the television, on the basis of the operation data.

### CROSS REFERENCE TO RELATED APPLICATION

The disclosure of Japanese Patent Application No. 2011-057705, filed Mar. 16, 2011, is incorporated herein by reference.

### FIELD

Disclosed herein are information processing systems, information processing apparatuses, storage media having stored information processing programs therein, and image display methods, which are intended to output images to two display devices.

### BACKGROUND AND SUMMARY

There is a conventional technology for viewing Web pages or suchlike acquired via the Internet on a television. Conventionally, it is possible, for example, that a game apparatus accesses the Internet, and displays Web pages on the Internet on a television. As a result, the user can view Web pages on a television whose screen is larger than the monitor for use with a general personal computer. For example, by displaying Web pages, including video and still images, on a television, it is rendered possible even for a plurality of viewers to readily see the images, and it is also rendered possible to provide powerful images.

The aforementioned technology simply displays Web pages on a television, and in some cases, it might not be possible to provide appropriate images which can be readily viewed, thereby allowing easy operation.

Therefore, the information processing systems, information processing apparatuses, information processing programs, and image display methods as disclosed herein are intended to provide images that can be viewed more readily and allow the user to readily perform image-related operations.

(1) An example information processing system described herein includes a stationary information processing apparatus and a portable display device allowing a user to perform an input operation.

The information processing apparatus includes a communication unit, a first image output unit, a second image output unit, an operation data acquisition unit, and an information processing unit. The communication unit is connectable to a network and communicates with a predetermined external device via the network. The first image output unit outputs an image to a predetermined display device different from the portable display device, the image being included in reception data obtained by the communication unit. The second image output unit outputs an operation image to the portable display device, the operation image being used for performing an operation related to the image. The operation data acquisition unit acquires operation data from the portable display device, the operation data representing an operation on the operation image. The information processing unit executes information processing related to an image displayed on the predetermined display device, on the basis of the operation data.

The portable display device includes an operation data transmission unit, a second image reception unit, and a display unit. The operation data transmission unit transmits data outputted by an operation unit provided in the portable display device as the operation data. The second image reception unit receives the operation image from the information processing apparatus. The display unit displays the received operation image.

The “information processing apparatus” may be a game apparatus in an example embodiment to be described later, or may be a multipurpose information processing apparatus such as a general personal computer.

The “portable display device” is a device having the function of outputting operation data to the information processing apparatus, receiving images from the information processing apparatus, and displaying the received images. Note that the term “portable” is intended to mean a size that allows the user to hold and move the device or arbitrarily change the position of the device.

The “predetermined external device” is a device capable of communicating with the information processing apparatus via the network and providing images to a game apparatus 3. For example, the “predetermined external device” may be a Web server, or a personal computer or suchlike which communicates with the information processing apparatus.

The “predetermined display device”, as a concept, encompasses any display device, including a television in the example embodiment to be described later.

The “operation related to the image” is an operation related to the image displayed on the predetermined display device. For example, the “operation related to the image” may be an operation to select the image displayed on the predetermined display device, an operation to enlarge/reduce the image, an operation to play back or pause a video (when the “image” is a video), or an operation to save the image.

The “operation image” is an image to be used for the “image-related operation”. For example, the “operation image” may be a button image for performing some operation on an image displayed on the predetermined display device, or an image including thumbnails of images to be displayed on the predetermined display device.

The “operation on an operation image”, as a concept, encompasses an operation to touch the screen on which the operation image is displayed (when the screen is provided with a touch panel), and an operation to specify a position in an operation image with a cursor.

The “information processing related to an image” encompasses, for example, processing for selecting an image to be displayed on the predetermined display device, processing for playing or pausing a video, and processing for enlarging/reducing an image.

According to the above configuration (1), an image is displayed on the predetermined display device, and an operation image related to that image is displayed on the portable display device. Accordingly, by using a device with a relatively large screen as the predetermined display device, the user can more readily view an image displayed on the predetermined display device in a form suitable for a plurality of viewers. Moreover, any operation-related image is displayed on the portable display device, and therefore, it is possible to provide that image to the user without distracting any viewer's attention from the image displayed on the predetermined display device. In addition, any operation related to the image displayed on the predetermined display device is performed using the portable display device, and therefore, the user can readily perform the operation using the portable display device at hand.

Furthermore, according to the above configuration (1), the portable display device can simply have the function of receiving and displaying images, and may just function as a so-called thin client terminal. Accordingly, synchronized processing dose not occur, resulting in simplified information processing. Therefore, an application (program) to be executed in the information processing apparatus can be readily created. In addition, even if information processing is rendered complicated, processing load on the portable display device does not change, and therefore, the portable display device can dispense with any high-level information processing capability. Thus, it is possible to readily reduce the size and the weight of the portable display device to be held in hand during use and thereby to facilitate easy production, resulting in reduced cost.

(2) The communication unit may receive data representing a plurality of types of images. In this case, the second image output unit outputs an operation image including the plurality of types of images to the portable display device. The information processing unit performs as the information processing a process for selecting one of the plurality of types of images that is to be displayed on the predetermined display device on the basis of the operation data. The communication unit transmits an acquisition request for the image selected by the information processing unit to the external device, and receives data for the image transmitted by the external device in response to the request. The first image output unit outputs the selected image to the predetermined display device.

The “operation image representing a plurality of types of images” is an image which includes certain information representing the plurality of types of images. For example, the “operation image representing a plurality of types of images” may be an operation image including the images themselves, an operation image including thumbnails of the images, or an operation image including information for identifying the images (e.g., titles and identification numbers).

According to the above configuration (2), the portable display device displays an operation image representing a plurality of types of images, and the user can perform an operation to specify an image to be displayed on the predetermined display device from among the plurality of types of images represented by the operation image. Thus, by using a terminal device 7, the user can readily perform an operation to select an image to be displayed on the predetermined display device.

(3) The information processing unit may acquire a search keyword entered by the user, on the basis of the operation data. In this case, the communication unit transmits the acquired search keyword to the external device and receives data representing the plurality of types of images from the external device as search result data for the search keyword. When the search result data is received, the second image output unit outputs an operation image including the plurality of types of images as an image representing search results.

According to the above configuration (3), by using the portable display device, the user can confirm search results for the image to be displayed on the predetermined display device. Moreover, the user performs an operation to select an image included in the search results, so that the selected image is displayed on the predetermined display device. Thus, the operation to select an image desired to be displayed from among search results can be rendered more user-friendly.

(4) The communication unit may acquire data representing a plurality of types of videos from a server having videos stored therein. In this case, when the data representing a plurality of types of videos is acquired, the second image output unit outputs an operation image including the plurality of types of videos to the portable display device. The communication unit makes an acquisition request to the server for a video selected by the information processing and receives data for that video from the server. The first image output unit outputs the received video to the predetermined display device. When the received video is outputted to the predetermined display device, the second image output unit outputs an operation image at least representing an operation related to play of the video to the portable display device.

The “operation related to play of the video” is an operation to, for example, play, pause, fast-forward, rewind, or stop the video.

According to the above configuration (4), a video acquired from a server for providing videos can be played using the predetermined display device. In addition, when the video is played, the user can perform an operation related to play of the video using the portable display device, and such an operation can be readily performed.

(5) The information processing unit may execute the process for selecting a video to be displayed on the predetermined display device, whether or not the first image output unit is outputting any video to the predetermined display device. In this case, the communication unit transmits an acquisition request for the video selected by the information processing unit to the external device, and receives data for the video transmitted by the external device in response to the request. When the communication unit receives data for a video while another video is being outputted to the predetermined display device, the first image output unit starts outputting the video received by the communication unit after completion of the output of the video to the predetermined display device.

According the above configuration (5), while a video is being played on the predetermined display device, an acquisition request for another video can be generated. Once data for that video is received, the video is played after the video currently being played. Thus, according the above configuration (5), while a video is being played, the user can select a video to be played next, and set a timer to play the video. Thus, enhanced user-friendliness can be ensured for video play operations.

(6) The communication unit may receive data representing a plurality of product images from a server having stored therein information about a plurality of products. In this case, the second image output unit outputs an operation image including the product images to the portable display device. The information processing unit selects one of the product images that is to be displayed on the predetermined display device. The first image output unit outputs the selected product image to the predetermined display device.

According to the above configuration (6), a product image to be displayed on the predetermined display device is selected from among a plurality of product images, and the selected product image is displayed on the predetermined display device. Thus, according to the above configuration (6), for example, a product image acquired from a server of a shopping site or suchlike can be presented on the predetermined display device so that the user can view the image more readily, and the user can also readily perform an operation related to the image using the portable display device.

(7) The information processing unit may allow predetermined information for product purchase to be inputted. In this case, the second image output unit outputs an image including the inputted information to the portable display device.

The “predetermined information for product purchase”, as a concept, encompasses various information to be inputted for product purchase by the user, e.g., the user's ID, password, credit card number, and so on.

According to the above configuration (7), for example, when a product is purchased at a shopping site, predetermined information to be inputted for product purchase is displayed on the portable display device. Here, the predetermined information is information not to be revealed to any third party, and therefore, according to the above configuration (7), the predetermined information is displayed on the portable display device so that only the user who is the purchaser can see the information. Thus, the user can securely shop at the shopping site without any third party seeing the predetermined information.

(8) The portable display device may include a camera. In this case, the communication unit receives a video recorded by a camera included in an external device, and transmits a video recorded by the camera of the portable display device to the external device.

According to the above configuration (8), the information processing apparatus is capable of exchanging videos with external devices. That is, according to the above configuration (8), for example, the above configuration (1) can be applied to a system, such as a videophone system, in which images are exchanged with another device, so that a video from another device can be presented so as to be more readily viewed, and video-related operations can be readily performed.

(9) The communication unit may communicate with a plurality of external devices via the network, and receive a video from each of the external devices. In this case, the first image output unit outputs an image including the video received from each of the external devices.

According to the above configuration (9), it is possible to exchange videos with a plurality of external devices at the same time. Moreover, by using a device with a large screen as the predetermined display device, videos from the external devices can be presented so as to be readily viewed.

(10) The communication unit may receive a predetermined image and data for character information associated with the predetermined image. In this case, the first image output unit outputs the predetermined image to the predetermined display device. The second image output unit outputs an operation image including the character information to the portable display device.

According to the above configuration (10), the predetermined display device displays a predetermined image, and the portable display device displays character information associated with the predetermined image. Thus, by using the portable display device, the user can smoothly explain and discuss images displayed on the predetermined display device. Moreover, with the portable display device, it is possible to readily perform operations related to the predetermined image displayed on the predetermined display device (and the character information displayed on the portable display device).

(11) When the first image output unit outputs an image to the predetermined display device, the information processing unit may control the predetermined display device before the image is outputted, so that the predetermined display device is able to display the image.

According to the above configuration (11), before an image is outputted to the predetermined display device, the predetermined display device is controlled so as to be able to display the image. Accordingly, the user is not caused to manipulate the predetermined display device, resulting in an easier operation being performed to display an image on the predetermined display device.

(12) The predetermined display device may be capable of receiving television broadcasting and displaying video of a television broadcast. In this case, the communication unit receives data for a television program guide from the predetermined external device. The second image output unit outputs an operation image including the received program guide to the portable display device. The information processing unit selects a program in the program guide included in the operation image on the basis of the operation data, and controls the predetermined display device to tune in to a channel of the selected program.

According to the above configuration (12), the portable display device displays a television program guide, and the user performs an operation to select a program from the program guide, thereby displaying the selected program on the predetermined display device. Thus, the user can perform an operation to select the channel of the predetermined display device using a terminal device 7 on which a program guide is displayed.

(13) The portable display device may include an infrared light emitting unit for emitting an infrared signal, and the predetermined display device may include an infrared light reception unit for receiving the infrared signal. In this case, the information processing unit outputs an instruction to the portable display device, thereby causing the infrared light emitting unit to output a control command for controlling the predetermined display device.

According to the above configuration (13), with an infrared signal, the predetermined display device can be readily controlled by the portable display device.

(14) The information processing apparatus may transmit a control command to the predetermined display device in a wired or wireless manner, thereby controlling the predetermined display device.

According to the above configuration (14), the information processing apparatus can readily control the predetermined display device by transmitting a control command.

(15) In response to the user performing a predetermined operation, the second image output unit may output a character input image to the portable display device, the character input image including key images which allow character input.

According to the above configuration (15), by the portable display device displaying a character input image, the user can readily input characters via the portable display device.

(16) Another example information processing system described herein includes a stationary information processing apparatus and a portable display device allowing a user to perform an input operation.

The information processing apparatus includes a program guide reception unit, an operation image output unit, an operation data acquisition unit, and a control unit. The program guide reception unit receives data for a television program guide from a predetermined external device via a network. The operation image output unit outputs an operation image including the program guide to the portable display device. The operation data acquisition unit acquires operation data from the portable display device, the operation data representing an operation on the operation image. The control unit selects a program in the program guide included in the operation image on the basis of the operation data, and controls the predetermined display device to tune in to a channel of the selected program.

The portable display device includes an operation data transmission unit, a second image reception unit, and a display unit. The operation data transmission unit transmits data outputted by an operation unit provided in the portable display device as the operation data. The second image reception unit receives the operation image from the information processing apparatus. The display unit displays the received operation image.

According to the above configuration (16), the portable display device displays a television program guide acquired from an external device, and once an operation is performed to select a program from the displayed program guide, channel selection control is performed on the predetermined display device, so that the selected program is displayed on the predetermined display device. Thus, the user can perform an operation to select the channel of the predetermined display device using a terminal device 7 on which a program guide is displayed.

(17) The information processing apparatus further includes a program acquisition unit and a program output unit. When the selected program satisfies a predetermined condition, the program acquisition unit makes an acquisition request to the predetermined external device for that program, and acquires the program via the network. When the selected program is acquired via the network, the program output unit outputs the program's image and audio to the predetermined display device.

Note that information processing apparatuses for use in the information processing systems as described in (1) to (17) above are disclosed herein. Also disclosed herein are non-transitory computer-readable storage media having stored therein information processing programs for causing computers of the information processing apparatuses to function as means equivalent to the features as described in (1) to (17) above. Further disclosed herein are image display methods to be performed in the information processing systems as described in (1) to (17) above.

As described above, in the information processing systems, information processing apparatuses, information processing programs, and image display methods as mentioned above, an externally acquired image is displayed on the predetermined display device, and an operation image for performing an operation on the image is displayed on the portable display device, making it possible to provide images that can be viewed more readily and allow the user to readily perform operations related to the images.

These and other objects, features, aspects and advantages will become more apparent from the following detailed description when taken in conjunction with the accompanying drawings.

### BRIEF DESCRIPTION OF THE DRAWINGS

FIG. 1 is an external view of an example non-limiting game system;

FIG. 2 is a block diagram illustrating an internal configuration of an example non-limiting game apparatus;

FIG. 3 is a perspective view illustrating an external configuration of an example non-limiting controller;

FIG. 4 is another perspective view illustrating an external configuration of the example non-limiting controller;

FIG. 5 is a diagram illustrating an internal configuration of the example non-limiting controller;

FIG. 6 is another diagram illustrating an internal configuration of the example non-limiting controller;

FIG. 7 is a block diagram illustrating a configuration of the example non-limiting controller;

FIG. 8 is a diagram illustrating an external configuration of an example non-limiting terminal device;

FIG. 9 is a diagram illustrating the example non-limiting terminal device being held by the user;

FIG. 10 is a block diagram illustrating an internal configuration of the example non-limiting terminal device;

FIG. 11 is a block diagram illustrating the relationship of connection between the example non-limiting game system and an example external device.

FIG. 12 is a flowchart illustrating an example basic processing operation of a game apparatus 3;

FIG. 13 is a diagram illustrating an example Web page acquired from a video search site and displayed on a terminal device 7 in First Example;

FIG. 14 is a diagram illustrating an example image displayed on the terminal device 7, where search results are shown;

FIG. 15 is a diagram illustrating an example image for video play displayed on the terminal device 7;

FIG. 16 is a diagram illustrating an example image for video play displayed on a television 2;

FIG. 17 is a diagram illustrating various types of example data for use in the processing by the game apparatus 3;

FIG. 18 is a main flowchart showing an example flow of the processing to be executed by the game apparatus 3 in First Example;

FIG. 19 is a flowchart illustrating a detailed flow of an example transmission process (step S17) shown in FIG. 18;

FIG. 20 is a flowchart illustrating a detailed flow of an example display process (step S18) shown in FIG. 18;

FIG. 21 is a diagram illustrating an example terminal image having a character input image added thereto;

FIG. 22 is a diagram illustrating an example Web page acquired from a shopping site and displayed on the terminal device 7 in Second Example;

FIG. 23 is a flowchart illustrating a detailed flow of an example display process (step S18) in Second Example;

FIG. 24 is a diagram illustrating an example image displayed on the television 2 in Third Example;

FIG. 25 is a diagram illustrating an example image displayed on the terminal device 7 in Third Example;

FIG. 26 is a diagram illustrating various types of example data for use in the processing by the game apparatus 3 in Third Example;

FIG. 27 is a flowchart illustrating an example flow of the processing to be executed by the game apparatus 3 in Third Example;

FIG. 28 is a diagram illustrating various types of example data for use in the processing by the game apparatus 3 in Fourth Example;

FIG. 29 is a flowchart illustrating an example flow of the processing to be executed by the game apparatus 3 in Fourth Example; and

FIG. 30 is a diagram illustrating an example EPG image displayed on the terminal device 7.

### DETAILED DESCRIPTION OF NON-LIMITING EXAMPLE EMBODIMENTS

### 1. Overall Configuration of the Game System

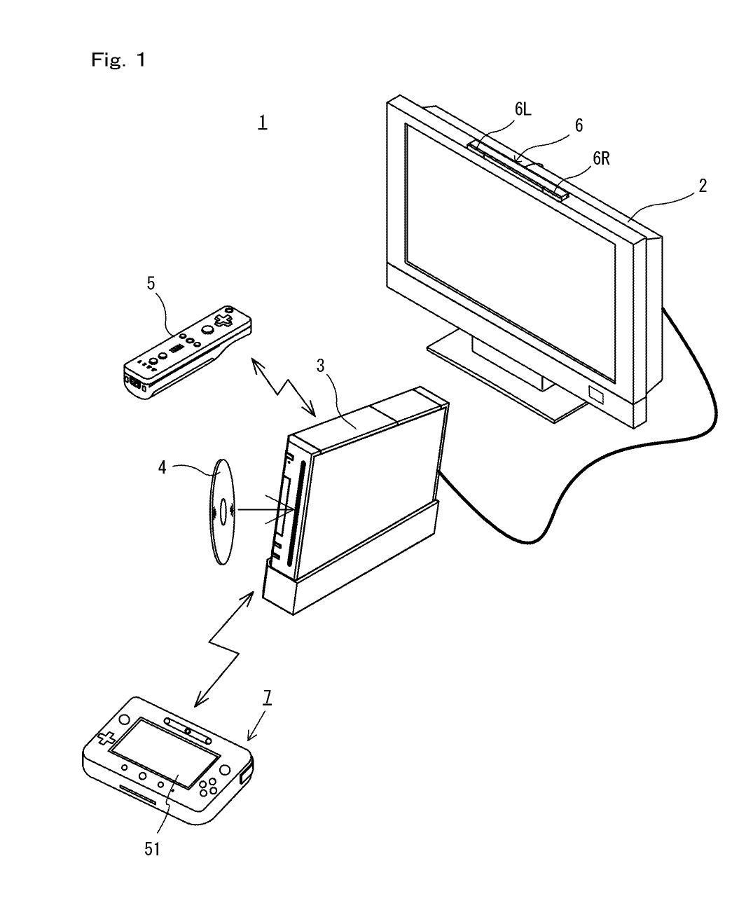

An example game system 1 according to an example embodiment will now be described with reference to the drawings. FIG. 1 is an external view of the game system 1. In FIG. 1, the game system 1 includes a stationary display device (hereinafter referred to as a “television”) 2 such as a television receiver, a stationary game apparatus 3, an optical disc 4, a controller 5, a marker device 6, and a terminal device 7. In the game system 1, the game apparatus 3 performs game processes based on game operations performed using the controller 5 and/or the terminal device 7, and game images acquired through the game processes are displayed on the television 2 and/or the terminal device 7.

In the game apparatus 3, the optical disc 4 typifying an information storage medium used for the game apparatus 3 in a replaceable manner is removably inserted. An information processing program (a game program, for example) to be executed by the game apparatus 3 is stored in the optical disc 4. The game apparatus 3 has, on the front surface thereof, an insertion opening for the optical disc 4. The game apparatus 3 reads and executes the information processing program stored on the optical disc 4 which is inserted into the insertion opening, to perform the game process.

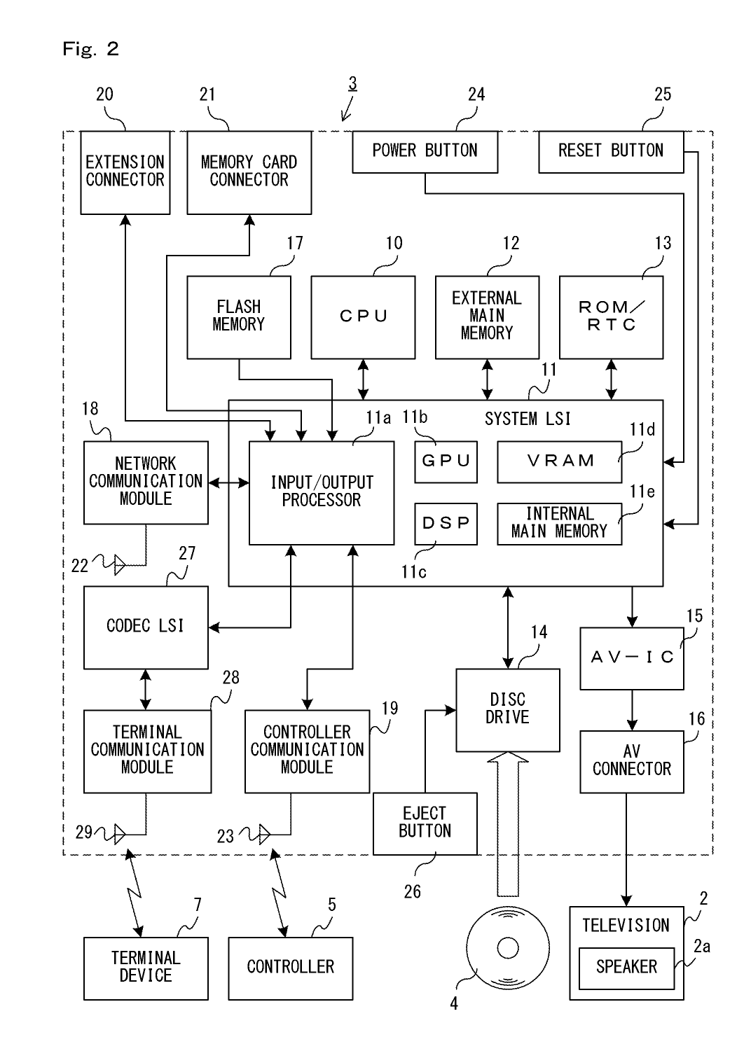

The television 2 is connected to the game apparatus 3 by a connecting cord. Game images acquired as a result of the game processes performed by the game apparatus 3 are displayed on the television 2. The television 2 includes a speaker 2a (see FIG. 2), and the speaker 2a outputs game sounds acquired as a result of the game process. In alternative example embodiments, the game apparatus 3 and the stationary display device may be an integral section. Also, the communication between the game apparatus 3 and the television 2 may be wireless communication.

The marker device 6 is provided along the periphery of the screen (on the upper side of the screen in FIG. 1) of the television 2. The user (player) can perform game operations by moving the controller 5, the details of which will be described later, and the marker device 6 is used by the game apparatus 3 for calculating the movement, position, attitude, etc., of the controller 5. The marker device 6 includes two markers 6R and 6L on opposite ends thereof. Specifically, the marker 6R (as well as the marker 6L) includes one or more infrared LEDs (Light Emitting Diodes), and emits an infrared light in a forward direction from the television 2. The marker device 6 is connected to the game apparatus 3, and the game apparatus 3 is able to control the lighting of each infrared LED of the marker device 6. Note that the marker device 6 is of a transportable type so that the user can install the marker device 6 in any desired position. While FIG. 1 shows an example embodiment in which the marker device 6 is arranged on top of the television 2, the position and the direction of arranging the marker device 6 are not limited to this particular arrangement.

The controller 5 provides the game apparatus 3 with operation data representing the content of operations performed on the controller itself. The controller 5 and the game apparatus 3 can wirelessly communicate with each other. In the present example embodiment, the wireless communication between the controller 5 and the game apparatus 3 uses, for example, Bluetooth (Registered Trademark) technology. In other example embodiments, the controller 5 and the game apparatus 3 may be connected by a wired connection. Furthermore, in the present example embodiment, the game system 1 includes only one controller 5, but the game apparatus 3 is capable of communicating with a plurality of controllers, so that by using a predetermined number of controllers at the same time, a plurality of people can play the game. The configuration of the controller 5 will be described in detail later.

The terminal device 7 is of a size that can be held by the user, so that the user can hold and move the terminal device 7 or can place the terminal device 7 in any desired position. As will be described in detail later, the terminal device 7 includes a liquid crystal display (LCD) 51, and input means (e.g., a touch panel 52 and a gyroscope 64 to be described later). The terminal device 7 can communicate with the game apparatus 3 wirelessly (or wired). The terminal device 7 receives data for images generated by the game apparatus 3 (e.g., game images) from the game apparatus 3, and displays the images on the LCD 51. Note that in the present example embodiment, the LCD is used as the display of the terminal device 7, but the terminal device 7 may include any other display device, e.g., a display device utilizing electro luminescence (EL). Furthermore, the terminal device 7 transmits operation data representing the content of operations performed thereon to the game apparatus 3.

### 2. Internal Configuration of the Game Apparatus 3

An internal configuration of the game apparatus 3 will be described with reference to FIG. 2. FIG. 2 is a block diagram illustrating an internal configuration of the game apparatus 3. The game apparatus 3 includes a CPU (Central Processing Unit) 10, a system LSI 11, external main memory 12, a ROM/RTC 13, a disc drive 14, and an AV-IC 15.

The CPU 10 performs game processes by executing a game program stored, for example, on the optical disc 4, and functions as a game processor. The CPU 10 is connected to the system LSI 11. The external main memory 12, the ROM/RTC 13, the disc drive 14, and the AV-IC 15, as well as the CPU 10, are connected to the system LSI 11. The system LSI 11 performs processes for controlling data transmission between the respective components connected thereto, generating images to be displayed, acquiring data from an external device (s), and the like. The internal configuration of the system LSI 11 will be described below. The external main memory 12 is of a volatile type and stores a program such as a game program read from the optical disc 4, a game program read from flash memory 17, and various data. The external main memory 12 is used as a work area and a buffer area for the CPU 10. The ROM/RTC 13 includes a ROM (a so-called boot ROM) incorporating a boot program for the game apparatus 3, and a clock circuit (RTC: Real Time Clock) for counting time. The disc drive 14 reads program data, texture data, and the like from the optical disc 4, and writes the read data into internal main memory 11e (to be described below) or the external main memory 12.

The system LSI 11 includes an input/output processor (I/O processor) 11a, a GPU (Graphics Processor Unit) 11b, a DSP (Digital Signal Processor) 11c, VRAM (Video RAM) 11d, and the internal main memory 11e. Although not shown in the figures, these components 11a to 11e are connected with each other through an internal bus.

The GPU 11b, acting as a part of a rendering mechanism, generates images in accordance with graphics commands (rendering commands) from the CPU 10. The VRAM 11d stores data (data such as polygon data and texture data) to be used by the GPU 11b to execute the graphics commands. When images are generated, the GPU 11b generates image data using data stored in the VRAM 11d. Note that the game apparatus 3 generates both images to be displayed on the television 2 and images to be displayed on the terminal device 7. Hereinafter, the images to be displayed on the television 2 are referred to as the “television images” and the images to be displayed on the terminal device 7 are referred to as the “terminal images”.

The DSP 11c, functioning as an audio processor, generates sound data using sound data and sound waveform (e.g., tone quality) data stored in one or both of the internal main memory 11e and the external main memory 12. Note that in the present example embodiment, game sounds to be generated are classified into two types as in the case of the game images, one being outputted from the speaker of the television 2, the other being outputted from speakers of the terminal device 7. Hereinafter, in some cases, the sounds to be outputted from the television 2 are referred to as “television sounds”, and the sounds to be outputted from the terminal device 7 are referred to as “terminal sounds”.

Among the images and sounds generated by the game apparatus 3 as described above, both image data and sound data to be outputted from the television 2 are read out by the AV-IC 15. The AV-IC 15 outputs the read-out image data to the television 2 via an AV connector 16, and outputs the read-out sound data to the speaker 2a provided in the television 2. Thus, images are displayed on the television 2, and sounds are outputted from the speaker 2a. Note that the game apparatus 3 and the television 2 may be connected in any manner, and a control command for controlling the television 2 may be transmitted to the television 2 by the game apparatus 3 in a wired or wireless manner. For example, an HDMI cable, which supports the HDMI (high-definition multimedia interface) standard, may be used. The HDMI standard allows a device to control another device connected thereto on the basis of a function called CEC (consumer electronics control). Accordingly, in the case where the HDMI cable is used so that the game apparatus 3 can control the television 2, the game apparatus 3 can turn on the television 2 or switch between inputs to the television 2 at appropriate times.

Furthermore, among the images and sounds generated by the game apparatus 3, both image data and sound data to be outputted by the terminal device 7 are transmitted to the terminal device 7 by the input/output processor 11a, etc. The data transmission to the terminal device 7 by the input/output processor 11a, etc., will be described later.

The input/output processor 11a exchanges data with components connected thereto, and downloads data from an external device(s). The input/output processor 11a is connected to the flash memory 17, a network communication module 18, a controller communication module 19, an expansion connector 20, a memory card connector 21, and a codec LSI 27. Furthermore, an antenna 22 is connected to the network communication module 18. An antenna 23 is connected to the controller communication module 19. The codec LSI 27 is connected to a terminal communication module 28, and an antenna 29 is connected to the terminal communication module 28.

The game apparatus 3 is capable of connecting to a network such as the Internet to communicate with other devices). Specifically, the input/output processor 11a can be connected to a network such as the Internet via the network communication module 18 and the antenna 22 to communicate with external information processing apparatuses connected to the network. The input/output processor 11a regularly accesses the flash memory 17, and detects the presence or absence of any data to be transmitted to the network, and when detected, transmits the data to the network via the network communication module 18 and the antenna 22. Further, the input/output processor 11a receives data transmitted from the external information processing apparatuses and data downloaded from a download server via the network, the antenna 22 and the network communication module 18, and stores the received data in the flash memory 17. The CPU 10 executes a game program so as to read data stored in the flash memory 17 and use the data, as appropriate, in the game program. The flash memory 17 may store game save data (e.g., game result data or unfinished game data) of a game played using the game apparatus 3 in addition to data exchanged between the game apparatus 3 and the external information processing apparatuses. Moreover, the flash memory 17 may have a game program stored therein.

Furthermore, the game apparatus 3 is capable of receiving operation data from the controller 5. Specifically, the input/output processor 11a receives operation data transmitted from the controller 5 via the antenna 23 and the controller communication module 19, and stores it (temporarily) in a buffer area of the internal main memory 11e or the external main memory 12.

Furthermore, the game apparatus 3 is capable of exchanging data, for images, sound, etc., with the terminal device 7. When transmitting game images (terminal game images) to the terminal device 7, the input/output processor 11a outputs game image data generated by the GPU 11b to the codec LSI 27. The codec LSI 27 performs a predetermined compression process on the image data from the input/output processor 11a. The terminal communication module 28 wirelessly communicates with the terminal device 7. Accordingly, the image data compressed by the codec LSI 27 is transmitted by the terminal communication module 28 to the terminal device 7 via the antenna 29. In the present example embodiment, the image data transmitted from the game apparatus 3 to the terminal device 7 is image data used in a game, and the playability of a game can be adversely influenced if there is a delay in the images displayed in the game. Therefore, delay may be avoided as much as possible in transmitting image data from the game apparatus 3 to the terminal device 7. Therefore, in the present example embodiment, the codec LSI 27 compresses image data using a compression technique with high efficiency such as the H.264 standard, for example. Other compression techniques may be used, and image data may be transmitted uncompressed if the communication speed is sufficient. The terminal communication module 28 is, for example, a Wi-Fi certified communication module, and may perform wireless communication at high speed with the terminal device 7 using a MIMO (Multiple Input Multiple Output) technique employed in the IEEE 802.11n standard, for example, or may use other communication schemes.

Furthermore, in addition to the image data, the game apparatus 3 also transmits sound data to the terminal device 7. Specifically, the input/output processor 11a outputs sound data generated by the DSP 11c to the terminal communication module 28 via the codec LSI 27. The codec LSI 27 performs a compression process on the sound data as it does on the image data. Any method can be employed for compressing the sound data, and such a method may use a high compression rate but may cause less sound degradation. Also, in another example embodiment, the sound data may be transmitted without compression. The terminal communication module 28 transmits compressed image and sound data to the terminal device 7 via the antenna 29.

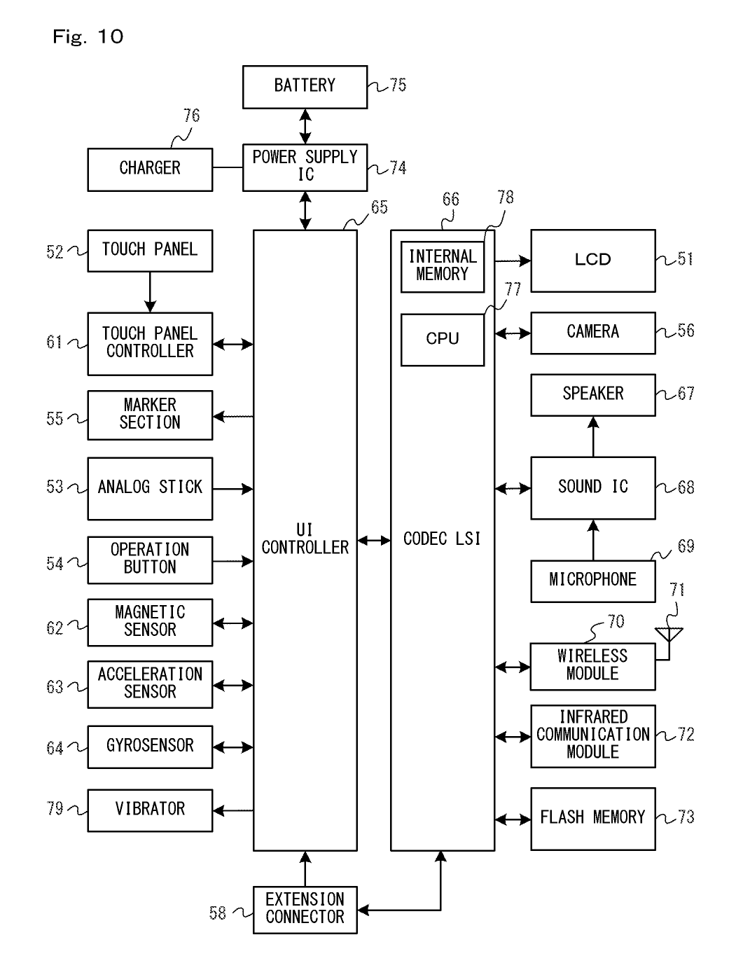

Furthermore, in addition to the image and sound data, the game apparatus 3 transmits various control data to the terminal device 7 where appropriate. The control data is data representing an instruction to control a component included in the terminal device 7, e.g., an instruction to control lighting of a marker section (a marker section 55 shown in FIG. 10) or an instruction to control shooting by a camera (a camera 56 shown in FIG. 10). The input/output processor 11a transmits the control data to the terminal device 7 in accordance with an instruction from the CPU 10. Note that in the present example embodiment, the codec LSI 27 does not perform a compression process on the control data, but in another example embodiment, a compression process may be performed. Note that the data to be transmitted from the game apparatus 3 to the terminal device 7 may or may not be coded depending on the situation.

Furthermore, the game apparatus 3 is capable of receiving various data from the terminal device 7. As will be described in detail later, in the present example embodiment, the terminal device 7 transmits operation data, image data, and sound data. The data transmitted by the terminal device 7 is received by the terminal communication module 28 via the antenna 29. Here, the image data and the sound data from the terminal device 7 have been subjected to the same compression process as performed on the image data and the sound data from the game apparatus 3 to the terminal device 7. Accordingly, the image data and the sound data are transferred from the terminal communication module 28 to the codec LSI 27, and subjected to a decompression process by the codec LSI 27 before output to the input/output processor 11a. On the other hand, the operation data from the terminal device 7 is smaller in size than the image data or the sound data and therefore is not always subjected to a compression process. Moreover, the operation data may or may not be coded depending on the situation. Accordingly, after being received by the terminal communication module 28, the operation data is outputted to the input/output processor 11a via the codec LSI 27. The input/output processor 11a stores the data received from the terminal device 7 (temporarily) in a buffer area of the internal main memory 11e or the external main memory 12.

Furthermore, the game apparatus 3 can be connected to other devices or external storage media. Specifically, the input/output processor 11a is connected to the expansion connector 20 and the memory card connector 21. The expansion connector 20 is a connector for an interface, such as a USB or SCSI interface. The expansion connector 20 can receive a medium such as an external storage medium, a peripheral device such as another controller, or a wired communication connector which enables communication with a network in place of the network communication module 18. The memory card connector 21 is a connector for connecting thereto an external storage medium such as a memory card (which may be of a proprietary or standard format, such as SD, miniSD, microSD, Compact Flash, etc.). For example, the input/output processor 11a can access an external storage medium via the expansion connector 20 or the memory card connector 21 to store data in the external storage medium or read data from the external storage medium.

The game apparatus 3 includes a power button 24, a reset button 25, and an eject button 26. The power button 24 and the reset button 25 are connected to the system LSI 11. When the power button 24 is on, power is supplied from an external power source to the components of the game apparatus 3 via an AC adaptor (not shown). When the reset button 25 is pressed, the system LSI 11 reboots a boot program of the game apparatus 3. The eject button 26 is connected to the disc drive 14. When the eject button 26 is pressed, the optical disc 4 is ejected from the disc drive 14.

In other example embodiments, some of the components of the game apparatus 3 may be provided as extension devices separate from the game apparatus 3. In this case, an extension device may be connected to the game apparatus 3 via the expansion connector 20, for example. Specifically, an extension device may include components as described above, e.g., a codec LSI 27, a terminal communication module 28, and an antenna 29, and can be attached to/detached from the expansion connector 20. Thus, by connecting the extension device to a game apparatus which does not include the above components, the game apparatus can communicate with the terminal device 7.

### 3. Configuration of the Controller 5

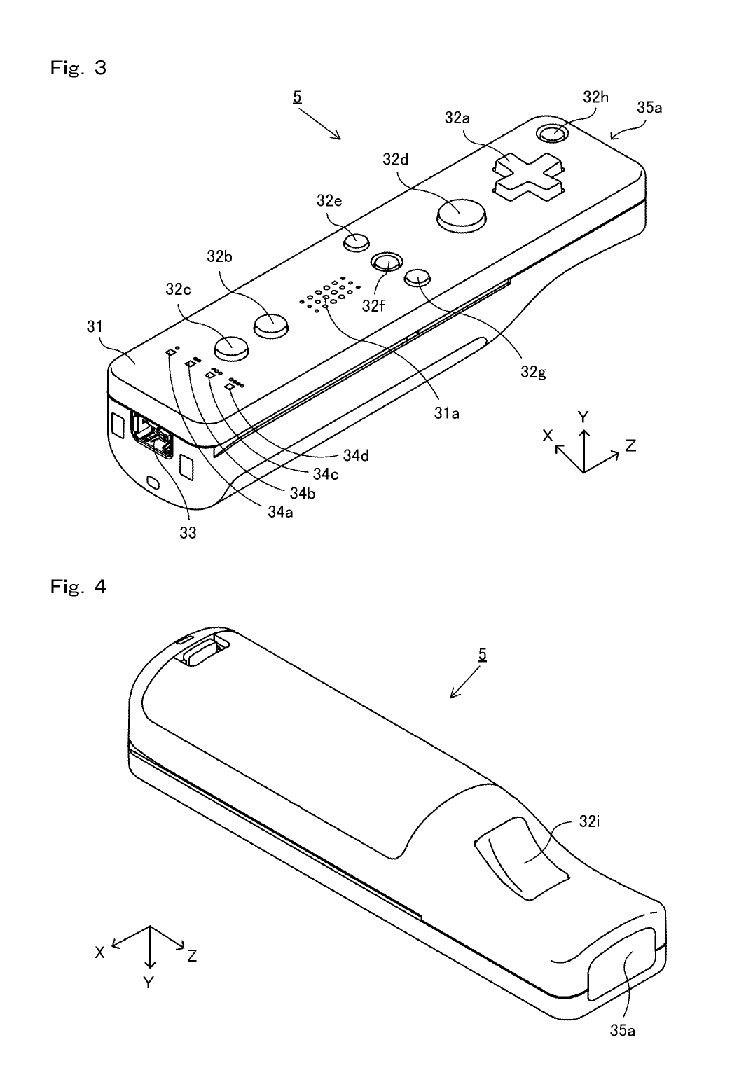

Next, with reference to FIGS. 3 to 7, the controller 5 will be described. FIG. 3 is a perspective view illustrating an external configuration of the controller 5. FIG. 4 is a perspective view illustrating an external configuration of the controller 5. The perspective view of FIG. 3 shows the controller 5 as viewed from the top rear side thereof, and the perspective view of FIG. 4 shows the controller 5 as viewed from the bottom front side thereof.

As shown in FIG. 3 and FIG. 4, the controller 5 has a housing 31 formed by, for example, plastic molding. The housing 31 has a generally parallelepiped shape extending in a longitudinal direction from front to rear (Z-axis direction shown in FIG. 3), and as a whole is sized to be held by one hand of an adult or even a child. The user can perform game operations by pressing buttons provided on the controller 5, and moving the controller 5 to change the position and the attitude (tilt) thereof.

The housing 31 has a plurality of operation buttons. As shown in FIG. 3, on the top surface of the housing 31, a cross button 32a, a first button 32b, a second button 32c, an A button 32d, a minus button 32e, a home button 32f, a plus button 32g, and a power button 32h are provided. In the present example embodiment, the top surface of the housing 31 on which the buttons 32a to 32h are provided may be referred to as a “button surface”. On the other hand, as shown in FIG. 4, a recessed portion is formed on the bottom surface of the housing 31, and a B button 32i is provided on a rear slope surface of the recessed portion. The operation buttons 32a to 32i are appropriately assigned their respective functions in accordance with the information processing program executed by the game apparatus 3. Further, the power button 32h is intended to remotely turn ON/OFF the game apparatus 3. The home button 32f and the power button 32h each have the top surface thereof recessed below the top surface of the housing 31. Therefore, the home button 32f and the power button 32h are prevented from being inadvertently pressed by the user.

On the rear surface of the housing 31, the connector 33 is provided. The connector 33 is used for connecting the controller 5 to another device (e.g., another sensor section or controller). Both sides of the connector 33 on the rear surface of the housing 31 have a fastening hole 33a for preventing easy inadvertent disengagement of another device as described above.

In the rear-side portion of the top surface of the housing 31, a plurality (four in FIG. 3) of LEDs 34a, 34b, 34c, and 34d are provided. The controller 5 is assigned a controller type (number) so as to be distinguishable from another controller. The LEDs 34a, 34b, 34c, and 34d are each used for informing the user of the controller type which is currently being set for the controller 5 being used, and for informing the user of remaining battery power of the controller 5, for example. Specifically, when a game operation is performed using the controller 5, one of the LEDs 34a, 34b, 34c, and 34d corresponding to the controller type is lit up.

The controller 5 has an imaging information calculation section 35 (FIG. 6), and a light incident surface 35a through which a light is incident on the imaging information calculation section 35 is provided on the front surface of the housing 31, as shown in FIG. 4. The light incident surface 35a is made of a material transmitting therethrough at least infrared light outputted from the markers 6R and 6L.

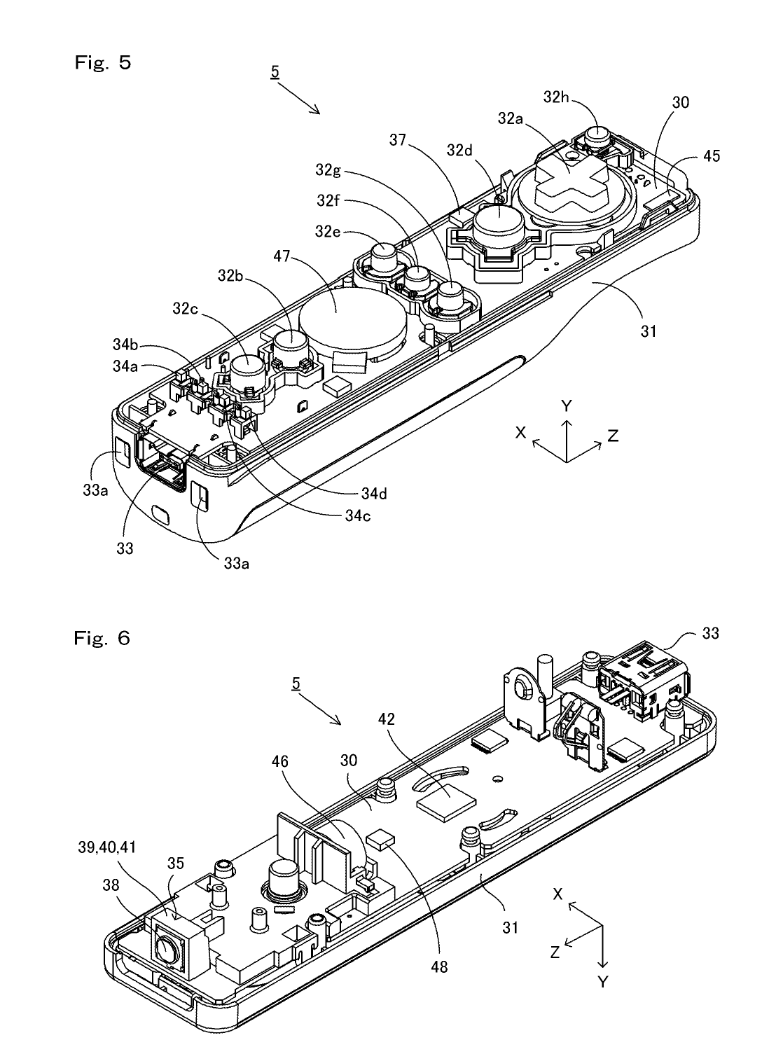

On the top surface of the housing 31, sound holes 31a for externally outputting a sound from a speaker 47 (shown in FIG. 5) incorporated in the controller 5 is provided between the first button 32b and the home button 32f.

Next, with reference to FIGS. 5 and 6, an internal configuration of the controller 5 will be described. FIG. 5 and FIG. 6 are diagrams illustrating the internal configuration of the controller 5. FIG. 5 is a perspective view illustrating a state where an upper casing (a part of the housing 31) of the controller 5 is removed. FIG. 6 is a perspective view illustrating a state where a lower casing (a part of the housing 31) of the controller 5 is removed. The perspective view of FIG. 6 shows a substrate 30 of FIG. 5 as viewed from the reverse side.

As shown in FIG. 5, the substrate 30 is fixed inside the housing 31, and on a top main surface of the substrate 30, the operation buttons 32a to 32h, the LEDs 34a, 34b, 34c, and 34d, an acceleration sensor 37, an antenna 45, the speaker 47, and the like are provided. These elements are connected to a microcomputer 42 (see FIG. 6) via lines (not shown) formed on the substrate 30 and the like. In the present example embodiment, the acceleration sensor 37 is provided on a position offset from the center of the controller 5 with respect to the X-axis direction. Thus, calculation of the movement of the controller 5 being rotated about the Z-axis may be facilitated. Further, the acceleration sensor 37 is provided anterior to the center of the controller 5 with respect to the longitudinal direction (Z-axis direction). Further, a wireless module 44 (see FIG. 6) and the antenna 45 allow the controller 5 to act as a wireless controller.

On the other hand, as shown in FIG. 6, at a front edge of a bottom main surface of the substrate 30, the imaging information calculation section 35 is provided. The imaging information calculation section 35 includes an infrared filter 38, a lens 39, an image pickup element 40 and an image processing circuit 41 located in order, respectively, from the front of the controller 5. These components 38 to 41 are attached on the bottom main surface of the substrate 30.

On the bottom main surface of the substrate 30, the microcomputer 42 and a vibrator 46 are provided. The vibrator 46 is, for example, a vibration motor or a solenoid, and is connected to the microcomputer 42 via lines formed on the substrate 30 or the like. The controller 5 is vibrated by actuation of the vibrator 46 based on a command from the microcomputer 42. Therefore, the vibration is conveyed to the user's hand holding the controller 5, and thus a so-called vibration-feedback game is realized. In the present example embodiment, the vibrator 46 is disposed slightly toward the front of the housing 31. That is, the vibrator 46 is positioned offset from the center toward the end of the controller 5, and therefore the vibration of the vibrator 46 can lead to enhancement of the vibration of the entire controller 5. Further, the connector 33 is provided at the rear edge of the bottom main surface of the substrate 30. In addition to the components shown in FIGS. 5 and 6, the controller 5 includes a quartz oscillator for generating a reference clock of the microcomputer 42, an amplifier for outputting a sound signal to the speaker 47, and the like.

FIGS. 3 to 6 only show examples of the shape of the controller 5, the shape of each operation button, the number and the positions of acceleration sensors and vibrators, and so on, and other shapes, numbers, and positions may be employed. Further, although in the present example embodiment the imaging direction of the image pickup means is the Z-axis positive direction, the imaging direction may be any direction. That is, the imagining information calculation section 35 (the light incident surface 35a through which a light is incident on the imaging information calculation section 35) of the controller 5 may not necessarily be provided on the front surface of the housing 31, but may be provided on any other surface on which a light can be received from the outside of the housing 31.

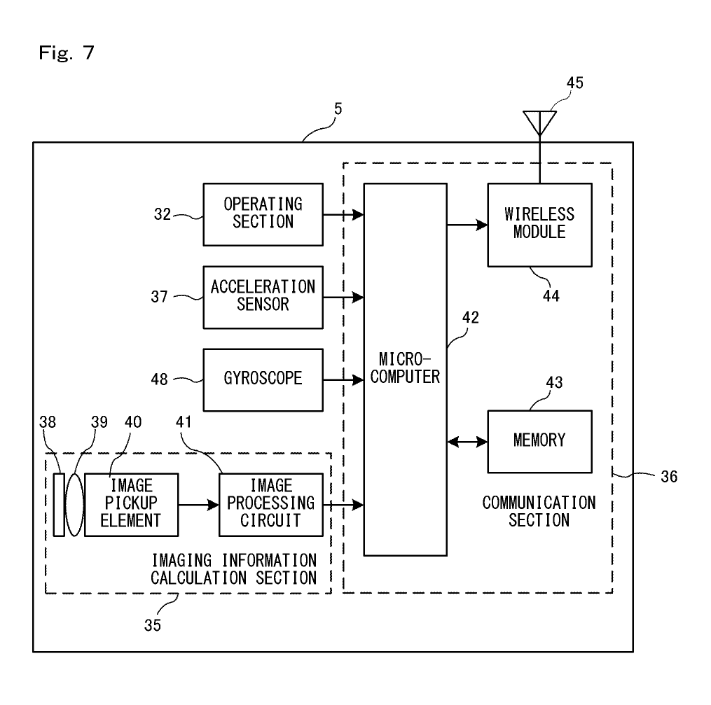

FIG. 7 is a block diagram illustrating a configuration of the controller 5. The controller 5 includes an operating section 32 (the operation buttons 32a to 32i), the imaging information calculation section 35, a communication section 36, the acceleration sensor 37, and a gyroscope 48. The controller 5 transmits, as operation data, data representing the content of an operation performed on the controller 5 itself, to the game apparatus 3. Note that hereinafter, in some cases, operation data transmitted by the controller 5 is referred to as “controller operation data”, and operation data transmitted by the terminal device 7 is referred to as “terminal operation data”.

The operating section 32 includes the operation buttons 32a to 32i described above, and outputs, to the microcomputer 42 of the communication section 36, operation button data indicating an input state (that is, whether or not each operation button 32a to 32i is pressed) of each operation button 32a to 32i.

The imaging information calculation section 35 is a system for analyzing image data taken by the image pickup means and calculating, for example, the centroid and the size of an area having a high brightness in the image data. The imaging information calculation section 35 has a maximum sampling period of, for example, about 200 frames/sec., and therefore can trace and analyze even a relatively fast motion of the controller 5.

The imaging information calculation section 35 includes the infrared filter 38, the lens 39, the image pickup element 40 and the image processing circuit 41. The infrared filter 38 transmits therethrough only infrared light included in the light incident on the front surface of the controller 5. The lens 39 collects the infrared light transmitted through the infrared filter 38 so as to be incident on the image pickup element 40. The image pickup element 40 is a solid-state imaging device such as, for example, a CMOS sensor or a CCD sensor, which receives the infrared light collected by the lens 39, and outputs an image signal. The marker section 55 of the terminal device 7 and the marker device 6, which are subjects to be imaged, include markers for outputting infrared light. Therefore, the infrared filter 38 enables the image pickup element 40 to receive only the infrared light transmitted through the infrared filter 38 and generate image data, so that an image of each subject to be imaged (the marker section 55 and/or the marker device 6) can be taken with enhanced accuracy. Hereinafter, the image taken by the image pickup element 40 is referred to as a pickup image. The image data generated by the image pickup element 40 is processed by the image processing circuit 41. The image processing circuit 41 calculates, in the pickup image, the positions of subjects to be imaged. The image processing circuit 41 outputs data representing coordinate points of the calculated positions, to the microcomputer 42 of the communication section 36. The data representing the coordinate points is transmitted as operation data to the game apparatus 3 by the microcomputer 42. Hereinafter, the coordinate points are referred to as “marker coordinate points”. The marker coordinate point changes depending on the attitude (angle of tilt) and/or the position of the controller 5 itself, and therefore the game apparatus 3 is allowed to calculate the attitude and the position of the controller 5 using the marker coordinate point.

In another example embodiment, the controller 5 may not necessarily include the image processing circuit 41, and the controller 5 may transmit the pickup image as it is to the game apparatus 3. At this time, the game apparatus 3 may have a circuit or a program, having the same function as the image processing circuit 41, for calculating the marker coordinate point.

The acceleration sensor 37 detects accelerations (including a gravitational acceleration) of the controller 5, that is, force (including gravity) applied to the controller 5. The acceleration sensor 37 detects a value of an acceleration (linear acceleration) applied to a detection section of the acceleration sensor 37 in the straight line direction along the sensing axis direction, among all accelerations applied to a detection section of the acceleration sensor 37. For example, a multiaxial acceleration sensor having two or more axes detects an acceleration of a component for each axis, as the acceleration applied to the detection section of the acceleration sensor. The acceleration sensor 37 is, for example, a capacitive MEMS (Micro-Electro Mechanical System) acceleration sensor. However, another type of acceleration sensor may be used.

In the present example embodiment, the acceleration sensor 37 detects a linear acceleration in each of three axis directions, i.e., the up/down direction (Y-axis direction shown in FIG. 3), the left/right direction (the X-axis direction shown in FIG. 3), and the forward/backward direction (the Z-axis direction shown in FIG. 3), relative to the controller 5. The acceleration sensor 37 detects acceleration in the straight line direction along each axis, and an output from the acceleration sensor 37 represents a value of the linear acceleration for each of the three axes. In other words, the detected acceleration is represented as a three-dimensional vector in an XYZ-coordinate system (controller coordinate system) defined relative to the controller 5.

Data (acceleration data) representing the acceleration detected by the acceleration sensor 37 is outputted to the communication section 36. The acceleration detected by the acceleration sensor 37 changes depending on the attitude (angle of tilt) and the movement of the controller 5, and therefore the game apparatus 3 is allowed to calculate the attitude and the movement of the controller 5 using the acquired acceleration data. In the present example embodiment, the game apparatus 3 calculates the attitude, angle of tilt, etc., of the controller 5 based on the acquired acceleration data.

When a computer such as a processor (e.g., the CPU 10) of the game apparatus 3 or a processor (e.g., the microcomputer 42) of the controller 5 processes an acceleration signal outputted from the acceleration sensor 37 (or similarly from an acceleration sensor 63 to be described later), additional information relating to the controller 5 can be inferred or calculated (determined), as one skilled in the art will readily understand from the description herein. For example, in the case where the computer performs processing on the premise that the controller 5 including the acceleration sensor 37 is in static state (that is, in the case where processing is performed on the premise that the acceleration to be detected by the acceleration sensor includes only the gravitational acceleration), when the controller 5 is actually in static state, it is possible to determine whether or not, or how much the controller 5 tilts relative to the direction of gravity, based on the acceleration having been detected. Specifically, when the state where the detection axis of the acceleration sensor 37 faces vertically downward is set as a reference, whether or not the controller 5 tilts relative to the reference can be determined based on whether or not 1G (gravitational acceleration) is applied to the detection axis, and the degree to which the controller 5 tilts relative to the reference can be determined based on the magnitude of the gravitational acceleration. Further, the multiaxial acceleration sensor 37 processes the acceleration signals having been detected for the respective axes so as to more specifically determine the degree to which the controller 5 tilts relative to the direction of gravity. In this case, the processor may calculate, based on the output from the acceleration sensor 37, the angle at which the controller 5 tilts, or the direction in which the controller 5 tilts without calculating the angle of tilt. Thus, the acceleration sensor 37 is used in combination with the processor, making it possible to determine the angle of tilt or the attitude of the controller 5.

On the other hand, when it is premised that the controller 5 is in dynamic state (where the controller 5 is being moved), the acceleration sensor 37 detects the acceleration based on the movement of the controller 5, in addition to the gravitational acceleration. Therefore, when the gravitational acceleration component is eliminated from the detected acceleration through a predetermined process, it is possible to determine the direction in which the controller 5 moves. Even when it is premised that the controller 5 is in dynamic state, the acceleration component based on the movement of the acceleration sensor is eliminated from the detected acceleration through a predetermined process, whereby it is possible to determine the tilt of the controller 5 relative to the direction of gravity. In another example embodiment, the acceleration sensor 37 may include an embedded processor or another type of dedicated processor for performing any desired processing on an acceleration signal detected by the acceleration detection means incorporated therein before outputting to the microcomputer 42. For example, when the acceleration sensor 37 is intended to detect static acceleration (for example, gravitational acceleration), the embedded or dedicated processor could convert the acceleration signal to a corresponding angle of tilt (or another appropriate parameter).

The gyroscope 48 detects angular rates about three axes (in the present example embodiment, the X-, Y-, and Z-axes). In the present specification, the directions of rotation about the X-axis, the Y-axis, and the Z-axis relative to the imaging direction (the Z-axis positive direction) of the controller 5 are referred to as a pitch direction, a yaw direction, and a roll direction, respectively. So long as the gyroscope 48 can detect the angular rates about the three axes, any number thereof may be used, and also any combination of sensors may be included therein. That is, the two-axis gyroscope 55 detects angular rates in the pitch direction (the direction of rotation about the X-axis) and the roll direction (the direction of rotation about the Z-axis), and the one-axis gyroscope 56 detects an angular rate in the yaw direction (the direction of rotation about the Y-axis). For example, the gyroscope 48 may be a three-axis gyroscope or may include a combination of a two-axis gyroscope and a one-axis gyroscope to detect the angular rates about the three axes. Data representing the angular rates detected by the gyroscope 48 is outputted to the communication section 36. Alternatively, the gyroscope 48 may simply detect an angular rate about one axis or angular rates about two axes.

The communication section 36 includes the microcomputer 42, memory 43, the wireless module 44 and the antenna 45. The microcomputer 42 controls the wireless module 44 for wirelessly transmitting, to the game apparatus 3, data acquired by the microcomputer 42 while using the memory 43 as a storage area in the process.

Data outputted from the operating section 32, the imaging information calculation section 35, the acceleration sensor 37, and the gyroscope 48 to the microcomputer 42 is temporarily stored to the memory 43. The data is transmitted as operation data (controller operation data) to the game apparatus 3. Specifically, at the time of the transmission to the controller communication module 19 of the game apparatus 3, the microcomputer 42 outputs the operation data stored in the memory 43 to the wireless module 44. The wireless module 44 uses, for example, the Bluetooth (registered trademark) technology to modulate the operation data onto a carrier wave of a predetermined frequency, and radiates the low power radio wave signal from the antenna 45. That is, the operation data is modulated onto the low power radio wave signal by the wireless module 44 and transmitted from the controller 5. The controller communication module 19 of the game apparatus 3 receives the low power radio wave signal. The game apparatus 3 demodulates or decodes the received low power radio wave signal to acquire the operation data. The CPU 10 of the game apparatus 3 performs the game process using the operation data acquired from the controller 5. The wireless transmission from the communication section 36 to the controller communication module 19 is sequentially performed at a predetermined time interval. Since the game process is generally performed at a cycle of 1/60 sec. (corresponding to one frame time), data may be transmitted at a cycle of a shorter time period. The communication section 36 of the controller 5 outputs, to the controller communication module 19 of the game apparatus 3, the operation data at intervals of 1/200 of a second, for example.

As described above, the controller 5 can transmit marker coordinate data, acceleration data, angular rate data, and operation button data as operation data representing operations performed thereon. In addition, the game apparatus 3 executes the game process using the operation data as game inputs. Accordingly, by using the controller 5, the user can perform the game operation of moving the controller 5 itself, in addition to conventionally general game operations of pressing operation buttons. For example, it is possible to perform the operations of tilting the controller 5 to arbitrary attitudes, pointing the controller 5 to arbitrary positions on the screen, and moving the controller 5 itself.

Also, in the present example embodiment, the controller 5 is not provided with any display means for displaying game images, but the controller 5 may be provided with a display means for displaying an image or suchlike to indicate, for example, a remaining battery level.

### 4. Configuration of the Terminal Device 7

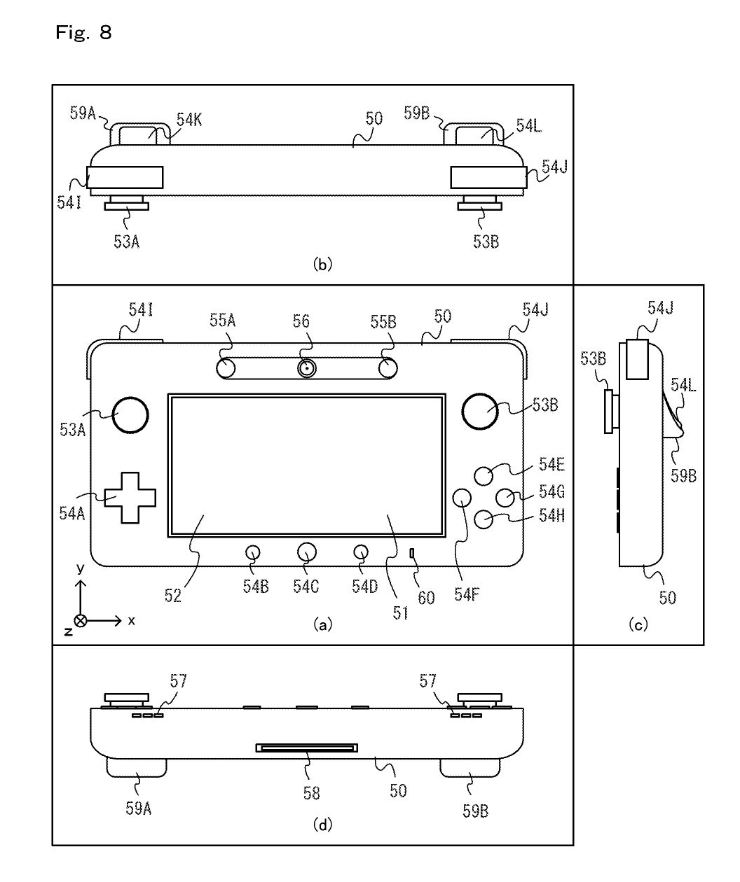

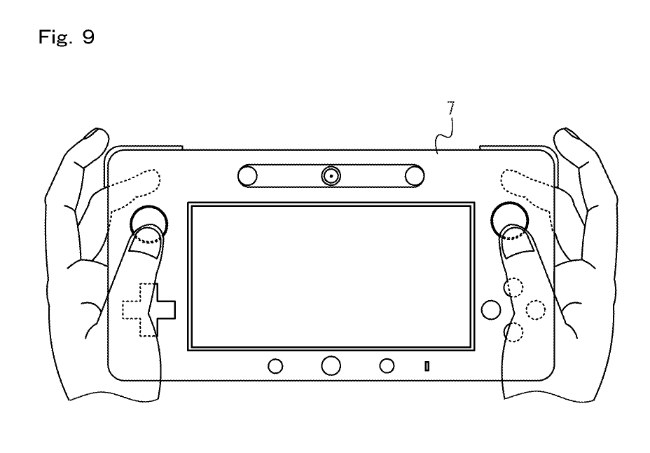

Next, referring to FIGS. 8 to 10, the configuration of the terminal device 7 will be described. FIG. 8 provides views illustrating an external configuration of the terminal device 7. In FIG. 8, parts (a), (b), (c), and (d) are a front view, a top view, a right side view, and a bottom view, respectively, of the terminal device 7. FIG. 9 is a diagram illustrating the terminal device 7 being held by the user.

As shown in FIG. 8, the terminal device 7 has a housing 50 roughly shaped in the form of a horizontally rectangular plate. The housing 50 is sized to be held by the user. Thus, the user can hold and move the terminal device 7, and can change the position of the terminal device 7.

The terminal device 7 includes an LCD 51 on the front surface of the housing 50. The LCD 51 is provided approximately at the center of the surface of the housing 50. Therefore, the user can hold and move the terminal device while viewing the screen of the LCD 51 by holding the housing 50 by edges to the left and right of the LCD 51, as shown in FIG. 9. While FIG. 9 shows an example where the user holds the terminal device 7 horizontal (horizontally long) by holding the housing 50 by edges to the left and right of the LCD 51, the user can hold the terminal device 7 vertical (vertically long).

As shown in FIG. 8(a), the terminal device 7 includes a touch panel 52 on the screen of the LCD 51 as an operating means. In the present example embodiment, the touch panel 52 is a resistive touch panel. However, the touch panel is not limited to the resistive type, and may be of any type such as capacitive. The touch panel 52 may be single-touch or multi-touch. In the present example embodiment, a touch panel having the same resolution (detection precision) as the LCD 51 is used as the touch panel 52. However, the touch panel 52 and the LCD 51 do not have to be equal in resolution. While a stylus is usually used for providing input to the touch panel 52, input to the touch panel 52 can be provided not only by the stylus but also by the user's finger. Note that the housing 50 may be provided with an accommodation hole for accommodating the stylus used for performing operations on the touch panel 52. In this manner, the terminal device 7 includes the touch panel 52, and the user can operate the touch panel 52 while moving the terminal device 7. Specifically, the user can provide input directly to the screen of the LCD 51 (from the touch panel 52) while moving the screen.

As shown in FIG. 8, the terminal device 7 includes two analog sticks 53A and 53B and a plurality of buttons 54A to 54L, as operating means. The analog sticks 53A and 53B are devices capable of directing courses. Each of the analog sticks 53A and 53B is configured such that its stick portion to be operated with the user's finger is slidable or tiltable in an arbitrary direction (at an arbitrary angle in any of the up, down, left, right, and oblique directions) with respect to the surface of the housing 50. Moreover, the left analog stick 53A and the right analog stick 53B are provided to the left and the right, respectively, of the screen of the LCD 51. Accordingly, the user can provide an input for course direction using the analog stick with either the left or the right hand. In addition, as shown in FIG. 9, the analog sticks 53A and 53B are positioned so as to allow the user to manipulate them while holding the terminal device 7 at its left and right edges, and therefore the user can readily manipulate the analog sticks 53A and 53B while moving the terminal device 7 by hand.

The buttons 54A to 54L are operating means for providing predetermined input. As will be discussed below, the buttons 54A to 54L are positioned so as to allow the user to manipulate them while holding the terminal device 7 at its left and right edges (see FIG. 9). Therefore the user can readily manipulate the operating means while moving the terminal device 7 by hand.

As shown in FIG. 8(a), of all the operation buttons 54A to 54L, the cross button (direction input button) 54A and the buttons 54B to 54H are provided on the front surface of the housing 50. That is, these buttons 54A to 54G are positioned so as to allow the user to manipulate them with his/her thumbs (see FIG. 9).

The cross button 54A is provided to the left of the LCD 51 and below the left analog stick 53A. That is, the cross button 54A is positioned so as to allow the user to manipulate it with his/her left hand. The cross button 54A is a cross-shaped button which makes it possible to specify at least up, down, left and right directions. Also, the buttons 54B to 54D are provided below the LCD 51. These three buttons 54B to 54D are positioned so as to allow the user to manipulate them with either hand. Moreover, the four buttons 54E to 54H are provided to the right of the LCD 51 and below the right analog stick 53B. That is, the four buttons 54E to 54H are positioned so as to allow the user to manipulate them with the right hand. In addition, the four buttons 54E to 54H are positioned above, to the left of, to the right of, and below the central position among them. Therefore, the four buttons 54E to 54H of the terminal device 7 can be used to function as buttons for allowing the user to specify the up, down, left and right directions.

Furthermore, as shown in FIGS. 8(a), 8(b) and 8(c), the first L button 54I and the first R button 54J are provided at the upper (left and right) corners of the housing 50. Specifically, the first L button 54I is provided at the left edge of the top surface of the plate-like housing 50 so as to be exposed both from the top surface and the left-side surface. The first R button 54J is provided at the right edge of the top surface of the housing 50 so as to be exposed both from the top surface and the right-side surface. Thus, the first L button 54I is positioned so as to allow the user to manipulate it with the left index finger, and the first R button 54J is positioned so as to allow user to manipulate it with the right index finger (see FIG. 9).

Also, as shown in FIGS. 8(b) and 8(c), the second L button 54K and the second R button 54L are positioned at stands 59A and 59B, respectively, which are provided on the back surface of the plate-like housing 50 (i.e., the plane opposite to the surface where the LCD 51 is provided). The second L button 54K is provided at a comparatively high position on the right side of the back surface of the housing 50 (i.e., the left side as viewed from the front surface side), and the second R button 54L is provided at a comparatively high position on the left side of the back surface of the housing 50 (i.e., the right side as viewed from the front surface side). In other words, the second L button 54K is provided at a position approximately opposite to the left analog stick 53A provided on the front surface, and the second R button 54L is provided at a position approximately opposite to the right analog stick 53B provided on the front surface. Thus, the second L button 54K is positioned so as to allow the user to manipulate it with the left middle finger, and the second R button 54L is positioned so as to allow the user to manipulate it with the right middle finger (see FIG. 9). In addition, the second L button 54K and the second R button 54L are provided on the surfaces of the stands 59A and 59B that are directed obliquely upward, as shown in FIG. 8(c), and therefore, the second L button 54K and the second R button 54L have button faces directed obliquely upward. When the user holds the terminal device 7, the middle fingers will probably be able to move in the up/down direction, and therefore the button faces directed upward will allow the user to readily press the second L button 54K and the second R button 54L. Moreover, providing the stands on the back surface of the housing 50 allows the user to readily hold the housing 50, and furthermore, providing the buttons on the stands allows the user to readily manipulate the buttons while holding the housing 50.

Note that the terminal device 7 shown in FIG. 8 has the second L button 54K and the second R button 54L provided at the back surface, and therefore when the terminal device 7 is placed with the screen of the LCD 51 (the front surface of the housing 50) facing up, the screen might not be completely horizontal. Accordingly, in another example embodiment, three or more stands may be formed on the back surface of the housing 50. As a result, when the terminal device 7 is placed on the floor with the screen of the LCD 51 facing upward, all the stands contact the floor, so that the screen can be horizontal. Alternatively, the terminal device 7 may be placed horizontally by adding a detachable stand.

The buttons 54A to 54L are each appropriately assigned a function in accordance with the game program. For example, the cross button 54A and the buttons 54E to 54H may be used for direction-specifying operations, selection operations, etc., whereas the buttons 54B to 54E may be used for setting operations, cancellation operations, etc.

Although not shown in the figures, the terminal device 7 includes a power button for turning ON/OFF the terminal device 7. Moreover, the terminal device 7 may also include buttons for turning ON/OFF the screen of the LCD 51, performing a connection setting (pairing) with the game apparatus 3, and controlling the volume of speakers (speakers 67 shown in FIG. 10).

As shown in FIG. 8(a), the terminal device 7 has a marker section (a marker section 55 shown in FIG. 10), including markers 55A and 55B, provided on the front surface of the housing 50. The marker section 55 is provided in the upper portion of the LCD 51. The markers 55A and 55B are each formed by one or more infrared LEDs, as are the markers 6R and 6L of the marker device 6. The marker section 55 is used for the game apparatus 3 to calculate the movement, etc., of the controller 5, as is the marker device 6 described above. In addition, the game apparatus 3 can control the lighting of the infrared LEDs included in the marker section 55.

The terminal device 7 includes the camera 56 which is an image pickup means. The camera 56 includes an image pickup element (e.g., a CCD image sensor, a CMOS image sensor, or the like) having a predetermined resolution, and a lens. As shown in FIG. 8, in the present example embodiment, the camera 56 is provided on the front surface of the housing 50. Therefore, the camera 56 can pick up an image of the face of the user holding the terminal device 7, and can pick up an image of the user playing a game while viewing the LCD 51, for example.

Note that the terminal device 7 includes a microphone (a microphone 69 shown in FIG. 10) which is a sound input means. A microphone hole 60 is provided in the front surface of the housing 50. The microphone 69 is provided inside the housing 50 behind the microphone hole 60. The microphone detects sounds around the terminal device 7 such as the voice of the user.

The terminal device 7 includes speakers (speakers 67 shown in FIG. 10) which are sound output means. As shown in FIG. 8(d), speaker holes 57 are provided in the bottom surface of the housing 50. Sound emitted by the speakers 67 is outputted from the speaker holes 57. In the present example embodiment, the terminal device 7 includes two speakers, and the speaker holes 57 are provided at positions corresponding to the left and right speakers.

Also, the terminal device 7 includes an expansion connector 58 for connecting another device to the terminal device 7. In the present example embodiment, the expansion connector 58 is provided at the bottom surface of the housing 50, as shown in FIG. 8(d). Any additional device may be connected to the expansion connector 58, including, for example, a game-specific controller (a gun-shaped controller or suchlike) or an input device such as a keyboard. The expansion connector 58 may be omitted if there is no need to connect any additional devices to terminal device 7.

Note that as for the terminal device 7 shown in FIG. 8, the shapes of the operation buttons and the housing 50, the number and arrangement of components, etc., are merely illustrative, and other shapes, numbers, and arrangements may be employed.

Next, an internal configuration of the terminal device 7 will be described with reference to FIG. 10. FIG. 10 is a block diagram illustrating the internal configuration of the terminal device 7. As shown in FIG. 10, in addition to the components shown in FIG. 8, the terminal device 7 includes a touch panel controller 61, a magnetic sensor 62, the acceleration sensor 63, the gyroscope 64, a user interface controller (UI controller) 65, a codec LSI 66, the speakers 67, a sound IC 68, the microphone 69, a wireless module 70, an antenna 71, an infrared communication module 72, flash memory 73, a power supply IC 74, a battery 75, and a vibrator 79. These electronic components are mounted on an electronic circuit board and accommodated in the housing 50.

The UI controller 65 is a circuit for controlling the input/output of data to/from various input/output sections. The UI controller 65 is connected to the touch panel controller 61, an analog stick section 53 (including the analog sticks 53A and 53B), an operation button group 54 (including the operation buttons 54A to 54L), the marker section 55, the magnetic sensor 62, the acceleration sensor 63, the gyroscope 64, and the vibrator 79. The UI controller 65 is connected to the codec LSI 66 and the expansion connector 58. The power supply IC 74 is connected to the UI controller 65, and power is supplied to various sections via the UI controller 65. The built-in battery 75 is connected to the power supply IC 74 to supply power. A charger 76 or a cable with which power can be obtained from an external power source can be connected to the power supply IC 74 via a charging connector, and the terminal device 7 can be charged with power supplied from an external power source using the charger 76 or the cable. Note that the terminal device 7 can be charged by being placed in an unillustrated cradle having a charging function.

The touch panel controller 61 is a circuit connected to the touch panel 52 for controlling the touch panel 52. The touch panel controller 61 generates touch position data in a predetermined format based on signals from the touch panel 52, and outputs it to the UI controller 65. The touch position data represents, for example, the coordinates of a position on the input surface of the touch panel 52 at which an input has been made. The touch panel controller 61 reads a signal from the touch panel 52 and generates touch position data once per a predetermined period of time. Various control instructions for the touch panel 52 are outputted from the UI controller 65 to the touch panel controller 61.

The analog stick section 53 outputs, to the UI controller 65, stick data representing the direction and the amount of sliding (or tilting) of the stick portion operated with the user's finger. The operation button group 54 outputs, to the UI controller 65, operation button data representing the input status of each of the operation buttons 54A to 54L (regarding whether it has been pressed).

The magnetic sensor 62 detects an azimuthal direction by sensing the magnitude and the direction of a magnetic field. Azimuthal direction data representing the detected azimuthal direction is outputted to the UI controller 65. Control instructions for the magnetic sensor 62 are outputted from the UI controller 65 to the magnetic sensor 62. While there are sensors using, for example, an MI (magnetic impedance) element, a fluxgate sensor, a Hall element, a GMR (giant magnetoresistance) element, a TMR (tunnel magnetoresistance) element, or an AMR (anisotropic magnetoresistance) element, the magnetic sensor 62 may be of any type so long as it is possible to detect the azimuthal direction. Strictly speaking, in a place where there is a magnetic field in addition to the geomagnetic field, the obtained azimuthal direction data does not represent the azimuthal direction. Nevertheless, if the terminal device 7 moves, the azimuthal direction data changes, and it is therefore possible to calculate the change in the attitude of the terminal device 7.

The acceleration sensor 63 is provided inside the housing 50 for detecting the magnitude of linear acceleration along each direction of three axes (the x-, y- and z-axes shown in FIG. 8(a)). Specifically, the acceleration sensor 63 detects the magnitude of linear acceleration along each axis, where the longitudinal direction of the housing 50 is taken as the x-axis, the width direction of the housing 50 as the y-axis, and a direction perpendicular to the front surface of the housing 50 as the z-axis. Acceleration data representing the detected acceleration is outputted to the UI controller 65. Also, control instructions for the acceleration sensor 63 are outputted from the UI controller 65 to the acceleration sensor 63. In the present example embodiment, the acceleration sensor 63 is assumed to be, for example, a capacitive MEMS acceleration sensor, but in another example embodiment, an acceleration sensor of another type may be employed. The acceleration sensor 63 may be an acceleration sensor for detection in one axial direction or two axial directions.

The gyroscope 64 is provided inside the housing 50 for detecting angular rates about the three axes, i.e., the x-, y-, and z-axes. Angular rate data representing the detected angular rates is outputted to the UI controller 65. Also, control instructions for the gyroscope 64 are outputted from the UI controller 65 to the gyroscope 64. Note that any number and combination of gyroscopes may be used for detecting angular rates about the three axes, and similar to the gyroscope 48, the gyroscope 64 may include a two-axis gyroscope and a one-axis gyroscope. Alternatively, the gyroscope 64 may be a gyroscope for detection in one axial direction or two axial directions.

The vibrator 79 is, for example, a vibration motor or a solenoid, and is connected to the UI controller 65. The terminal device 7 is vibrated by actuation of the vibrator 79 based on an instruction from the UI controller 65. Therefore, the vibration is conveyed to the user's hand holding the terminal device 7, and thus a so-called vibration-feedback game is realized.

The UI controller 65 outputs operation data to the codec LSI 66, including touch position data, stick data, operation button data, azimuthal direction data, acceleration data, and angular rate data received from various components described above. If another device is connected to the terminal device 7 via the expansion connector 58, data representing an operation performed on that device may be further included in the operation data.

The codec LSI 66 is a circuit for performing a compression process on data to be transmitted to the game apparatus 3, and a decompression process on data transmitted from the game apparatus 3. The LCD 51, the camera 56, the sound IC 68, the wireless module 70, the flash memory 73, and the infrared communication module 72 are connected to the codec LSI 66. The codec LSI 66 includes a CPU 77 and internal memory 78. While the terminal device 7 does not perform any game process itself, the terminal device 7 may execute a minimal set of programs for its own management and communication purposes. Upon power-on, the CPU 77 executes a program loaded into the internal memory 78 from the flash memory 73, thereby starting up the terminal device 7. Also, some area of the internal memory 78 is used as VRAM for the LCD 51.

The camera 56 picks up an image in response to an instruction from the game apparatus 3, and outputs data for the pick-up image to the codec LSI 66. Also, control instructions for the camera 56, such as an image pickup instruction, are outputted from the codec LSI 66 to the camera 56. Note that the camera 56 can also record video. Specifically, the camera 56 can repeatedly pick up images and repeatedly output image data to the codec LSI 66.

The sound IC 68 is a circuit connected to the speakers 67 and the microphone 69 for controlling input/output of sound data to/from the speakers 67 and the microphone 69. Specifically, when sound data is received from the codec LSI 66, the sound IC 68 outputs to the speakers 67 a sound signal obtained by performing D/A conversion on the sound data so that sound is outputted from the speakers 67. The microphone 69 senses sound propagated to the terminal device 7 (e.g., the user's voice), and outputs a sound signal representing the sound to the sound IC 68. The sound IC 68 performs A/D conversion on the sound signal from the microphone 69 to output sound data in a predetermined format to the codec LSI 66.

The infrared communication module 72 emits an infrared signal to perform infrared communication with another device. Here, for example, the infrared communication module 72 has the function of performing infrared communication in accordance with the IrDA standard and the function of outputting an infrared signal to control the television 2.

The codec LSI 66 transmits image data from the camera 56, sound data from the microphone 69, and terminal operation data from the UI controller 65 to the game apparatus 3 via the wireless module 70. In the present example embodiment, the codec LSI 66 subjects the image data and the sound data to a compression process as the codec LSI 27 does. The terminal operation data, along with the compressed image data and sound data, is outputted to the wireless module 70 as transmission data. The antenna 71 is connected to the wireless module 70, and the wireless module 70 transmits the transmission data to the game apparatus 3 via the antenna 71. The wireless module 70 has a similar function to that of the terminal communication module 28 of the game apparatus 3. Specifically, the wireless module 70 has a function of connecting to a wireless LAN by a scheme in conformity with the IEEE 802.11n standard, for example. Data to be transmitted may or may not be encrypted depending on the situation.

As described above, the transmission data to be transmitted from the terminal device 7 to the game apparatus 3 includes operation data (terminal operation data), image data, and sound data. In the case where another device is connected to the terminal device 7 via the expansion connector 58, data received from that device may be further included in the transmission data. The codec LSI 66 may transmit data received via infrared communication by the infrared communication module 72 to the game apparatus 3, along with the aforementioned transmission data, where appropriate.

As described above, compressed image data and sound data are transmitted from the game apparatus 3 to the terminal device 7. These data items are received by the codec LSI 66 via the antenna 71 and the wireless module 70. The codec LSI 66 decompresses the received image data and sound data. The decompressed image data is outputted to the LCD 51, and images are displayed on the LCD 51. The decompressed sound data is outputted to the sound IC 68, and the sound IC 68 outputs sound from the speakers 67.

Also, in the case where control data is included in the data received from the game apparatus 3, the codec LSI 66 and the UI controller 65 give control instructions to various sections in accordance with the control data. As described above, the control data is data representing control instructions for the components of the terminal device 7 (in the present example embodiment, the camera 56, the touch panel controller 61, the marker section 55, sensors 62 to 64, the infrared communication module 72, and the vibrator 79). In the present example embodiment, the control instructions represented by the control data are conceivably instructions to activate or deactivate (suspend) the components. Specifically, any components that are not used in a game may be deactivated in order to reduce power consumption, and in such a case, data from the deactivated components is not included in the transmission data to be transmitted from the terminal device 7 to the game apparatus 3. Note that the marker section 55 is configured by infrared LEDs, and therefore is simply controlled for power supply to be ON/OFF.

Furthermore, the game apparatus 3 is capable of controlling output of the infrared communication module 72, thereby controlling the operation of the television 2. Specifically, the game apparatus 3 outputs an instruction (control data as mentioned above) to the terminal device 7, thereby causing the infrared communication module 72 to output an infrared signal corresponding to a control command for controlling the television 2. In response to this instruction, the codec LSI 66 causes the infrared communication module 72 to output an infrared signal corresponding to the control command. Here, the television 2 includes an infrared light reception section capable of receiving the infrared signal. By the infrared light reception section receiving the infrared signal outputted by the infrared communication module 72, the television 2 operates in accordance with the infrared signal. Note that the instruction from the game apparatus 3 may indicate the pattern of the infrared signal, or when the terminal device 7 has the infrared signal pattern stored therein, the game apparatus 3 may provide an instruction to indicate the pattern.

While the terminal device 7 includes operating means such as the touch panel 52, the analog sticks 53 and the operation button group 54, as described above, in another example embodiment, other operating means may be included in place of or in addition to these operating means.

Also, while the terminal device 7 includes the magnetic sensor 62, the acceleration sensor 63 and the gyroscope 64 as sensors for calculating the movement of the terminal device 7 (including its position and attitude or changes in its position and attitude), in another example embodiment, only one or two of the sensors may be included. Furthermore, in another example embodiment, any other sensor may be included in place of or in addition to these sensors.

Also, while the terminal device 7 includes the camera 56 and the microphone 69, in another example embodiment, the terminal device 7 may or may not include the camera 56 and the microphone 69 or it may include only one of them.

Also, while the terminal device 7 includes the marker section 55 as a feature for calculating the positional relationship between the terminal device 7 and the controller 5 (e.g., the position and/or the attitude of the terminal device 7 as seen from the controller 5), in another example embodiment, it may not include the marker section 55. Furthermore, in another example embodiment, the terminal device 7 may include another means as the aforementioned feature for calculating the positional relationship. For example, in another example embodiment, the controller 5 may include a marker section, and the terminal device 7 may include an image pickup element. Moreover, in such a case, the marker device 6 may include an image pickup element in place of an infrared LED.

### 5. Basic Processing in the Game System 1

Next, the basic processing to be executed in the game system 1 will be described. In the game system 1, two display devices, i.e., the television 2 and the terminal device 7, are used to provide the user with images or suchlike acquired from a network, such as the Internet, in such a manner that the images can be readily viewed and allow easy operation.

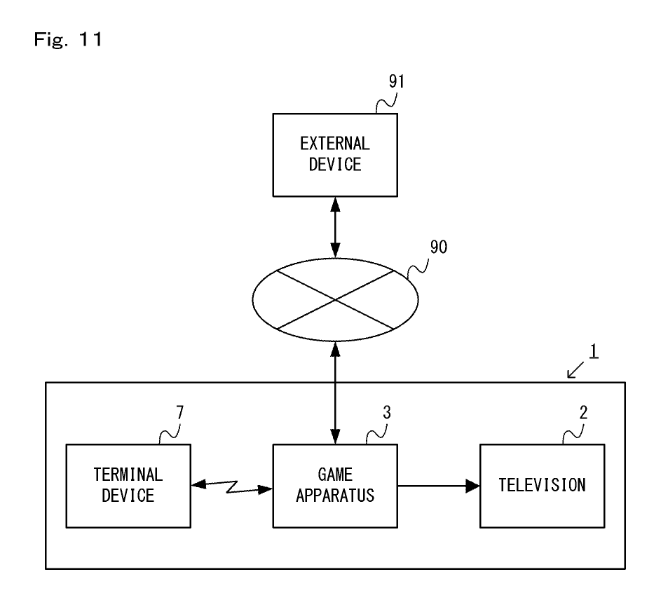

FIG. 11 is a block diagram illustrating the relationship of connection between the game system 1 and an external device. As shown in FIG. 11, the game apparatus 3 in the game system 1 is capable of communicating with an external device 91 via a network 90. The network 90 is an arbitrary communication network such as the Internet. The external device 91 is a Web server or a terminal device or suchlike capable of communicating with the game apparatus 3 (e.g., in the case where the game system 1 is used as a videophone system, a personal computer on the other side). Note that there may be more than one external device 91, and the game apparatus 3 may communicate with a plurality of external devices. The game apparatus 3 acquires information, such as a Web page and an image (a video or still image), from the external device 91 via the network 90, and outputs the acquired information, along with, for example, an image generated on the basis of the information, to the television 2 and the terminal device 7. The television 2 displays the video or still image acquired from the external device 91. The terminal device 7 displays an image (referred to as an “operation image”) for performing operations related to the image displayed on the television 2. Therefore, the user can perform various operations using the terminal device 7 at hand displaying the operation image, while viewing an image displayed on a large screen of the television 2.

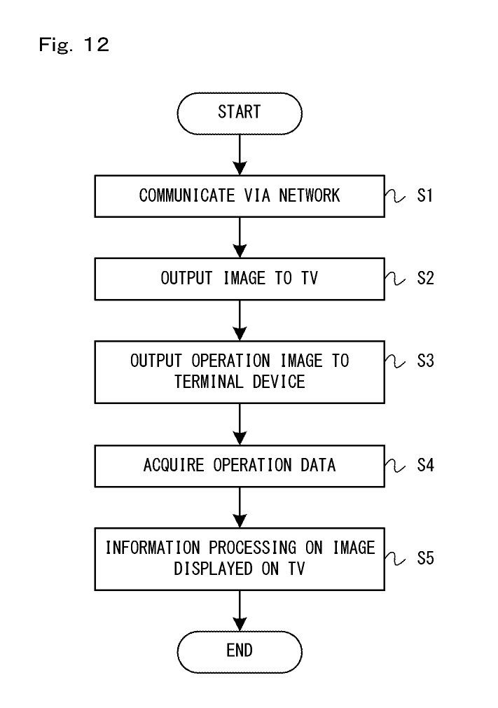

FIG. 12 is a flowchart illustrating a basic processing operation of the game apparatus 3. Note that, in addition to the processing shown in FIG. 12, the game apparatus 3 may perform a variety of types of information processing, as will be shown in operation examples to be described later.

First, in step S1, the game apparatus 3 communicates with a predetermined external device 91 via the network 90. As a result, the game apparatus 3 can acquire/transmit various data from/to the external device 91. Examples of the data to be acquired from the external device 91 conceivably include data for a Web page or a video included therein where the external device 91 is a Web server, and data for an image (shot by a camera) where the external device 91 is a videophone terminal. Note that in the case where no communication is needed, e.g., data to be used has completely been downloaded, the next processing may be performed without performing any communication.

In step S2, the game apparatus 3 outputs the image included in the data received by the process of step S1 to the television 2. The image (television image) to be displayed on the television 2 may be a video or still image. Examples of the image to be displayed on the television 2 conceivably include a video image acquired at a video search site, a video image transmitted from a videophone terminal, and a (product's) still image acquired at a shopping site.

In step S3, the game apparatus 3 outputs an operation image, which is intended for operation related to the image displayed on the television 2, to the terminal device 7. The operation image may be any image which allows the user having a look at it to perform any operation related to the image displayed on the television 2. For example, the operation image may be a Web page including images displayable on the television 2, such as a Web page showing search results at an image search site or a shopping site. In this case, for example, the user can perform an operation to specify an image included in the operation image and cause the television 2 to display the specified image. Alternatively, the operation image may include button images for performing operations to, for example, play, pause, fast-forward, rewind, and stop a video.

In step S4, the game apparatus 3 acquires operation data, which represents an operation on the operation image, from the terminal device 7. In the present example embodiment, terminal operation data as mentioned above is acquired from the terminal device 7, and any of the aforementioned terminal operation data may be used for operation. For example, data inputted with the touch panel 52 (touch position data) may be used for operation as mentioned above, or data inputted with the analog sticks 53A and 53B and the operation buttons 54A to 54L may be used for operation as mentioned above.

In step S5, the game apparatus 3 performs information processing on the image displayed on the television 2, on the basis of the operation data. Examples of the information processing conceivably include the processing for displaying an image on the television 2, the processing, for example, for playing or stopping a video, and the processing for switching the image displayed on the television 2 to another image. By the processes of steps S4 and S5, the user can perform various operations on the image displayed on the television 2 using the terminal device 7. Note that the game apparatus 3 may repeatedly perform a series of processes of steps S1 to S5 where appropriate, as will be shown in examples to be described later.

As described above, in the game system 1, an image (video or still image) is displayed on the television 2, an operation image for that image is displayed on the terminal device 7. Accordingly, the user can display an image he/she wishes to view, on the television 2 whose screen is larger than that of the terminal device 7, so that the image can be viewed in a form suitable for a plurality of viewers. The image for operation is displayed on the terminal device 7, and therefore, can be provided to the user without distracting any viewer's attention from the image displayed on the television 2. In addition, any operation for the image displayed on the television 2 is supposed to be performed using the terminal device 7, and the user can readily perform such an operation using the terminal device 7 at hand.

### 6. Examples

Hereinafter, examples of using the game system 1 will be described. Note that First to Fourth Examples shown below are merely illustrative of the possible operational processing in the game system 1, and the game system 1 may operate in a plurality of patterns from among First to Fourth Examples or may operate even in a pattern other than those in First to Fourth Examples.

### First Example

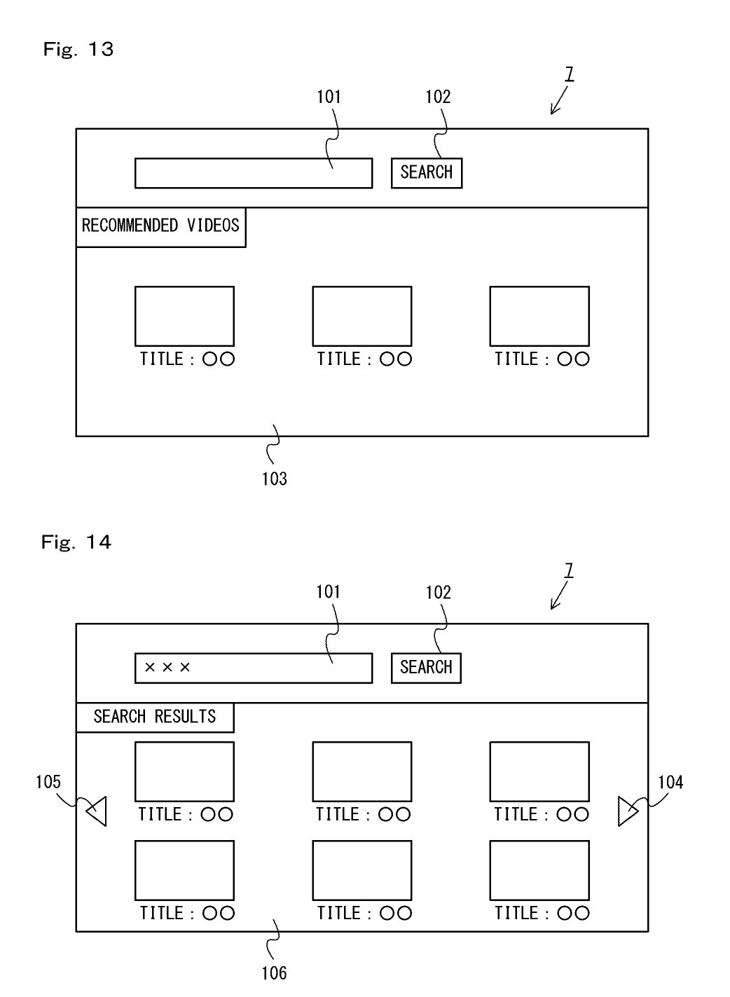

Initially, First Example will be described where the game system 1 is used to watch a video provided at a video search (viewing) site. In First Example, the game apparatus 3 has the function of a Web browser, and communicates with the server for a video search site (the external device 91) via the Internet (the network 90). The game apparatus 3 searches for a video stored in the server, and acquires the video from the server. Hereinafter, referring to FIGS. 13 to 16, the operation of the game system 1 in First Example will be outlined.

FIG. 13 is a diagram illustrating an example Web page acquired from a video search site and displayed on the terminal device 7 in First Example. The image shown in FIG. 13 is an image displayed before a video search is performed at the video search site, e.g., the top page of the video search site. The pre-search image shown in FIG. 13 includes a search entry box 101, a search button 102, and a recommendation area 103. The search entry box 101 is an area for entering a keyword to be used in a search. The search button 102 is an image indicating a button to provide an instruction to perform a search with the keyword entered in the search entry box 101. The recommendation area 103 is an area where recommended videos (e.g., videos frequently viewed) are displayed. As shown in FIG. 13, the recommendation area 103 displays thumbnails and titles of the recommended videos. Note that the thumbnails are images representing videos that can be provided at the video search site, and the thumbnails may be video or still images. Note that, in addition to the contents of FIG. 13, the terminal device 7 may display, for example, a button for closing the browser, a scroll bar for scrolling the screen, and a menu bar for performing various operations as performed in typical browsers.

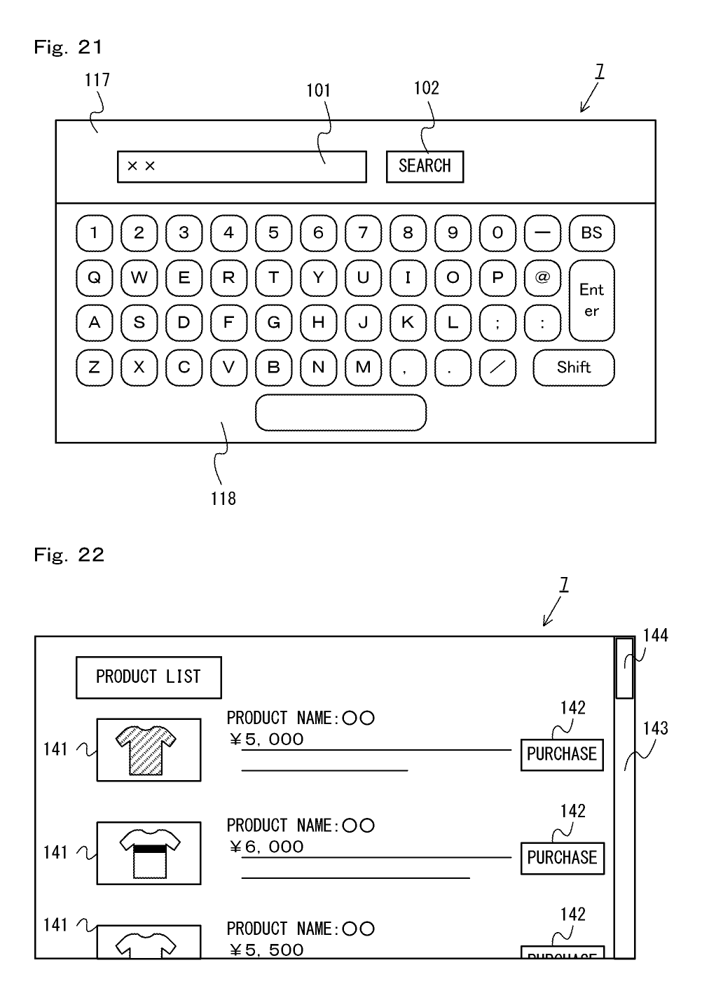

The user can perform a video search operation while viewing the pre-search image displayed on the terminal device 7. Specifically, in the case where any pre-search image is displayed, the user enters a keyword for use in a search in the search entry box 101, and operates the search button 102. As a result, information for the entered keyword and so on is transmitted from the game apparatus 3 to the server of the video search site, and a Web page showing search results is transmitted from the server to the game apparatus 3. Note that, as will be described in detail later, a predetermined character input image (FIG. 21) is displayed for the user to input characters. In addition, the touch panel 52, the analog sticks 53A and 53B, etc., are used to perform operations on the image displayed on the terminal device 7.

FIG. 14 is a diagram illustrating an example image displayed on the terminal device 7, where search results are shown. As described above, once the game apparatus 3 acquires a Web page representing search results, for example, an image as shown in FIG. 14 is displayed on the terminal device 7. The search result image shown in FIG. 14 includes a search result area 106, in place of the recommendation area 103 as included in the pre-search image shown in FIG. 13. The search result area 106 includes thumbnails, which represent found videos, and the titles of the videos. In addition, the search result area 106 includes a right scroll button 104 for scrolling the search result area 106 to the right and a left scroll button 105 for scrolling the search result area 106 to the left.

When the search result image is displayed, the user selects a video to view (play) from among the images displayed within the search result area 106. For example, the user specifies (e.g., touches) a thumbnail within the search result area 106 or the recommendation area 103, thereby selecting the thumbnail. The game apparatus 3 makes an acquisition request to the server for a video represented by the selected thumbnail. In response to the acquisition request, the server transmits the video to the game apparatus 3. Thus, the game apparatus 3 acquires the video.

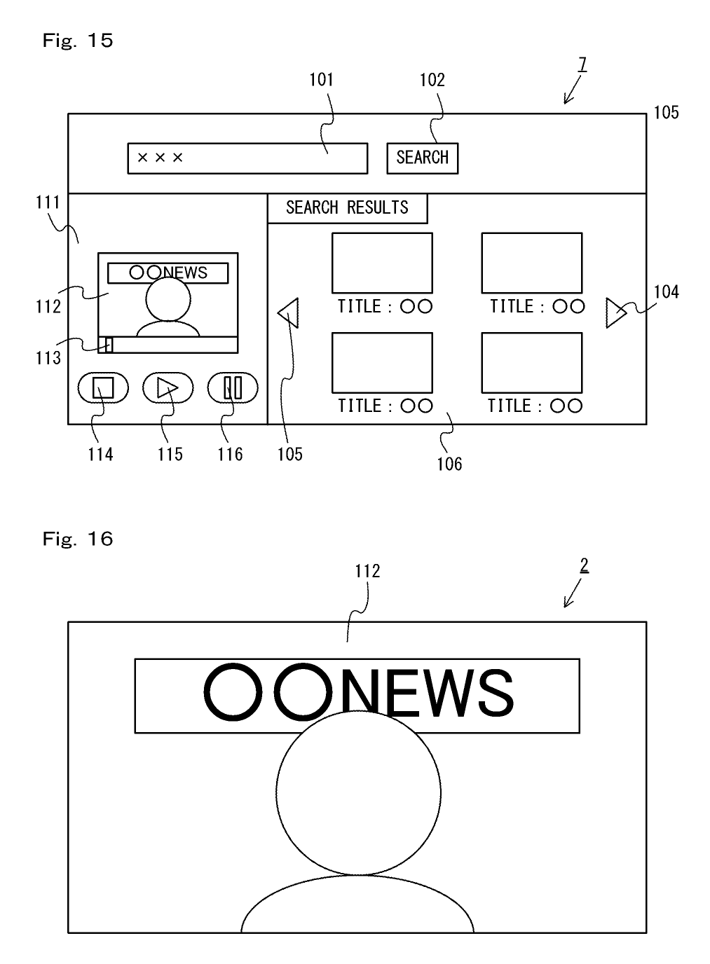

FIG. 15 is a diagram illustrating an example image for video play displayed on the terminal device 7. The image for video play shown in FIG. 15 has the search result area 106 displayed in a smaller size than in the search result image shown in FIG. 14, and additionally includes a video play area 111. The video play area 111 includes a video 112, a bar 113, a stop button 114, a play button 115, and a pause button 116. The video 112 is a video to be played on the television 2. The bar 113 indicates a play position (play point) of the video 112. In addition, the stop button 114 is an image representing a button for providing an instruction to stop playing the video 112. The play button 115 is an image representing a button for providing an instruction to play the video 112. The pause button 116 is an image representing a button for providing an instruction to temporarily stop playing the video 112. Note that the video play area 111 may include a button for providing an instruction to register a video being played as a favorite, and a button for providing an instruction to search for a video related to a video being played. Note that in another example embodiment, a video, along with the bar 113, the stop button 114, the play button 115, and the pause button 116, may be arranged, in place of thumbnails included in the search result image, without changing the size of the search result area 106.

FIG. 16 is a diagram illustrating an example image for video play displayed on the television 2. As shown in FIG. 16, the television 2 displays the video 112 to be played. Unlike the terminal device 7, the television 2 does not display the search entry box 101, the search button 102, and the search result area 106, so that the video 112 is displayed full-screen on the television 2. Note that in another example embodiment, the television 2 may display another image (e.g., the bar 113), in addition to the video 112. In this manner, a video is displayed approximately on the entire screen of the television 2, and therefore, can be readily seen even by a plurality of viewers. Moreover, the game system 1 uses the large television screen to play so powerful a video as to immerse the user in viewing it, and therefore, is suitably used for watching content, such as movies, sports, and TV dramas, for example.

Note that the terminal images shown in FIGS. 13 to 15 may be Web page images acquired from the server, or may be generated by the game apparatus 3 on the basis of Web page data. For example, in the case where operations are performed using the touch panel 52 of the terminal device 7, the buttons may be changed to larger to make operations via the touch panel 52 easy. For example, the game apparatus 3 may generate images with the search button 102, the stop button 114, the play button 115, and the pause button 116 being larger than on the Web page. Moreover, in First Example, since the video 112 is displayed in a large size on the television 2, the terminal device 7 may change the video play area 111 to be smaller than on the Web page (so that the search result area 106 is increased), or may even display no video 112.

Note that the search result image shown in FIG. 14 allows a video to be played by an operation to specify a thumbnail, and therefore, corresponds to the aforementioned operation image. In addition, the image for video play shown in FIG. 15 allows operations of playing back, stopping, and pausing a video, and therefore, corresponds to the aforementioned operation image. In addition, the pre-search image shown in FIG. 13, as with the search result image, allows the user to play a recommended video by performing an operation to select the video. Accordingly, the pre-search image also corresponds to the aforementioned operation image.

As described above, in First Example, operation images related to operations of searching for a video at a video search site and playing the video are displayed on the terminal device 7 (FIGS. 13 to 16), and the video to be played back is displayed on the television 2 (FIG. 16). As a result, it is possible to provide a video available at a video search site to the user in a form suitable for a plurality of viewers. In addition, the user can readily perform operations related to the image displayed on the television 2 using the terminal device 7 at hand.

Furthermore, in First Example, the television 2 displays nothing but the video 112, and therefore, is not used except when the video 112 is being played. That is, until the video 112 is played, the television 2 can be used for other purposes, such as watching a television program or a DVD. For example, if a user performed a video search and found an interesting video, it would be possible to watch the video on the television 2 with another user who was watching a television program on the television 2. Note that, in this case, the game apparatus 3 may control the television 2 to switch between inputs to the television 2 (e.g., the mode for displaying a television program to the mode for displaying an image from the game apparatus 3).

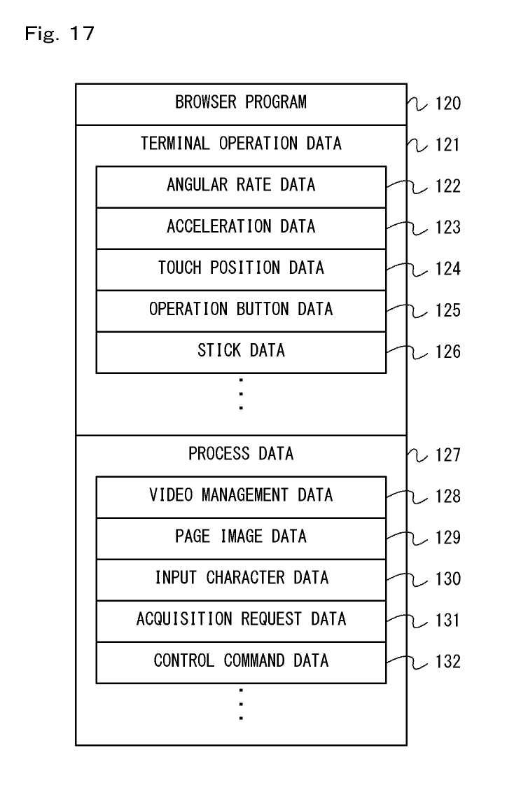

Next, referring to FIGS. 17 to 21, the processing by the game apparatus 3 in First Example will be described in detail. First, various types of data for use in the processing by the game apparatus 3 will be described. FIG. 17 is a diagram illustrating the data for use in the processing by the game apparatus 3. The data shown in FIG. 17 are main data stored in the main memory (the external main memory 12 or the internal main memory 11e) of the game apparatus 3. As shown in FIG. 17, the main memory of the game apparatus 3 has stored therein a browser program 120, terminal operation data 121, and process data 127. Note that in addition to the data shown in FIG. 17, the main memory has stored therein data to be used in the browser program 120 such as image data and sound data.

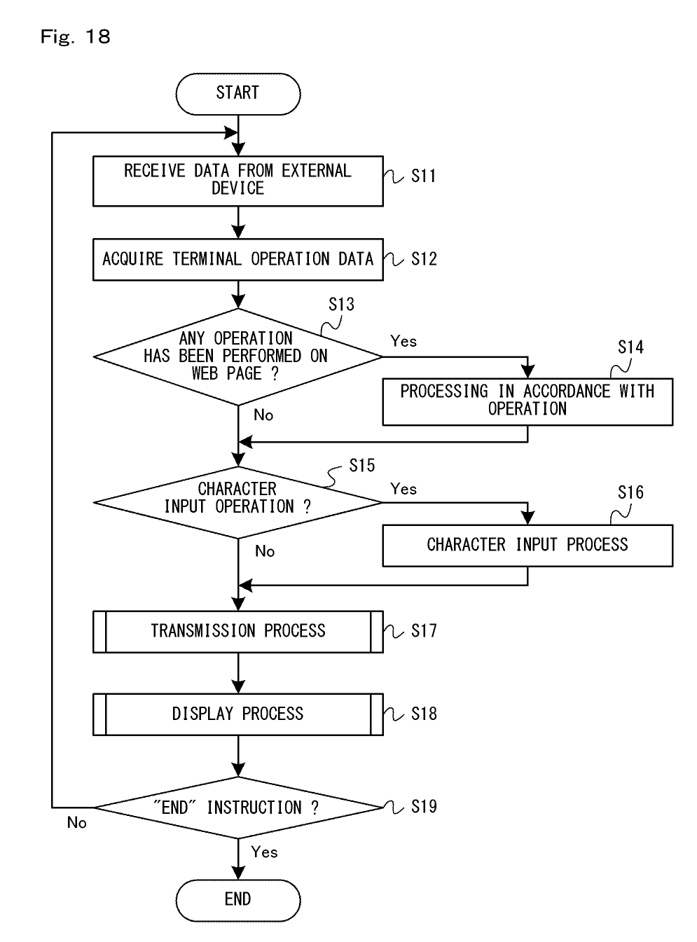

The browser program 120 is a program for causing the CPU 10 of the game apparatus 3 to execute a so-called browser function. In First Example, the CPU 10 executes the browser program 120 so that each step in a flowchart shown in FIG. 18 is executed. The browser program 120 is read in whole or in part from the flash memory 17 at an appropriate time after the power-on of the game apparatus 3, and then stored to the main memory. Note that the browser program 120 may be acquired from the optical disc 4 or a device external to the game apparatus 3 (e.g., via the Internet), rather than from the flash memory 17.

The terminal operation data 121 is data representing the player's operation on the terminal device 7. The terminal operation data 121 is transmitted by the terminal device 7, acquired by the game apparatus 3, and then stored to the main memory. The terminal operation data 121 includes angular rate data 122, acceleration data 123, touch position data 124, operation button data 125, and stick data 126. Note that the main memory may have stored therein the terminal operation data up to a predetermined number of pieces counted from the latest piece (the last acquired piece).

The angular rate data 122 is data representing angular rates detected by the gyroscope 64. In the present example embodiment, the angular rate data 122 represents angular rates about three axes, X-, Y-, and Z-axes, shown in FIG. 8, but in another embodiment, the data may represent an angular rate about each of any one or more axes.

The acceleration data 123 is data representing acceleration (acceleration vector) detected by the acceleration sensor 63. In the present example embodiment, the acceleration data 123 represents three-dimensional acceleration whose components are acceleration values associated with the directions of three axes, X-, Y-, and Z-axes, shown in FIG. 8, but in another embodiment, the data may represent acceleration associated with any one or more directions.

The touch position data 124 is data representing a position (touch position) on the input screen of the touch panel 52 at which an input has been made. In the present example embodiment, the touch position data 124 represents a coordinate value in a two-dimensional coordinate system which indicates a position on the input screen. Note that in the case where the touch panel 52 is multi-touch, the touch position data 124 may represent a plurality of touch positions.

The operation button data 125 is data representing an input state of each depressible key operation member (each of the operation buttons 54A to 54L) provided on the terminal device 7. Specifically, the operation button data 125 indicates whether any of the operation buttons 54A to 54L has been pressed.

The stick data 126 is data representing the direction and the amount of sliding (or tilting) of the stick portion of each of the analog sticks 53A and 53B. The analog stick 53 is an input device capable of an input operation by moving its operation member (stick portion) movable in any two-dimensional directions, and the stick data 126 represents the direction (operation direction) and the amount (operation amount) in which the operation member is moved. In the present example embodiment, the operation amount and the operation direction for the analog stick 53 are assumed to be represented by two-dimensional coordinates with the operation amount in the horizontal direction taken as x-component and the operation amount in the vertical direction taken as y-component.

Note that, in addition to the data 92 to 95, the terminal operation data 121 may include orientation data representing an orientation detected by the magnetic sensor 62. Moreover, in the present example embodiment, camera image data and/or microphone audio data, in addition to the terminal operation data 121, may be transmitted from the terminal device 7 to the game apparatus 3. The camera image data is data representing an image (camera image) picked up by the camera 56 of the terminal device 7. The microphone audio data is data representing audio (microphone audio) detected by the microphone 69 of the terminal device 7. Note that the camera image data and the microphone audio data may be compressed by the codec LSI 66, transmitted to the game apparatus 3, decompressed by the codec LSI 27 in the game apparatus 3, and then stored to the main memory.

Furthermore, in the case where the terminal device 7 includes another input means (e.g., a touch pad or an imaging means of the controller 5), the terminal operation data 121 may include data outputted by such an input means.

Furthermore, although not shown because the controller 5 is not used as an operating device in the present example embodiment, the main memory may have stored therein controller operation data representing the user's (player's) operation on the controller 5.

The process data 127 is data to be used in a browser process to be described later (FIG. 18). The process data 127 includes video management data 128, page image data 129, input character data 130, acquisition request data 131, and control command data 132. Note that, in addition to the data shown in FIG. 17, the process data 127 includes various types of data to be used by the browser program 120.

The video management data 128 is data for managing videos to be played (displayed) on the television 2. Data for each video to be played on the television 2 is received by the game apparatus 3 from an external device 91 (a server of a video search site) via the network 90, and stored to the flash memory 17. The video management data 128 represents information for identifying videos stored in the flash memory 17, information about the status of video reception, and information about the status of play. Note that the video reception status information indicates whether a video is being received or has already been received, and the play status information indicates whether a video has not yet been played, is being played, or has already been played.

The page image data 129 represents Web page images acquired from the external device 91, or images obtained by adding predetermined changes to the Web page images. One of the images represented by the page image data 129 that is to be displayed on the screen is displayed on the terminal device 7 as a terminal image. Note that the page image data 129 may be stored to the VRAM 11d.

The input character data 130 is data representing any character (or character string) inputted using the terminal device 7. As will be described in detail later, when the user inputs characters, a character input image (FIG. 21) is displayed on the terminal device 7, and a character is inputted through a character input operation on the character input image.

The acquisition request data 131 is data representing an acquisition request to the external device 91 for a Web page or a video. Concretely, the acquisition request data 131 represents the URL of a Web page to be acquired or video identification information. The acquisition request data 131 stored in the main memory is transmitted and stored to the flash memory 17 at an appropriate time, and then transmitted to the external device 91 by the input/output processor 11a. Note that when a plurality of acquisition requests are generated, the main memory stores acquisition request data 131 for each of the acquisition requests.

The control command data 132 is data representing a control command for controlling the television 2. In First Example, data representing various control commands for causing the television 2 to perform various operations is prestored in a storage device (the flash memory 17 or the main memory) within the game apparatus 3. The control command data 132 represents one of the control commands that is to be transmitted to the television 2.

Next, the processing to be executed by the game apparatus 3 in First Example will be described in detail with reference to FIGS. 18 to 21. FIG. 18 is a main flowchart showing a flow of the processing to be executed by the game apparatus 3 in First Example. When the game apparatus 3 is powered on, the CPU 10 of the game apparatus 3 executes a boot program stored in an unillustrated boot ROM, thereby initializing each section, including the main memory. The browser program 120 stored in the flash memory 17 is loaded to the main memory, and the CPU 10 starts executing the browser program 120. The processing shown in the flowchart of FIG. 18 is performed upon completion of the above processing. Note that the game apparatus 3 may be configured such that the browser program 120 is executed immediately after the power-on or such that an internal program for displaying a predetermined menu screen is initially executed after the power-on and then the browser program 120 is executed, for example, when the user provides an instruction to activate the browser program 120 by performing a selection operation on the menu screen.

Note that the processing in each step of the flowcharts shown in the figures is merely illustrative, and if similar results can be achieved, the processing order of the steps may be changed. In addition, values of variables and thresholds to be used in determination steps are also merely illustrative, and other values may be used appropriately. Furthermore, while the processing in each step of the flowcharts is described herein as being performed by the CPU 10, part of the steps in the flowcharts may be performed by a processor other than the CPU 10 or by specialized circuits.

Note that the game apparatus 3 can access an arbitrary Web server through the browser program 120 and acquire a Web page, but in First Example, the processing flow will be described on the assumption that the user accesses a server of a video search site as mentioned above from the game apparatus 3, and a Web page at the video search site is acquired by the game apparatus 3.

First, in step S11, the CPU 10 receives data from the external device 91 via the network 90. Specifically, the data received from the external device 91 is stored to the flash memory 17, and therefore, the CPU 10 confirms the presence or absence of received data, and, if any, the type of the received data (e.g., Web page data or video data). Note that in the case where the processing of the flowchart shown in FIG. 18 is executed, the game apparatus 3 accesses a previously registered Web server (a home page) at the beginning of the processing, and receives Web page data from the Web server. Following step S11, the process of step S12 is performed. Note that in First Example, a process loop of steps S11 to S19 is repeatedly performed once per predetermined period (one frame period, e.g., 1/60 of a second).

Note that in First Example, when video data corresponding to the acquisition request is received in step S11, data representing information related to the received video (including identification information and status information) is stored to the main memory as video management data 128.

In step S12, the CPU 10 acquires terminal operation data. The terminal device 7 repeats transmitting the terminal operation data to the game apparatus 3, and therefore, the game apparatus 3 sequentially receives the terminal operation data. More specifically, in the game apparatus 3, the terminal operation data is sequentially received by the terminal communication module 28, and stored to the main memory by the input/output processor 11a. In step S1, the CPU 10 reads the latest terminal operation data 121 from the main memory. Note that the terminal operation data 121 represents an operation on an operation image displayed on the terminal device 7. Following step S12, the process of step S13 is performed.

In step S13, the CPU 10 determines whether or not any Web page-related operation has been performed. The Web page-related operation refers to an operation to acquire a Web page or an operation performed on a Web page. The Web page-related operation may depend on a Web page and may be arbitrary, but in First Example, at least the following operations (a) to (c) can be performed:

(a) an operation to specify a link on a Web page being displayed on the terminal device 7;

(b) an operation to specify a button (e.g., the search button 102 or the play button 115) on the Web page being displayed on the terminal device 7; and

(c) an operation to specify a thumbnail included in the Web page being displayed on the terminal device 7.

In addition to the above, the Web page-related operation may encompass any operations feasible with a general browser program, including, for example, an operation to go back one Web page and an operation to specify and display a previously registered Web page (e.g., a Web page registered as a favorite).

Furthermore, the Web page-related operation may be performed in an arbitrary manner so long as the terminal device 7 is used. For example, the operation may be performed using the touch panel 52, using the analog stick 53 and the buttons 54A to 54L, or using the attitude of the terminal device 7 that is calculated on the basis of the result of detection by at least one of the sensors 62 to 64. More specifically, the operation may be to touch a link, a button, or a thumbnail on a Web page displayed on the terminal device 7, or may be to press a predetermined button after manipulating the analog stick 53 to place a cursor displayed on the terminal device 7 in a desired position. Alternatively, the touch panel 52 may be used for the operation together with the analog stick 53 and the buttons 54A to 54L. For example, a position on a Web page is specified by an operation on the touch panel 52, and the Web page is scrolled by using the analog stick 53 or the cross button 54A, so that it is rendered possible to ensure enhanced user-friendliness.

Furthermore, the determination of step S13 is made on the basis of the operation data acquired in step S12. When the result of the determination of step S13 is affirmative, the process of step S14 is performed. On the other hand, when the result of the determination of step S13 is negative, the process of step S14 is skipped, and the process of step S15 is performed.

In step S14, the CPU 10 performs processing in accordance with the Web page-related operation. For example, in the case of the operation shown above in (a), an acquisition request for a linked Web page. In the case of the operation shown above in (b), processing assigned to the specified button is performed. For example, in the case where the search button is specified, an acquisition request for search results based on an entered keyword is generated. Alternatively, a button related to video play (e.g., the play button, the stop button, or the pause button) is specified, play-related processing is performed in accordance with the specified button. In the case of the operation shown above in (c), an acquisition request for a video corresponding to a specified thumbnail is generated.

Concretely, when an acquisition request is generated in the process of step S14, data representing the acquisition request is generated as acquisition request data 131. Note that in the case where any acquisition request data 131 has already been stored in the main memory up to this point, additional acquisition request data 131 representing the acquisition request generated anew is stored to the main memory. Alternatively, in the case where an acquisition request for search results is generated, the CPU 10 reads input character data from the main memory, and generates acquisition request data 131 including a character (or a character string) represented by the input character data. On the other hand, in the case where a button related to video play is specified, data representing the function of the specified button (play, stop, or pause) is stored to the main memory. Following step S14, the process of step S15 is performed.

In step S15, the CPU 10 determines whether or not the character input operation has been performed. The character input operation may be any operation using the terminal device 7, but here, the character input operation is an input operation on key images included in the character input image (FIG. 21). Specifically, in the case where the character input image is displayed, the CPU 10 determines whether or not any key image has been touched, on the basis of the terminal operation data 121 acquired in step S12. When the result of the determination of step S15 is affirmative, the process of step S16 is performed. On the other hand, when the result of the determination of step S15 is negative, the process of step S16 is skipped, and the process of step S17 is performed.

In step S16, the CPU 10 performs a character input process. The character input process may be any process for performing character input in accordance with the user's operation. In First Example, the CPU 10 generates a new character string by adding a character or sign indicated on a key image used for an input operation to a character string already inputted, or by performing a process (e.g., a process for character deletion or character string conversion) indicated on a key image used for an input operation. Concretely, the CPU 10 reads input character data 130 representing a character string already inputted from the main memory, and generates a new character string on the basis of the input character data 130 and the terminal operation data 121 acquired in step S12. Data representing the generated character string is stored to the main memory as new input character data 130. Following step S16, the process of step S17 is performed.

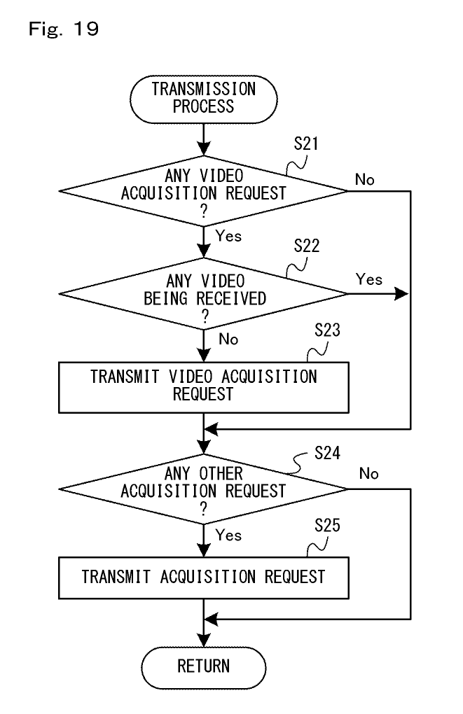

In step S17, the CPU 10 performs a transmission process. The transmission process is a process for transmitting an acquisition request for a Web page or suchlike to the external device (the server of the video search site) 91. Hereinafter, referring to FIG. 19, the transmission process will be described in detail.

FIG. 19 is a flowchart illustrating a detailed flow of the transmission process (step S17) shown in FIG. 18. In the transmission process, the CPU 10 initially in step S21 determines whether or not there is any video acquisition request. Specifically, the CPU 10 reads the acquisition request data 131 from the main memory, and determines whether or not any acquisition request data 131 stored represents a video acquisition request. When the result of the determination of step S21 is affirmative, the process of step S22 is performed. On the other hand, when the result of the determination of step S21 is negative, the processes of steps S22 and S23 are skipped, and the process of step S24 to be described later is performed.

In step S22, the CPU 10 determines whether or not any video is being received. Specifically, the CPU 10 reads the video management data 128 from the main memory, and determines whether or not the reception status information indicates any video being received. When the result of the determination of step S22 is negative, the process of step S23 is performed. On the other hand, when the result of the determination of step S22 is affirmative, the process of step S23 is skipped, and the process of step S24 to be described later is performed.

Note that in First Example, the determination process of step S22 is performed to acquire one video from the server at a time. Here, in another example, the CPU 10 may acquire a plurality of types of videos from the server at the same time (in parallel). At this time, the determination process of step S22 does not have to be performed, and when a video acquisition request is generated while data for another video is being received, the CPU 10 may transmit the acquisition request without waiting for the reception to be completed.

In step S23, the CPU 10 transmits the video acquisition request to the external device 91. Specifically, from among all of the acquisition request data 131 stored in the main memory, the CPU 10 selects a piece of data that represents a video acquisition request (e.g., the acquisition request data 131 representing the oldest acquisition request). The selected acquisition request data 131 is then stored to a predetermined region of the flash memory 17 as data to be transmitted to the network 90. Note that the selected acquisition request data 131 is deleted from the main memory. The input/output processor 11a transmits the acquisition request data stored in the flash memory 17 to the network 90 at a predetermined time. As a result, the acquisition request data is transmitted to the external device 91. Following the process of step S23, the process of step S24 is performed.

In step S24, the CPU 10 determines whether or not there is any acquisition request other than the video acquisition request. Specifically, the CPU 10 reads the acquisition request data 131 from the main memory, and determines whether or not any acquisition request data 131 stored represents an acquisition request other than the video acquisition request. When the result of the determination of step S24 is affirmative, the process of step S25 is performed. On the other hand, when the result of the determination of step S24 is negative, the process of step S25 is skipped, and the CPU 10 ends the transmission process.

In step S25, the CPU 10 transmits the acquisition request to the external device 91. Specifically, from among all of the acquisition request data 131 stored in the main memory, the CPU 10 selects a piece of data that represents the acquisition request and stores the selected data to a predetermined region of the flash memory 17 as data to be transmitted to the network 90. Note that the selected acquisition request data 131 is deleted from the main memory. The input/output processor 11a transmits the acquisition request data stored in the flash memory 17 to the network 90 at a predetermined time. As a result, the acquisition request data is transmitted to the external device 91. After the process of step S25, the CPU 10 ends the transmission process.

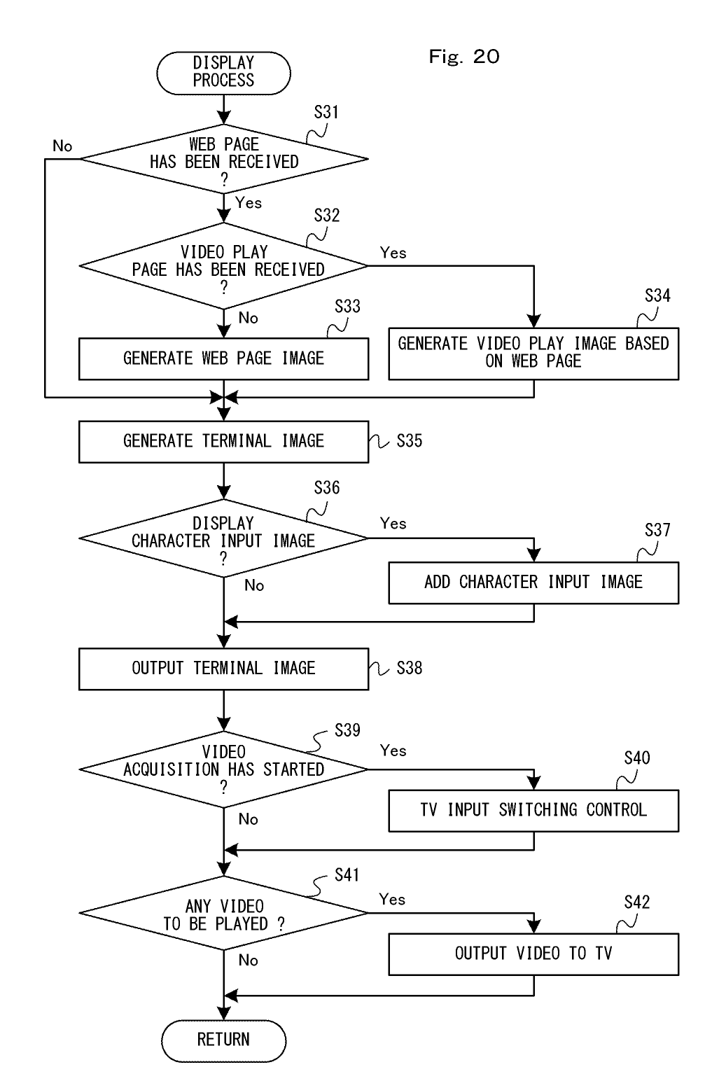

Returning to the description of FIG. 18, the process of step S18 is performed after the transmission process of step S17. In step S18, the CPU 10 performs a display process. The display process is a process for generating images to be displayed on the terminal device 7 and the television 2, and causing these display devices to display the generated images. Hereinafter, referring to FIG. 20, the display process will be described in detail.

FIG. 20 is a flowchart illustrating a detailed flow of the display process (step S18) shown in FIG. 18. In the display process, the CPU 10 initially in step S31 determines whether the data received in step S11 is Web page data or not. Note that the determination of step S31 may be made on the basis of whether the received data is equivalent to one entire page or whether the received data is equivalent to a portion of one page. In the latter case, on the basis of the received data, images are sequentially generated in the process of step S33 or S34 to be described later. When the result of the determination of step S31 is affirmative, the process of step S32 is performed. On the other hand, when the result of the determination of step S31 is negative, the process of step S35 to be described later is performed.

In step S32, the CPU 10 determines whether the data received in step S11 is a Web page for video play or not. The Web page for video play refers to a Web page including a display area for a video to be played, e.g., the Web page including the video play area 111 as shown in FIG. 15. When the result of the determination of step S32 is negative, the process of step S33 is performed. On the other hand, when the result of the determination of step S32 is affirmative, the process of step S34 is performed.

In step S33, the CPU 10, in concert with the GPU 11b, generates an image for the Web page received in step S11. Here, in First Example, any Web page other than the Web page for video play is displayed without modifying the original arrangement of a text, images, etc., included therein. That is, in step S33, a Web page image is generated in accordance with the Web page data received in step S11. Note that in another example embodiment, the image for the Web page other than the Web page for video play may be generated by modifying a Web page provided from the server, for example, such that buttons included therein are displayed in a larger size.

Concretely, in the process of step S33, the CPU 10 reads the Web page data stored in the flash memory 17, and generates a Web page image on the basis of that data. Data for the generated image is stored to the main memory as page image data 129. Following step S33, the process of step S35 is performed.

On the other hand, in step S34, the CPU 10, in concert with the GPU 11b, generates an image for video play on the basis of the Web page data. Here, in First Example, the video to be played is displayed on the television 2. Moreover, in First Example, while the video is being played on the television 2, the user can use the terminal device 7 to perform an operation to search for another video or select the next video to be played. Accordingly, here, the CPU 10 generates the image for video play with the video play area 111 smaller than the size determined for the Web page (so that the search result area 106 increases). Thus, operations as mentioned above can be readily performed during video play.

Concretely, in the process of step S34, the CPU 10 reads the Web page data (for video play) stored in the flash memory 17, and generates an image for video play on the basis of that data. Data for the generated image is stored to the main memory as page image data 129. Following step S34, the process of step S35 is performed.

Note that in First Example, the CPU 10 displays the image for video play on the terminal device 7 after modifying a Web page acquired from the server, but other Web pages, such as a pre-search image and a search result image, are displayed as-is (without modification). Here, in another example, the CPU 10 may modify the other web pages as well, and display the modified images on the terminal device 7. Note that whether or not to modify Web pages acquired from servers is determined for each Web page or for each server. Accordingly, the CPU 10 may change whether or not to modify a Web page in accordance with the server that provides the Web page or in accordance with the content of the Web page. For example, only the Web pages acquired from a predetermined server may be modified, or when Web pages include images smaller than a predetermined size (e.g., button images), such images may be modified to be larger.

In step S35, the CPU 10, in concert with the GPU 11b, generates a terminal image to be displayed on the terminal device 7. Concretely, the CPU 10 reads the page image data 129 from the main memory, and extracts an image equivalent to an area for one screen to be displayed on the terminal device 7, from the image represented by the page image data 129, as a terminal image. Data for the extracted terminal image is stored to the VRAM 11d. Note that the area to be extracted as the terminal image changes in accordance with an operation to scroll the screen. Following step S35, the process of step S36 is performed.

In step S36, the CPU 10 determines whether or not to display a character input image. Concretely, the CPU 10 determines whether or not a predetermined operation to display the character input image has been performed, on the basis of the terminal operation data acquired in step S12. The predetermined operation may be any operation such as an operation of pressing a predetermined button of the terminal device 7 or an operation of specifying the search entry box 101 displayed on the terminal device 7. When the result of the determination of step S36 is affirmative, the process of step S37 is performed. On the other hand, when the result of the determination of step S36 is negative, the process of step S37 is skipped, and the process of step S38 is performed.

In step S37, the CPU 10 adds the character input image to the terminal image. FIG. 21 is a diagram illustrating an example terminal image having the character input image added thereto. The CPU 10 generates an image by adding a character input image 118 to a Web page image 117, as shown in FIG. 21. The character input image 118 is an image for character input, and includes images of keys representing characters and symbols. In FIG. 21, the character input image 118 is an image of a so-called software keyboard. The character input image 118 is prepared along with the browser program 120, and stored to the VRAM 11d (or the main memory) at an appropriate time. Note that in First Example, the CPU 10 generates an image by adding the character input image 118 to the Web page image 117, but in another example embodiment, only the character input image may be generated as a terminal image. Concretely, in the process of step S36, the CPU 10 reads the terminal image data and the character input image data stored in step S35 from the VRAM 11d, and generates an image by adding the character input image to the Web page image represented by the page image data 129. Data for the generated image is stored to the VRAM 11d as new terminal image data. Following step S37, the process of step S38 is performed.

As described above, in First Example, the CPU 10, responsive to the user's predetermined operation (Yes in step S36), outputs the character input image (FIG. 21), including the key images by which characters can be inputted, to the terminal device 7 (step S37). As a result, the user can readily input characters using the terminal device 7. In the case, for example, where a search keyword is entered as in First Example, or where predetermined information is entered to be used for product purchase in Second Example to be described later, the character input image can be usefully displayed.

In step S38, the CPU 10 outputs (transmits) the terminal image to the terminal device 7. Concretely, the CPU 10 transfers the terminal image data stored in the VRAM 11d to the codec LSI 27, and the codec LSI 27 subjects the image data to a predetermined compression process. The terminal communication module 28 transmits the compressed image data to the terminal device 7 via the antenna 29. The terminal device 7 receives the image data transmitted by the game apparatus 3 at the wireless module 70, and the codec LSI 66 subjects the received image data to a predetermined decompression process. The decompressed image data is outputted to the LCD 51. As a result, the terminal image is displayed on the LCD 51. Moreover, in step S38, audio data may be transmitted to the terminal device 7, along with the image data, so that audio is outputted by the speakers 67 of the terminal device 7. Following step S38, the process of step S39 is performed.

In step S39, the CPU 10 determines whether or not reception of any video to be played on the television 2 has started. Specifically, it is determined whether or not the video transmitted by the external device 91 in response to the acquisition request transmitted in step S23 has been received. When the result of the determination of step S39 is affirmative, the process of step S40 is performed. On the other hand, when the result of the determination of step S40 is negative, the process of step S41 to be described later is performed.

In step S40, the CPU 10 performs control for switching inputs to the television 2. Concretely, the CPU 10 outputs a control command to the television 2 such that images outputted by the game apparatus 3 can be displayed. Outputted here is a predetermined control command for switching the input source of the television 2 to the game apparatus 3 (the mode is switched such that images outputted by the game apparatus 3 can be displayed on the screen). Note that in First Example, the flash memory 17 or the main memory has stored therein data representing various control commands for causing the television 2 to perform various operations. The CPU 10 picks out data representing the predetermined control command from among these various control commands, and stores that data to the main memory as control command data 132. Note that in another example embodiment, the CPU 10 may output a control command to turn on the television 2 before outputting the predetermined control command mentioned above.

By the process of step S40, the television 2 is controlled such that an image (video) can be displayed, before the image is outputted to the television 2. Thus, it is rendered possible for the user to display images on the television 2 without manipulating the television 2, ensuring easier operations.

Here, any arbitrary method can be employed for controlling the television 2 using the control command generated by the game apparatus 3. In the game system 1, the television 2 can be controlled by a first method in which the infrared communication module 72 of the terminal device 7 outputs an infrared signal corresponding to the control command, and/or a second method in which the control command is outputted via the AV connector 16 of the game apparatus 3. In the first method, the CPU 10 transmits an instruction to the terminal device 7, such that the infrared communication module 72 outputs an infrared signal corresponding to the control command represented by the control command data 132. In response to this instruction, the codec LSI 66 of the terminal device 7 causes the infrared communication module 72 to output the infrared signal corresponding to the control command. The infrared light reception section of the television 2 receives the infrared signal, so that the television 2 is turned on and the input source of the television 2 is switched to the game apparatus 3. On the other hand, in the second method, the CPU 10 outputs the control command represented by the control command data 132 to the television 2 via the AV connector 16. Following step S40, the process of step S41 is performed.

Note that the format of the infrared signal or the control command for controlling the television 2 might vary depending on the model of the television 2. Accordingly, the game apparatus 3 may have previously stored therein infrared signals or control commands in formats corresponding to a plurality of models. In this case, the game apparatus 3 may select a format corresponding to the television 2 at a predetermined time (e.g., at the time of initial setting), and use infrared signals or control commands in the selected format thereafter. Thus, the game apparatus 3 can be compatible with a plurality of models of television.

In step S41, the CPU 10 determines whether or not there is any video to be played on the television 2. Specifically, the CPU 10 reads the video management data 128 from the main memory, and determines whether or not the flash memory 17 has stored therein data for any video whose play status information indicates “playing”. When the result of the determination of step S41 is affirmative, the process of step S42 is performed. On the other hand, when the result of the determination of step S41 is negative, the process of step S42 is skipped, and the CPU 10 ends the display process.

In step S42, the CPU 10 outputs the video to the television 2. The CPU 10 initially reads the video data stored in the flash memory 17, and stores one of the images included in the video to the VRAM 11d. At this time, the CPU 10 and the GPU 11b collaborate to, where appropriate, perform a process to generate the image from the data stored in the flash memory 17. For example, in the case where the video data stored in the flash memory 17 is compressed in predetermined scheme, the video data is subjected to a decompression process to generate the image. Alternatively, in the case where the video data is stored in packets, the image is generated from packet data. The image stored in the VRAM 11d is transferred to the AV-IC 15, and the AV-IC 15 outputs the image to the television 2 via the AV connector 16. As a result, the image included in the video is displayed on the television 2. Moreover, in another example embodiment, audio data may be acquired from the external device 91, along with video data, and in step S42, the audio data, along with the video data, may be outputted to the television 2, so that the speakers 2a of the television 2 emit sound.

Note that the video outputted to the television 2 in step S42 is a video whose play status information represented by the video management data 128 indicates “playing”. Note that once video play ends, the CPU 10 reads the video management data 128 from the main memory, and changes the play status information for the video that has been played from “playing” to “played”. In addition, the next video to be played has its play status information changed from “not played” to “playing”. As a result, play of the video is started by step S42 being performed next. Note that “the next video to be played” may be the earliest acquired video or may be the largest video in terms of received data size. In addition, in the case where there is no video for which sufficient data is received to start play, the CPU 10 may wait until sufficient data is received, and then start video play. In First Example, video play is started while video data is being received as in so-called streaming and progressive download schemes, but in another example, video play is started upon reception of the entire video data from the server. In addition, any video data with status information “played” may be deleted from the flash memory 17.

Furthermore, in the case where a button related to video play is specified in step S14, video play in the process of step S42 is performed in accordance with the specified button. Specifically, in the case where the play button is specified, an image included in the video is sequentially generated every time the process of step S42 is performed, and then stored to the VRAM 11d. On the other hand, in the case where the pause button is specified, the image to be stored to the VRAM 11d does not change, so that the same image as that last outputted is outputted. Moreover, in the case where the stop button is specified, images stored in the VRAM 11d are deleted, and image output to the television 2 stops. After step S42, the CPU 10 ends the display process.

Returning to the description of FIG. 18, the process of step S19 is performed after the display process of step S18. In step S19, the CPU 10 determines whether or not an instruction has been given to end execution of the browser program 120. When the result of the determination of step S19 is negative, the process of step S11 is performed again. On the other hand, when the result of the determination of step S19 is affirmative, the CPU 10 ends the processing shown in FIG. 18. Thereafter, a series of processes of steps S11 to S19 are repeatedly performed until the determination of step S19 indicates that the instruction has been given.

As described above, in First Example, an image (video) included in data received by the game apparatus 3 is outputted to the television 2 (step S42), and an operation image (FIGS. 13 to 15) for operations related to the outputted image is outputted to the terminal device 7 (step S38). In addition, the game apparatus 3 acquires operation data, which represents an operation on an operation image, from the terminal device 7 (step S12), and performs information processing related to the image to be displayed on the television 2, on the basis of the operation data (step S14).

More specifically, by the processing in First Example, the game apparatus 3 can perform, for example, the following operations. The game apparatus 3 initially accesses a server of a video search site to receive Web page data (step S11), and outputs the Web page to the terminal device 7 (step S33, S35, or S38). As a result, a pre-search image as mentioned above (FIG. 13) is displayed on the terminal device 7. Thereafter, a character input image (FIG. 21) is displayed in accordance with the user's predetermined operation (step S37), and the user performs a character input operation on the character input image, thereby entering a character string as a search keyword (step S16). Moreover, by the user specifying the search button 102, an acquisition request is transmitted to the server to obtain search results for the character string entered as a search keyword (step S25). In response to this, Web page data for the search results is acquired from the server, representing a plurality of types of videos (step S11). Once the data is acquired, the CPU 10 outputs the Web page with the search results to the terminal device 7 (step S33). As a result, an operation image representing the videos (FIG. 14) is displayed on the terminal device 7.

In the case where the user specifies a thumbnail included in the Web page for search results (step S14), a video acquisition request is transmitted to the server (step S23). In response to this, the server transmits a video to the game apparatus 3, and the game apparatus 3 receives the video. That is, the game apparatus 3 requests the server for the video selected by the process of step S14, and receives data for the video from the server. The received video is outputted to the television 2 (step S42; FIG. 16). On the other hand, an image for video play (FIG. 15) is outputted to the terminal device 7 (step S34). In this manner, in the case where the received video is outputted to the television 2, an operation image at least representing an operation related to play of the video is outputted to the terminal device 7. Thus, in First Example, a video acquired at a video search site can be presented on the television 2 so that the user can view the video more readily, and the user can also readily perform an operation related to the video using the terminal device 7.

Furthermore, in First Example, while a video is being played on the television 2, it is possible to acquire and display another Web page using the terminal device 7 as in the case where no video is being played. Therefore, even when the video is being played, the user can perform another search to have search results displayed. Thus, in First Example, even when playing a video, the user can see another Web page using the terminal device 7, and therefore can enjoy more stress-free Web page browsing.

Furthermore, in First Example, while a video is being played on the television 2, the user can use the terminal device 7 to acquire a video desired to be played next. Specifically, the CPU 10 performs a process for selecting a video to be displayed on the television 2 whether or not another video is being outputted to the television 2 (step S14). In response to this, an acquisition request for the selected video is transmitted to the server (step S23), and data for the video is received from the server in accordance with the acquisition request (step S11). Here, in the case where the CPU 10 receives data for a video while another video is being outputted to the television 2, output of the received video is started after (play of) the video being outputted is finished (step S42). In this manner, in First Example, while a video is being played, an acquisition request for the next video is generated, data for the next video is received, and then the next video is played after the video currently being played. Thus, in First Example, while a video is being played, another video to be displayed next can be set in advance using the terminal device 7.

While First Example has been described taking as an example the case where the game apparatus 3 receives a video from the server of the video search site, the game apparatus 3 can operate in the same manner as in First Example even in the case where videos are received from arbitrary video distribution servers other than the video search site, e.g., servers for distributing videos of movies and television programs. Note that in the case where a video is received from a television program distribution server, the game apparatus 3 may receive an EPG (electronic program guide) image, as described later in Fourth Example, from the server, and output the EPG image to the terminal device 7 on which the EPG image is displayed as an operation image. For example, by the user selecting a desired program from the EPG image displayed on the terminal device 7, video data for the desired program may be transmitted by the server and displayed on the television 2.

### Second Example

Described below is Second Example in which the game system 1 is used for the television 2 to display images of products provided at a shopping site. In Second Example, as in First Example, the game apparatus 3 has the function of a Web browser, and communicates with a server (external device 91) of the shopping site via the Internet (network 90). The game apparatus 3 acquires Web pages that offer products from the site and images of the products. The operation of the game system 1 in Second Example will now be described.

FIG. 22 is a diagram illustrating an example Web page acquired from a shopping site and displayed on the terminal device 7 in Second Example. The image shown in FIG. 22 is intended to offer products at the shopping site, and includes product images 141 and purchase buttons 142. The product images 141 represent products. In Second Example, the product images 141 are still images, but in another example, they may be videos. The purchase buttons 142 are intended for the user to purchase products. In FIG. 22, a scroll bar 143 and a thumb 144 for scrolling the screen up and down are shown. Note that, as in First Example, the terminal device 7 may display, for example, buttons and a menu bar for performing various operations as performed in typical browsers.

In Second Example, the game apparatus 3 causes the television 2 to display one of the product images 141 displayed on the terminal device 7 in accordance with the user's selection. Specifically, in the case where the terminal device 7 displays one or more product images 141, when the user performs an operation of selecting any product image 141 (e.g., an operation of touching the product image 141 or an operation of pressing a predetermined button after placing the cursor in the position of the product image 141), the game apparatus 3 outputs the product image 141 to the television 2. By displaying the product image 141 on the television 2 with a large screen, it is possible to present the product image such that even more than one user can readily see the image. In addition, any operation related to the product image displayed on the television 2 is performed using the terminal device 7, and therefore, the user can readily perform the operation using the terminal device 7 at hand. For example, in Second Example, it is possible that the user who considers purchasing a product at a shopping site using the terminal device 7 displays an image of the product on the television 2 in order to show the product's image to other users (his/her family and friends) and to hear their comments and opinions on the product.

The processing by the game apparatus 3 in Second Example will be described in detail below. In Second Example, the CPU 10 executes the browser program to perform the processing, as in First Example. The following description of the processing in Second Example mainly focuses on the difference from First Example.

In Second Example, the processing is performed in accordance with the flowchart shown in FIG. 18, as in First Example. Note that in Second Example, as for steps S13 and S14, the processing can be performed not only in accordance with the operations as specified above in (a) to (c), as in First Example, but also in accordance with the following manner. Specifically, in the case where an operation of specifying the purchase button 142 is performed in step S13, an acquisition request for an input page for product purchase is generated in the process of step S14. The input page for product purchase refers to a Web page for inputting predetermined information for use in purchasing products (e.g., the purchaser's ID, password, credit card number, etc.). Alternatively, in the case where an operation of specifying a product image 141 included in a Web page displayed on the terminal device 7 is performed in step S13, an acquisition request for a product image to be displayed on the television 2 is generated.

Furthermore, as for the transmission process of step S17, in Second Example, no video is acquired from the server of the shopping site, and therefore, the processes of steps S21 to S23 are not performed. Note that in the case where an acquisition request for a product image is generated in the process of step S14, the acquisition request is transmitted to the server in the process of step S25.

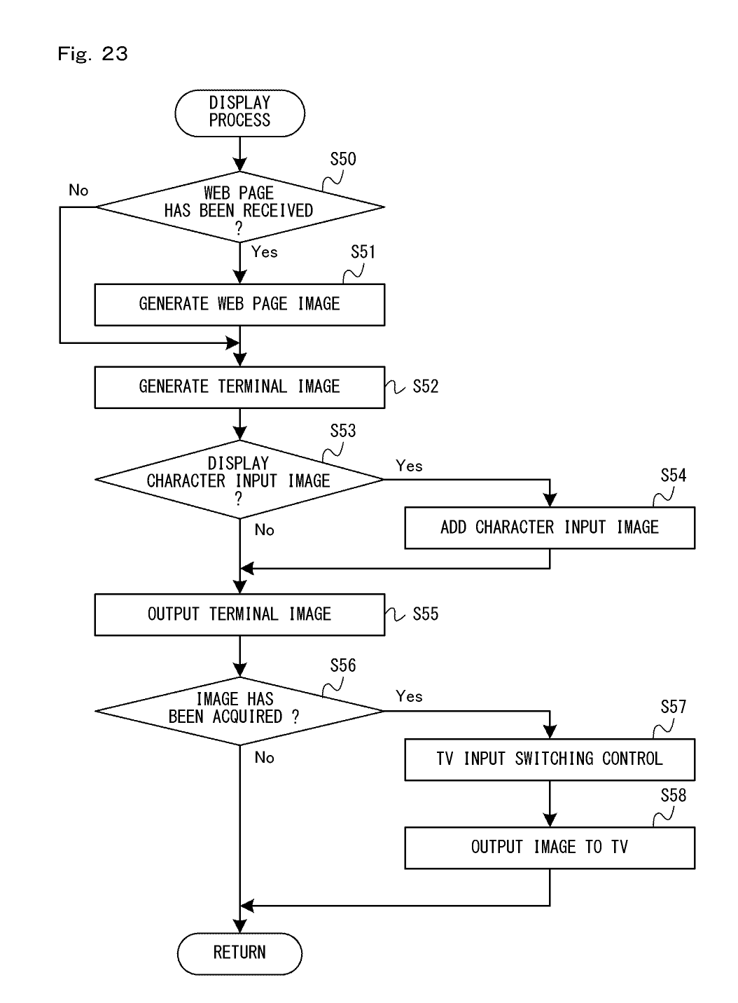

Furthermore, Second Example differs from First Example in the display process of step S18. FIG. 23 is a flowchart illustrating a detailed flow of the display process (step S18) in Second Example. In the display process of Second Example, the CPU 10 initially in step S50 determines whether or not any Web page data has been received in the process of step S11. The process of step S50 is the same as the process of step S31 in First Example. When the result of the determination of step S50 is affirmative, the process of step S51 is performed. On the other hand, when the result of the determination of step S50 is negative, the process of step S51 is skipped, and the process of step S52 is performed.

In step S51, the CPU 10, in concert with the GPU 11b, generates an image for the Web page received in step S11. The process of step S51 is the same as the process of step S32 in First Example. Note that in Second Example, the Web page acquired from the server is displayed without modifying the original arrangement of a text, images, etc., included therein, but an image may be generated by modifying the Web page as in step S34 of First Example. Following step S51, the process of step S52 is performed.

In step S52, the CPU 10, in concert with the GPU 11b, generates a terminal image to be displayed on the terminal device 7. The process of step S52 is the same as the process of step S35 in First Example. Following step S52, the process of step S53 is performed.

In step S53, the CPU 10 determines whether or not to display a character input image. When the result of the determination of step S53 is affirmative, the process of step S54 is performed. On the other hand, when the result of the determination of step S53 is negative, the process of step S54 is skipped, and the process of step S55 is performed. The processes of steps S53 and S54 are the same as the processes of steps S36 and S37, respectively, in First Example. Note that in Second Example, the character input image is displayed, for example, when entering a search keyword for product search or when entering information for use in purchasing products (e.g., the purchaser's ID, password, credit card number, etc.) in the aforementioned input page for product purchase displayed on the terminal device 7.

In step S55, the CPU 10 outputs (transmits) the terminal image to the terminal device 7. The process of step S55 is the same as the process of step S38 in First Example. Following step S55, the process of step S57 is performed.

In step S56, the CPU 10 determines whether or not data for the product image to be displayed on the television 2 has been received in the process of step S11. Note that in Second Example, image management data for managing the image to be played (displayed) on the television 2 is stored to the main memory. Moreover, in the case where the product image data has been received in the process of step S11, image management data representing information for identifying the product image and reception status information for the product image is stored to the main memory. Accordingly, the determination of step S56 can be made by reading and referring to the image management data from the main memory. When the result of the determination of step S56 is affirmative, the process of step S57 is performed. On the other hand, when the result of the determination of step S56 is negative, the processes of steps S57 and S58 are skipped, and the CPU 10 ends the display process.

In step S57, the CPU 10 performs control for switching inputs to the television 2. The process of step S57 is the same as the process of step S40 in First Example. By the process of step S57, the television 2 is controlled such that product images can be displayed (images outputted by the game apparatus 3 can be displayed). Following step S57, the process of step S58 is performed.

In step S58, the CPU 10 outputs the product image to the television 2. The CPU 10 initially reads the product image data stored in the flash memory 17, and stores the data to the VRAM 11d. At this time, the CPU 10 and the GPU 11b may collaborate to, where appropriate, perform a process to generate the image from the data stored in the flash memory 17, as in the process of step S42 in First Example. The image stored in the VRAM 11d is transferred to the AV-IC 15, and the AV-IC 15 outputs the image to the television 2 via the AV connector 16. As a result, the product image is displayed on the television 2. Note that in the case where the user thereafter performs an operation to select a new product image using the terminal device 7, the image currently displayed on the television 2 is switched to that new product image in response to data for the new product image. In addition, the CPU 10 may stop outputting the image to the television 2 in response to the user providing a predetermined instruction to stop display using the terminal device 7. Following step S58, the CPU 10 ends the display process. This is the end of the description of the processing by the game apparatus 3 in Second Example.

Note that in Second Example, when a product image is displayed on the television 2, data for the product image to be displayed is acquired anew from the server. Here, in another example, the CPU 10 may use a product image included in an already acquired Web page (an operation image displayed on a terminal device) as the product image to be displayed on the television 2. Specifically, in the case where an operation to specify a product image included in a Web page displayed on the terminal device 7 is performed in step S13, the CPU 10 may output the product image to the television 2.

As described above, in Second Example, an image (product image) included in data received by the game apparatus 3 is outputted to the television 2 (step S58), and an operation image (FIG. 22) for operations related to the outputted image is outputted to the terminal device 7 (step S55). In addition, the game apparatus 3 acquires operation data, which represents an operation on the operation image, from the terminal device 7 (step S12), and performs information processing related to the image to be displayed on the television 2, on the basis of the operation data (step S14).

More specifically, by the processing in Second Example, the game apparatus 3 can perform, for example, the following operations. The game apparatus 3 initially accesses a server of a shopping site to receive data for a Web page which offers products (step S11), and outputs the Web page to the terminal device 7 (step S55). Specifically, the game apparatus 3 receives data for images of a plurality of products from the server having stored therein information on a plurality of products, and outputs an operation image including the product images to the terminal device 7. In addition, when the user specifies any product image included in the Web page (step S14), an acquisition request for that product image is transmitted to the server (step S25). In response to this, the product image is transmitted from the server to the game apparatus 3, and the product image received by the game apparatus 3 is outputted to the television 2 (step S59). That is, the CPU 10 selects one of the product images that is to be displayed on the television 2, and outputs the selected product image to the television 2. Thus, in Second Example, a product image acquired at a shopping site can be presented on the television 2 so that the user can view the image more readily, and can also readily perform an operation related to the image using the terminal device 7.

Furthermore, in Second Example, the CPU 10 accepts input of predetermined information for product purchase (step S16), and outputs an image including the inputted information to the terminal device 7 (step S55). Here, in Second Example, the predetermined information is displayed on the terminal device 7, rather than on the television 2, and therefore, any users other than the purchaser using the terminal device 7 cannot see the predetermined information. Thus, in Second Example, the purchaser can make a purchase at a shopping site without any other users seeing the predetermined information, such as ID, password, credit card number, etc., which should not be revealed to others.

In this manner, in First and Second Examples, the game apparatus 3 receives data representing a plurality of types of images (step S11), and outputs an operation image including these images (FIGS. 13 to 15, and FIG. 22) to the terminal device 7 (step S38 or S55). Moreover, the CPU 10 performs an operation to select one of the images that is to be displayed on the television 2 on the basis of the terminal operation data (step S14). The game apparatus 3 transmits an acquisition request for the selected image to the server (step S23), and receives data for the selected image transmitted by the server in response to the request (step S11). The selected image is then outputted to the television 2. In this manner, in First and Second Examples, the user can specify an image to be displayed on the television 2 by performing an operation to select one of the images included in an operation image displayed on the terminal device 7. Thus, the image to be displayed on the television 2 can be readily selected using the terminal device 7.

Furthermore, in First and Second Examples, the CPU 10 acquires a search keyword entered by the user on the basis of terminal operation data (step S16). Correspondingly, the game apparatus 3 transmits the acquired search keyword to the server (step S25), and receives data representing a plurality of types of images from the server as search result data for the search keyword (step S11). In addition, once the search result data is received, the CPU 10 outputs an operation image including the plurality of types of images (FIG. 14) to the terminal device 7 as an image representing search results (step S38 or S55). Thus, in First and Second Examples, a search for an image to be displayed on the television 2 can be performed by the terminal device 7, so that search results can be confirmed by the terminal device 7. Moreover, by selecting an image included in the search results, the selected image can be displayed on the television 2.

### Third Example

Described below is Third Example in which the game system 1 is used for the television 2 to display an image of the other person on the videophone. In Third Example, the game apparatus 3 has the function of a videophone, and exchanges video and audio with another device via a predetermined network. In Third Example, the external device 91 shown in FIG. 11 is the device on the other side (destination device). The destination device has the function of a videophone allowing communication with the game apparatus 3, and may or may not be configured in the same manner as in the game system 1. In addition, the network for connecting the game apparatus 3 and the external device 91 may be the Internet or another dedicated network.

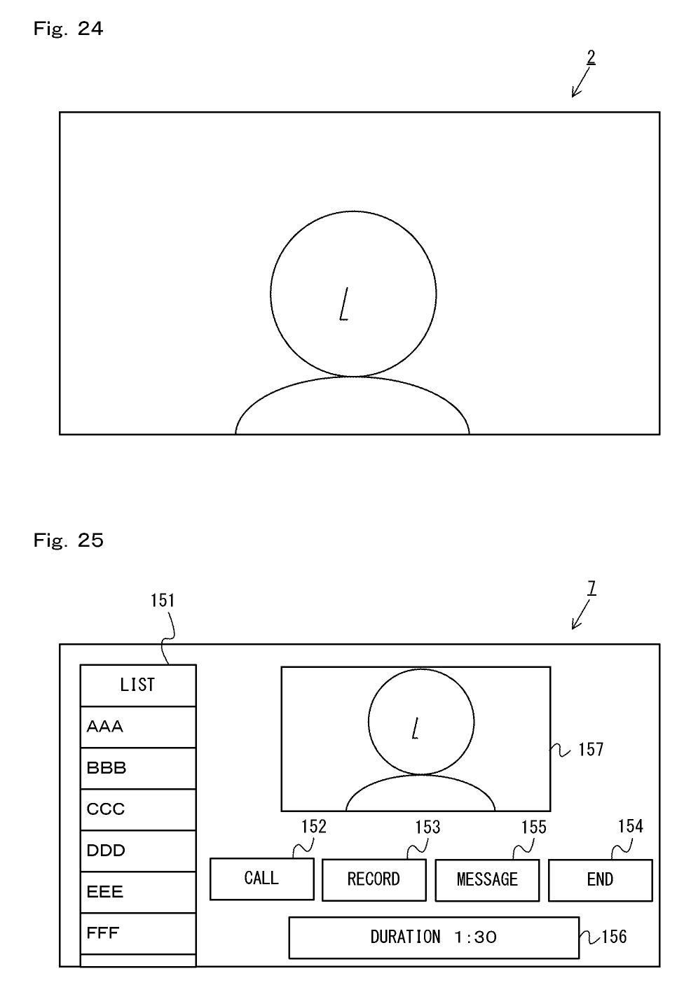

FIG. 24 is a diagram illustrating an example image displayed on the television 2 in Third Example. As shown in FIG. 24, the television 2 displays an image (video) of the other person on the videophone. Note that, in addition to the image, the television 2 may display the name of the person on the other side and so on. Moreover, in the case where there is more than one person to communicate with via the network, the screen may be divided to display an image for each person.

FIG. 25 is a diagram illustrating an example image displayed on the terminal device 7 in Third Example. The image displayed on the terminal device 7 is an operation image for operations related to the image displayed on the television 2. As shown in FIG. 25, the operation image displayed on the terminal device 7 includes a contacts list 151, a call button 152, a record button 153, an end button 154, a message button 155, a duration image 156, and a user image 157. The contacts list 151 is a list of users capable of communication on the videophone. Here, a destination terminal can be specified by an operation to select the name of a person the user wishes to communicate with from the contacts list 151. The call button 152 is a button for starting/ending a call. The record button 153 is a button for starting/ending the recording of a video displayed on the television 2. The end button 154 is a button for ending the videophone application. The message button 155 is a button for transmitting a message to the destination device. The duration image 156 is an image indicating the duration of a call. The user image 157 is an image of the user picked up by the camera 56 of the terminal device 7. In addition to the buttons and the images shown in FIG. 25, the terminal device 7 may display a button for controlling the volume, an area for displaying a message from the destination device, and so on.

In Third Example, the game apparatus 3 exchanges images and sound with the destination device. Specifically, an image picked up by the camera 56 of the terminal device 7 and sound detected by the microphone 69 are transmitted from the game apparatus 3 to the destination device. Moreover, the game apparatus 3 receives an image of the other person and sound on the other side from the destination device, and outputs the received image and sound to the television 2. Here, in Third Example, the television 2 displays the image of the other person, and the terminal device 7 displays an operation image for performing an operation on the image displayed on the television 2. Thus, it is possible to provide videophone images in a form suitable for a plurality of viewers and in such a manner as to facilitate easy viewing of the images. Moreover, the user can readily perform an operation related to the image displayed on the television 2 using the terminal device 7 at hand.

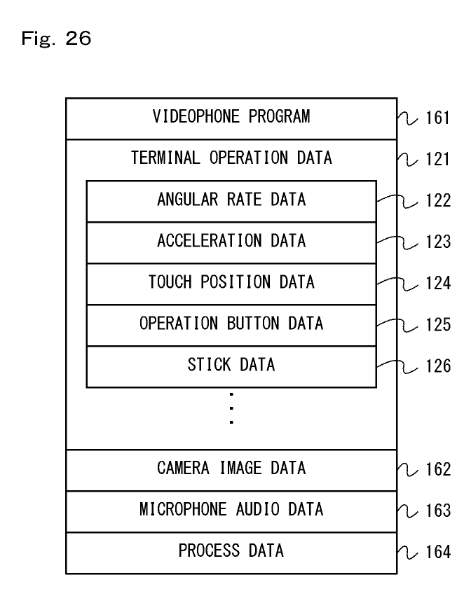

Hereinafter, the processing by the game apparatus 3 in Third Example will be described in detail. First, various types of data for use in the processing by the game apparatus 3 will be described. FIG. 26 is a diagram illustrating the data for use in the processing by the game apparatus 3 in Third Example. The data shown in FIG. 26 are main data stored in the main memory of the game apparatus 3. As shown in FIG. 26, the main memory of the game apparatus 3 has stored therein a videophone program 161, terminal operation data 121, camera image data 162, microphone audio data 163, and process data 164. Note that in FIG. 26, the same data as in FIG. 17 are denoted by the same numbers, and any detailed descriptions thereof will be omitted. Moreover, in addition to the data shown in FIG. 26, the main memory has stored therein data to be used in the videophone program 161 such as image data.

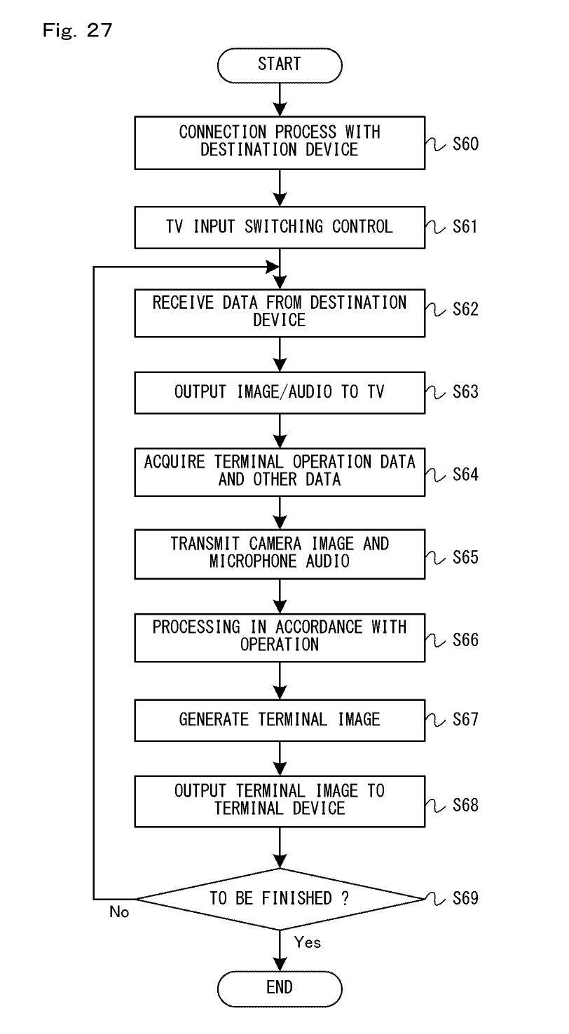

The videophone program 161 is a program for causing the CPU 10 of the game apparatus 3 to execute the function of a videophone. In Third Example, the CPU 10 executes the videophone program 161 so that each step in a flowchart shown in FIG. 27 is executed. The videophone program 161 is read in whole or in part from the flash memory 17 at an appropriate time after the power-on of the game apparatus 3, and then stored to the main memory. Note that the videophone program 161 may be acquired from the optical disc 4 or a device external to the game apparatus 3 (e.g., via the Internet), rather than from the flash memory 17.

The camera image data 162 is data representing an image (camera image) picked up by the camera 56 of the terminal device 7. The camera image data 162 is obtained by the codec LSI 27 decompressing compressed image data transmitted by the terminal device 7, and stored to the main memory by the input/output processor 11a. Note that the main memory may have stored therein the camera image data up to a predetermined number of pieces counted from the latest piece (the last acquired piece).

The microphone audio data 163 is data representing audio (microphone audio) detected by the microphone 69 of the terminal device 7. The microphone audio data 163 is obtained by the codec LSI 27 decompressing compressed audio data transmitted by the terminal device 7, and stored to the main memory by the input/output processor 11a.

The process data 164 is data to be used in a videophone process (FIG. 27) to be described later. In Third Example, the process data 164 includes various data generated in the videophone process shown in FIG. 27. Details of the data to be stored to the main memory as the process data 164 will be described later.

Next, the processing to be executed by the game apparatus 3 in Third Example will be described in detail with reference to FIG. 27. FIG. 27 is a flowchart illustrating a flow of the processing to be executed by the game apparatus 3 in Third Example. Note that the game apparatus 3 starts execution of the videophone program 161 in the same manner as in the case of the browser program 120 in First Example. The processing shown in the flowchart of FIG. 27 is executed in response to the start of the videophone program 161.

First, in step S60, the CPU 10 performs a connection process with a destination device. Concretely, the CPU 10 outputs an operation image, for example, as shown in FIG. 25, to the terminal device 7, and accepts the user's connection operation. Here, the connection operation is performed by selecting a destination user from the contacts list 151 displayed on the terminal device 7 and specifying the call button 152 with the destination user being selected. Once the connection operation is performed, the CPU 10 performs a process for establishing communication with a destination device corresponding to the selected user. The process for establishing communication between devices can be performed by any arbitrary method. For example, communication may be established via a device (server) for managing device connections, or may be established by the game apparatus 3 directly accessing the destination device. Once the communication between the game apparatus 3 and the destination device is established in step S60, the process of step S61 is performed.

In step S61, the CPU 10 performs control for switching inputs to the television 2. The process of step S61 is the same as the process of step S40 in First Example. Alternatively, in another example, the CPU 10 may output a control command to turn on the television 2 before outputting a control command for switching the input source of the television 2 to the game apparatus 3. Following step S61, the process of step S62 is performed.

In step S62, the CPU 10 receives data transmitted by the destination device. In Third Example, the data includes an image (of the destination user) picked up by a camera provided in the destination device and sound (on the other side) detected by a microphone provided in the destination device. After the game apparatus 3 receives the data transmitted by the destination device, the data is stored to the flash memory 17. The CPU 10 confirms the presence or absence of received data, and, if any, the content of the received data. Following step S62, the process of step S63 is performed.

In step S63, the CPU 10 outputs the image and the sound transmitted by the destination device to the television 2. Specifically, the CPU 10 reads image (video) data stored in the flash memory 17, and stores the image to the VRAM 11d. The image stored in the VRAM 11d is transferred to the AV-IC 15. In addition, the CPU 10 reads audio data stored in the flash memory 17, and transfers the audio data to the AV-IC 15. The AV-IC 15 outputs the image and sound to the television 2 via the AV connector 16. As a result, the image is displayed on the television 2, and sound is outputted by the speakers 2a of the television 2. Following step S63, the process of step S64 is performed.

In step S64, the CPU 10 acquires data from the terminal device 7. In Third Example, terminal operation data, camera image data, and microphone audio data are acquired. The terminal device 7 repeats transmitting the data (terminal operation data, camera image data, and microphone audio data) to the game apparatus 3, and therefore, the game apparatus 3 sequentially receives the data. In the game apparatus 3, the terminal communication module 28 sequentially receives the data, and the codec LSI 27 sequentially performs a decompression process on the camera image data and the microphone audio data. Thereafter, the input/output processor 11a sequentially stores the terminal operation data, the camera image data, and the microphone audio data to the main memory. The CPU 10 reads the latest terminal operation data 121 from the main memory. Following step S64, the process of step S65 is performed.

In step S65, the CPU 10 transmits the camera image and the microphone audio acquired from the terminal device 7 to the destination device. Specifically, the CPU 10 reads the camera image data and the microphone audio data stored to the main memory in step S64, and stores these data to a predetermined region of the flash memory 17 as data to be transmitted to the network 90. Note that in another example, the camera image data and the microphone audio data acquired from the terminal device 7 may be directly stored to the flash memory 17. In addition, when storing the data (camera image data and microphone audio data) to the flash memory 17, the CPU 10 may, where appropriate, modify the data to a form suitable for communication with the destination device. The input/output processor 11a transmits the data stored in the flash memory 17 to the network 90 at a predetermined time. As a result, the data is transmitted to the destination device. Following step S65, the process of step S66 is performed.

In step S66, the CPU 10 performs processing in accordance with the user's operation with the terminal device 7. This processing may be any arbitrary processing, including processing as performed in conventional videophone applications. Note that the user's operation is determined on the basis of the terminal operation data 121 acquired in step S64. In Third Example, for example, in response to specification of the record button 153 or the message button 155 shown in FIG. 25, the processing associated with the button 153 or 155 is performed. Specifically, in the case where the record button 153 is specified, the processing for storing a video displayed on the television 2 to the main memory or suchlike is performed. Alternatively, in the case where the message button 155 is specified, the CPU 10 accepts characters inputted by the user, and transmits the inputted characters to the destination device. Note that in the case where character input is accepted, the CPU 10 may cause the terminal device 7 to display the character input image (FIG. 21) in First Example. Note that in the case where the call button 152 is specified, the CPU 10 ends the communication with the destination device currently connected thereto. In this case, although not shown, the process of step S60 is performed again. Following step S66, the process of step S67 is performed.

In step S67, the CPU 10 generates a terminal image. In Third Example, an operation image as shown in FIG. 25 is generated. Here, Third Example differs from First and Second Examples in the method for generating the operation image. Specifically, the operation image is not generated on the basis of data (Web page data) acquired from the external device 91, but on the basis of data prepared for the game apparatus 3 and the camera image data. The CPU 10 and the GPU 11b collaborate to generate an operation image using image data and camera image data prepared along with the videophone program 161, and store data for the generated operation image to the VRAM 11d. Following step S67, the process of step S68 is performed.

In step S68, the terminal image is outputted (transmitted) to the terminal device 7. The process of step S68 is the same as the process of step S35 in First Example. By this process, the terminal image is displayed on the LCD 51. Note that in step S68, as in step S35, audio data may be transmitted to the terminal device 7 along with image data, so that sound is outputted from the speakers 67 of the terminal device 7. For example, the same sound as that outputted from the speakers 2a of the television 2 may be outputted by the terminal device 7. Following step S68, the process of step S69 is performed.

In step S69, the CPU 10 determines whether or not to end the videophone program. Concretely, it is determined whether or not the end button 154 has been specified, on the basis of the terminal operation data 121 acquired in step S64. When the result of the determination of step S69 is negative, the process of step S62 is performed again. On the other hand, when the result of the determination of step S69 is affirmative, the CPU 10 ends the videophone process shown in FIG. 27. Thereafter, a series of processes of steps S62 to S69 are repeatedly performed until the determination of step S69 indicates that the end button 154 has been specified.

Note that, as described above, the game apparatus 3 may communicate with a plurality of destination devices. In this case, in step S62, the game apparatus 3 communicates with destination devices via the network, and receives video and audio data from each of the destination devices. In step S63, the CPU 10, in concert with the GPU 11b, generates a television image including the video received from each of the destination devices, and outputs the television image to the television 2. For example, the television image is generated such that the images from the destination devices are displayed in their corresponding areas of the screen divided into the same number of areas as the number of the destination devices. In addition, the sound transmitted by each or one of the destination devices may be outputted to the speakers 2a of the television 2. Moreover, in step S65, the camera image and the microphone audio acquired from the terminal device 7 are transmitted to each of the destination devices.

As described above, in Third Example, as in First and Second Examples, an image (of the destination user) included in data received by the game apparatus 3 is outputted to the television 2 (step S63), and an operation image (FIG. 25) for operations related to the image outputted to the television 2 is outputted to the terminal device 7 (step S68). In addition, the game apparatus 3 acquires operation data representing an operation on the operation image from the terminal device 7 (step S64), and performs information processing related to the image displayed on the television 2, on the basis of the operation data (step S66).

Furthermore, in Third Example, the game apparatus 3 receives a video recorded by a camera from an external device (destination device) provided with that camera, and transmits a video recorded by the camera 56 of the terminal device 7 to the external device. In this manner, the game system 1 can be applied to the system that exchanges images with the external device 91, and also to the videophone system as in Third Example. In Third Example, since the image of the destination user is displayed on the television 2, besides the user having communication through the terminal device 7, any other person can see the face of the destination user as well, and images on the videophone can be readily viewed.

Furthermore, in First and Third Examples, the game apparatus 3 receives video data from an external device (step S11 or S62), and outputs an operation image at least representing an operation related to play of the received video (FIG. 15 or 25) is outputted to the terminal device 7. Thus, in First and Third Examples, a video can be presented on the television 2 so that the user can view the video more readily, and the user can also readily perform an operation related to the video using the operation image on the terminal device 7.

### Alternative Example

In addition to First through Third Examples, the game system 1 can be applied to any arbitrary system in which images acquired via a network are displayed. In an alternative example, images to be displayed on the television 2 and images to be displayed on the terminal device 7 may be prepared in the external device 91, such that the game apparatus 3 acquires the images from the external device 91, and causes the television 2 and the terminal device 7 to display their respective images. For example, in the case of “picture-story show” content, it is conceivable to prepare pictures as television images and story passages as terminal images. In this case, once the images are acquired from the external device 91, the game apparatus 3 causes the television 2 and the terminal device 7 to display the pictures and the passages, respectively. In addition, the terminal device 7 may display images of, for example, buttons to provide instructions to change pages of the terminal and television images (instructions to acquire images for the subsequent pages). As a result, it is possible to perform image-related operations using the terminal images. Thus, for example, the game system 1 can be used to read a child the story of a picture-story show, such that a parent reads the text on the terminal device 7, and a child can see the pictures on the television 2.

In addition to the above example where the picture-story show content is displayed on each display device, for example, the game system 1 can be used for the purpose of displaying conference or presentation documents. Specifically, images for a document to be shown to conference or presentation participants may be displayed on the television 2 as television images, and written material may be displayed as terminal images for the user to view in order to provide an explanation (or a presentation) about the document displayed on the television 2.

In this manner, the game apparatus 3 may receive predetermined images and character information data associated therewith, and in this case, the CPU 10 may output the predetermined images to the television 2, and operation images, including the character information, to the terminal device 7. Thus, by using the terminal device 7, the user can smoothly explain and discuss images displayed on the television 2. Moreover, with the terminal device 7, it is possible to readily perform operations related to predetermined images displayed on the television 2 (and character information displayed on the terminal device 7).

### Fourth Example

In First through Third Examples, the game system 1 causes the television 2 to display images acquired from the external device 91. Here, in the case where the television 2 receives and displays a television program, the game system 1 renders it possible to control channel selection on the television 2 on the basis of an EPG (electronic program guide) acquired from the external device 91. Fourth Example will be described below with respect to the processing operation for the game apparatus 3 to control channel selection on the television 2.

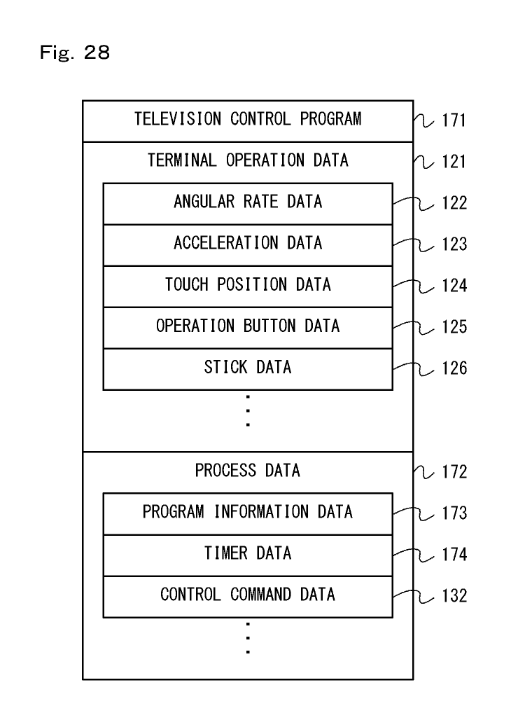

FIG. 28 is a diagram illustrating various types of data for use in the processing by the game apparatus 3 in Fourth Example. The data shown in FIG. 28 are main data stored in the main memory of the game apparatus 3. As shown in FIG. 28, the main memory of the game apparatus 3 has stored therein a television control program 171, terminal operation data 121, and process data 172. Note that in FIG. 28, the same data as in FIG. 17 are denoted by the same numbers, and any detailed descriptions thereof will be omitted. Moreover, in addition to the data shown in FIG. 28, the main memory has stored therein data to be used in the television control program 171 such as image data.

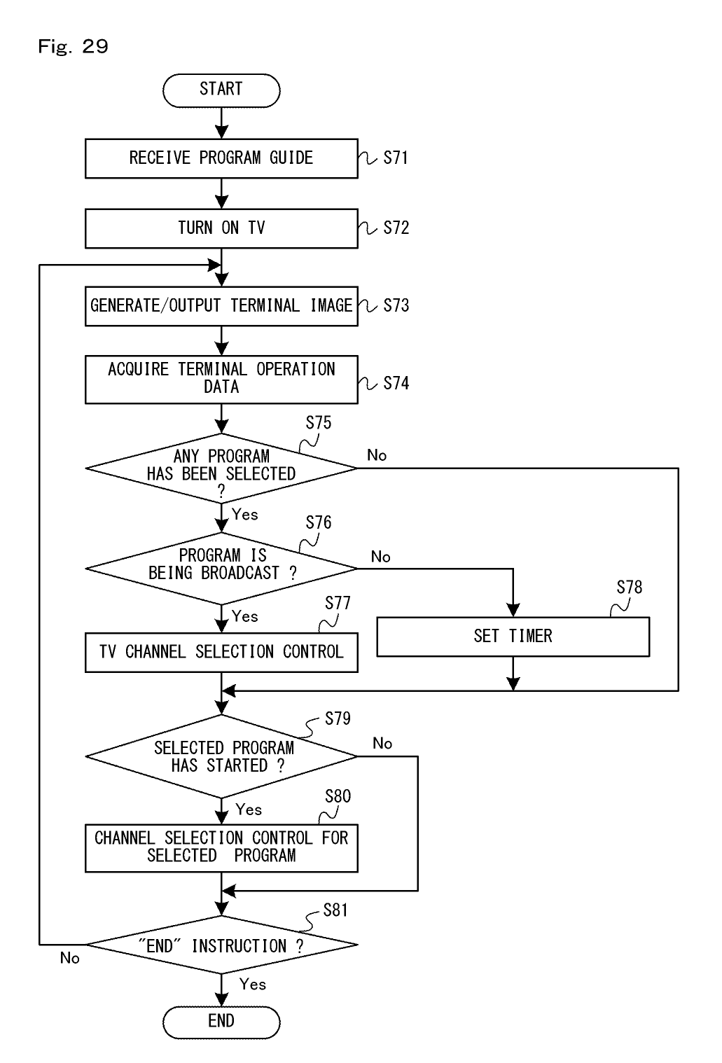

The television control program 171 is a program for causing the CPU 10 of the game apparatus 3 to execute the processing for controlling the television 2 on the basis of an EPG acquired from the external device 91. In Fourth Example, the CPU 10 executes the television control program 171, so that each step in a flowchart shown in FIG. 29 is executed. The television control program 171 is read in whole or in part from the flash memory 17 at an appropriate time after the power-on of the game apparatus 3, and then stored to the main memory. Note that the television control program 171 may be acquired from the optical disc 4 or a device external to the game apparatus 3 (e.g., via the Internet), rather than from the flash memory 17.

The process data 172 is data to be used in a television control process to be described later (FIG. 29). In Fourth Example, the process data 172 includes program information data 173, timer data 174, and control command data 132. The program information data 173 represents information related to a program included in the EPG acquired from the external device 91. Concretely, the program information data 173 at least represents identification information (e.g., the title of the program) for identifying the program, the airtime of the program, and the channel of the program. The timer data 174 is data representing a program for which the user has set a timer to watch. Concretely, the timer data 174 at least represents the start time and the channel of the program. The control command data 132 is the same as in an earlier example. Note that, in addition to the data shown in FIG. 28, the process data 172 includes various types of data to be used in the television control process.

FIG. 29 is a flowchart illustrating a flow of the processing to be executed by the game apparatus 3 in Fourth Example. Note that the game apparatus 3 starts execution of the television control program 171 in the same manner as in the case of the browser program 120 in First Example. The processing shown in the flowchart of FIG. 29 is executed in response to the start of the television control program 171.

First, in step S71, the CPU 10 receives EPG data from an external device 91. Specifically, the CPU 10 initially generates an EPG acquisition request, and transmits the acquisition request to a predetermined external device 91 via the network 90. The predetermined external device 91 may be any arbitrary device capable of providing EPG data, e.g., a Web server having EPG data stored therein. In response to the acquisition request, the external device 91 transmits EPG data to the game apparatus 3 via the network 90. The EPG data transmitted by the external device 91 is stored to the flash memory 17. The CPU 10 reads the received data from the flash memory 17, generates program information data 173 on the basis of the data being read, and then stores the program information data 173 to the main memory. Following step S71, the process of step S72 is performed.

In step S72, the CPU 10 performs control for turning on the television 2. Specifically, the CPU 10 generates control command data 132 representing a control command for turning on the television 2, and stores the control command data 132 to the main memory. Thereafter, as in First Example, the control for turning on the television 2 is performed in accordance with the control command. Following step S72, the process of step S73 is performed. Note that in Fourth Example, after the process of step S72, a process loop of steps S73 to S81 is repeatedly performed once per predetermined period.

In Fourth Example, even when the television 2 is off, the process of step S72 allows the television 2 to be automatically turned on without the need of the user's operation. Note that in another example embodiment based on the premise that the television 2 is turned on before execution of the television control program 171 is started or the user turns on the television 2, the process of step S72 is not performed.

In step S73, the CPU 10 generates and outputs a terminal image to the terminal device 7. Specifically, the CPU 10 reads the EPG data stored in the flash memory 17, and generates an EPG image on the basis of that data. Data for the generated image is stored to the VRAM 11d. The terminal image data stored in the VRAM 11d is outputted to the terminal device 7 by an output method as used in First Example. Thus, the EPG image is displayed on the terminal device 7. Following step S73, the process of step S74 is performed.

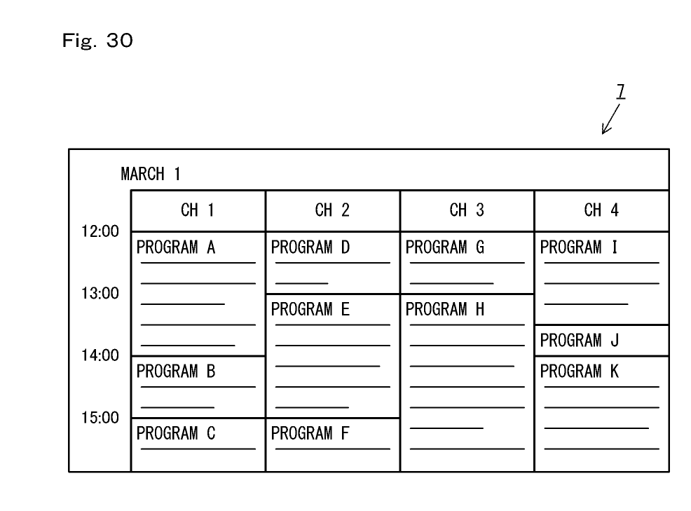

FIG. 30 is a diagram illustrating an example EPG image displayed on the terminal device 7. As shown in FIG. 30, the terminal device 7 displays part (or even all) of the EPG acquired from the external device 91. Note that in the case where the terminal device 7 only displays part of the EPG, the screen may be scrolled by manipulating the terminal device 7. By the terminal device 7 displaying the EPG image as shown in FIG. 30, the user can select a desired program using the terminal device 7 (e.g., by touching the cell for the desired program). Moreover, in addition to the EPG image, the terminal image may include a cursor image for selecting a program, and other images including buttons and a menu bar for providing various instructions, such as an instruction to scroll the screen and an instruction to end the television control program 171.

In step S74, the CPU 10 acquires terminal operation data. The process of step S74 is the same as the process of step S12 in First Example. Following step S74, the process of step S75 is performed.

In step S75, the CPU 10 determines whether or not an operation to select a program has been performed. Here, the program selection operation may be any operation using the terminal device 7, e.g., an operation of touching the cell for a desired program in the EPG displayed on the terminal device 7 or an operation of pressing a predetermined button after placing the cursor in the cell for a desired program. The CPU 10 determines whether or not any operation as mentioned above has been performed, on the basis of the terminal operation data acquired in step S73. In the case where the operation has been performed, data (selected-program data) representing information related to the selected program (e.g., identification information, airtime, and channel) is stored to the main memory. When the result of the determination of step S75 is affirmative, the process of step S76 is performed. On the other hand, when the result of the determination of step S75 is negative, the process of step S79 to be described later is performed.

In step S76, the CPU 10 determines whether or not the program selected by the user is being broadcast. Specifically, the CPU 10 initially reads the selected-program data stored in step S75 from the main memory, and identifies the airtime of the program, thereby determining whether or not the program is currently being broadcast. When the result of the determination of step S76 is affirmative, the process of step S77 is performed. On the other hand, when the result of the determination of step S76 is negative, the process of step S78 is performed.

In step S77, the CPU 10 controls the television 2 to be tuned to the channel of the program selected by the user. Specifically, the CPU 10 initially reads the selected-program data from the main memory, and identifies the channel of the program. Then, the CPU 10 generates control command data 132 representing a control command for selecting the identified channel, and stores the control command data 132 to the main memory. After the control command data 132 is stored to the main memory, the operation of the television 2 is controlled by a control method as used in First Example in accordance with the control command. As a result, the television 2 is tuned to the channel of the selected program. Following step S77, the process of step S79 is performed.

On the other hand, in step S78, the CPU 10 sets a timer for the program selected by the user. Concretely, the CPU 10 reads data representing the program selected in step S75 from the main memory, along with the program information data 173, and identifies the start time and the channel of the program. Data representing the identified start time and channel is stored to the main memory as timer data 174. Note that the CPU 10 may store timer data 174 for a plurality of programs to the main memory if the programs do not start at the same time. For programs with the same start time, timer data 174 for only one of the programs (e.g., the last program for which a timer is set) may be stored to the main memory. Following step S78, the process of step S79 is performed.

In step S79, the CPU 10 determines whether or not it is the start time of the program for which a timer is set. The determination is made on the basis of whether or not the start time of the program for which a timer was set in step S78 has arrived. Concretely, the CPU 10 reads the timer data 174, and determines whether or not there is any program whose start time has arrived. When the result of the determination of step S79 is affirmative, the process of step S80 is performed. On the other hand, when the result of the determination of step S79 is negative, the process of step S80 is skipped, and the process of step S81 is performed.

In step S80, the CPU 10 controls the television 2 to be tuned to the channel of the program whose start time has arrived. Concretely, the CPU 10 initially identifies the channel of the program whose start time was determined in step S79 to have arrived, on the basis of the timer recording data 174 for that program. Then, the CPU 10 generates control command data 132 representing a control command for selecting the identified channel, and stores the control command data 132 to the main memory. After the control command data 132 is stored to the main memory, the operation of the television 2 is controlled by a control method as used in First Example in accordance with the control command. As a result, the television 2 is tuned to the channel of the program. Following step S80, the process of step S81 is performed.

In step S81, the CPU 10 determines whether or not to end the television control program. Concretely, it is determined whether or not a predetermined ending operation has been performed, on the basis of the terminal operation data 121 acquired in step S74. When the result of the determination of step S81 is negative, the process of step S73 is performed again. On the other hand, the result of the determination of step S81 is affirmative, the CPU 10 ends the television control process shown in FIG. 29. Thereafter, a series of processes of steps S73 to S81 are repeatedly performed until the determination of step S81 indicates that the ending operation has been performed.

As described above, in Fourth Example, the game apparatus 3 receives television program guide data from a predetermined external device via the network (step S71). Thereafter, an operation image including the program guide (FIG. 30) is outputted to the terminal device 7 (step S73). The CPU 10 acquires operation data representing an operation on the operation image from the terminal device 7 (step S74). In addition, the CPU 10 selects a program in the program guide included in the operation image on the basis of the operation data (step S75), and controls the television 2 to be tuned to the channel of the selected program (step S77 or S80). In this manner, in Fourth Example, it is possible to cause the terminal device 7 to display an EPG image acquired from an external device, so that the terminal device 7 can be used to control, for example, channel selection of the television 2. Thus, the user can perform a channel selection operation on the television 2 using the terminal device 7 having the EPG image displayed thereon.

Here, in the case where an EPG is displayed on the screen of a conventional television, no television program image is displayed on the screen, so that the user cannot check the EPG while watching a program. Accordingly, in the case of conventional televisions, when viewing an EPG, the user has difficulty in viewing a program image and selecting a program channel. On the other hand, in Fourth Example, the user can view an EPG on the terminal device 7 while leaving the television 2 displaying a program image, and furthermore, the user can perform channel selection control on the television 2 using the terminal device 7. Thus, in Fourth Example, it is possible to provide program images that can be readily viewed and also possible to facilitate channel selection using an EPG.

Furthermore, in Fourth Example, it is possible to select a program that is currently not being broadcast, and in the case where any program that is currently not being broadcast is selected, a timer is set to watch that program (step S78), and an channel selection operation is performed to tune in to the channel of the program at the start time of the program (step S80). Thus, while viewing a program on the television 2, the user can use the terminal device 7 to select another program and set a timer to watch that program at a later time.

Note that in Fourth Example, when the user selects a program, the CPU 10 causes the television 2 to operate to tune in to the channel of the program. Here, in another example embodiment, when the television 2 has the function of recording program images, or the television 2 is connected to a recording device having such a function, the CPU 10 may control the television 2 to record a selected program, rather than to select (or in addition to selecting) a channel. Thus, it is possible to perform an operation to record a television program using the terminal device 7 having an EPG image displayed thereon.

Furthermore, in Fourth Example, in the case where a broadcast station or suchlike offers a service to redistribute already-broadcast programs via a network, when any already-broadcast program in a program guide is specified, the game apparatus 3 may acquire the program via the network, automatically switch the channel (input) of the television 2, and output the program's image (video) and audio to the television 2. As a result, it is rendered possible to watch a desired program any time of the day. Concretely, in the case where a program selected from a program guide satisfies a predetermined condition, the game apparatus 3 makes an acquisition request to a predetermined external device for that program (note that the external device may or may not be the same as the external device that distributes the program guide). For example, the predetermined condition is that the program has already been broadcast (or the program has just started and is being broadcast). In addition, data for the program guide may include information in which programs are associated with link information which indicates the sources of their video and audio. In response to the acquisition request, the external device transmits image and audio data for the program to the game apparatus 3 via the network. The game apparatus 3 acquires the program data via the network. In the case where the game apparatus 3 acquires a selected program via the network, the CPU 10 outputs image and audio data for that program to the television 2. Note that the method by which a video acquisition request is transmitted to an external device to acquire a video and the video is outputted to the television 2 may be the same as in First Example. In addition, before outputting the image and audio data for the program to the television 2, the CPU 10 may switch inputs to the television 2 such that the image and audio data from the game apparatus 3 can be displayed and outputted.

### 7. Variant

The above example embodiments are merely illustrative, and in another example embodiment, a game system or suchlike can be carried out with, for example, a configuration as will be described below.

(Variant Related to the Operating Device)

In the above example embodiments, the terminal device 7, rather than the controller 5, is used as an operating device. Accordingly, the game system 1 may be configured to include no controller 5. However, in another example embodiment, the controller 5, along with the terminal device 7, may be used as an operating device. Specifically, the CPU 10 may acquire operation data (controller operation data) representing an operation with the controller 5, and perform information processing related to a video displayed on the television 2, on the basis of the operation data. For example, in the case where the television 2 displays a video, the controller 5 may be used to perform an operation to play or pause the video. Thus, not only the user holding the terminal device 7 but also another user with the controller 5 can perform an operation related to the video displayed on the television 2, ensuring enhanced user-friendliness.

(Variant with a Plurality of Terminal Devices)

In the above example embodiments, the game system 1 includes only one terminal device 7, but the game system 1 may be configured to include more than one terminal device. Specifically, the game apparatus 3 may be capable of wirelessly communicate with a plurality of terminal devices, so that image data can be transmitted to each terminal device, and operation data, camera image data, and microphone audio data can be received from each terminal device. In addition, each terminal device may display a different operation image, and may individually perform their operations to display images on the television 2. Note that, when wirelessly communicating with terminal devices, the game apparatus 3 may perform the wireless communication with the terminal devices using a time-division or frequency-band-division system.

Furthermore, each terminal device may have the function of outputting operation data to a game apparatus, receiving images from the game apparatus, and displaying the received images. Specifically, in another example embodiment, each terminal device may be a device, such as a hand-held game device, which has the function of, for example, executing predetermined information processing (game processing) by a predetermined program (game program).

(Variant in which Audio is Outputted to the Television 2)

While the above example embodiments have been described with respect to examples where images (video and/or still images) are outputted to the television 2, the game system 1 can be configured such that sound, rather than an image, is outputted to the television 2 (the speakers 2a of the television 2). Specifically, the game apparatus 3 may receive audio (e.g., music) data from the external device 91 via the network 90, and output the audio data to the speakers 2a. In this case, the terminal device 7 displays an operation image for use in performing an operation related to audio. In addition, the CPU 10 executes information processing related to audio on the basis of terminal operation data. Note that, in general, the television 2 can output higher-quality sound than the terminal device 7 of portable type, and therefore, in the above case, by the television 2 outputting audio acquired from the external device 91, the user can enjoy listening to higher-quality sound.

(Variant Related to the Information Processing Apparatus for Executing the Processing)

In the above example embodiments, a series of information processing tasks to be performed in the game system 1 are executed by the game apparatus 3, but the series of information processing tasks may be executed in part by another device. For example, in another example embodiment, a part (e.g., the terminal game image generation process) of the series of information processing tasks may be performed by the terminal device 7. Moreover, in another example embodiment, a series of information processing tasks in a game system including a plurality of information processing apparatuses capable of communicating with each other may be shared between the information processing apparatuses. Note that in the case where information processing is shared between information processing apparatuses, processing tasks are synchronized between the information processing apparatuses, resulting in complicated processing. On the other hand, in the case where, as in the above embodiments, information processing is executed by one game apparatus 3, and the terminal device 7 receives and displays images (i.e., the terminal device 7 is a thin-client terminal), processing tasks are not synchronized between information processing apparatuses, resulting in simplified processing.

Furthermore, wile the above example embodiments have been described taking as an example the game system 1 which includes the game apparatus 3 capable of performing game processing, the processing operations described in the above example embodiments can be performed not only by the game system and apparatus, but also by any arbitrary information processing system and apparatus. Any information processing system can be employed so long as it includes an information processing apparatus, and a portable display device (e.g., terminal device 7) allowing the user to perform input operations, and any information processing apparatus can be employed so long as it can output and display images on both a portable display device and a display device (e.g., television 2) different from the portable display device.

As discussed above, the various systems, methods, and techniques described herein may be implemented in digital electronic circuitry, computer hardware, firmware, software, or in combinations of these elements. Apparatus embodying these techniques may include appropriate input and output devices, a computer processor, and a computer program product tangibly embodied in a non-transitory machine-readable storage device for execution by a programmable processor. A process embodying these techniques may be performed by a programmable processor executing a suitable program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language or in assembly or machine language, if desired; and in any case, the language may be a compiled or interpreted language. Suitable processors include, by way of example, both general and special purpose microprocessors. Generally, a processor will receive instructions and data from a read-only memory and/or a random access memory. Non-transitory storage devices suitable for tangibly embodying computer program instructions and data include all forms of computer memory including, but not limited to, (a) non-volatile memory, including by way of example semiconductor memory devices, such as Erasable Programmable Read-Only Memory (EPROM), Electrically Erasable Programmable Read-Only Memory (EEPROM), and flash memory devices; (b) magnetic disks such as internal hard disks and removable disks; (c) magneto-optical disks; and (d) Compact Disc Read-Only Memory (CD-ROM). Any of the foregoing may be supplemented by, or incorporated in, specially-designed Application Specific Integrated Circuits (ASICs).

The processing system/circuitry described in this specification is “programmed” to control processes such as game processes in accordance with the “logic” described in the specification. One of ordinary skill in the art will therefore recognize that, for example, a processing system including at least one CPU when executing instructions in accordance this logic operates as “programmed logic circuitry” to perform the operations defined by the logic.

The systems, devices and apparatuses described herein may include one or more processors, which may be located in one place or distributed in a variety of places communicating via one or more networks. Such processor(s) can, for example, use conventional 3D graphics transformations, virtual camera and other techniques to provide appropriate images for display. By way of example and without limitation, the processors can be any of: a processor that is part of or is a separate component co-located with the stationary display and which communicates remotely (e.g., wirelessly) with the movable display; or a processor that is part of or is a separate component co-located with the movable display and communicates remotely (e.g., wirelessly) with the stationary display or associated equipment; or a distributed processing arrangement some of which is contained within the movable display housing and some of which is co-located with the stationary display, the distributed portions communicating together via a connection such as a wireless or wired network; or a processor(s) located remotely (e.g., in the cloud) from both the stationary and movable displays and communicating with each of them via one or more network connections; or any combination or variation of the above.

The processors can be implemented using one or more general-purpose processors, one or more specialized graphics processors, or combinations of these. These may be supplemented by specifically-designed ASICs (application specific integrated circuits) and/or logic circuitry. In the case of a distributed processor architecture or arrangement, appropriate data exchange and transmission protocols are used to provide low latency and maintain interactivity, as will be understood by those skilled in the art.

Similarly, program instructions, data and other information for implementing the systems and methods described herein may be stored in one or more on-board and/or removable memory devices. Multiple memory devices may be part of the same device or different devices, which are co-located or remotely located with respect to each other.

As described above, the present example embodiment can be applied to, for example, a game system or apparatus for the purpose of, for example, providing images that can be viewed more readily and allowing the user to readily perform operations related to the images.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. An information processing system, comprising a stationary information processing apparatus and a portable display device allowing a user to perform an input operation, wherein,
the information processing apparatus includes:
a communication unit connectable to a network and communicating with a predetermined external device via the network;
a first image output unit for outputting an image to a predetermined display device different from the portable display device, the image being included in reception data obtained by the communication unit;
a second image output unit for outputting an operation image to the portable display device, the operation image being used for performing an operation related to the image;
an operation data acquisition unit for acquiring operation data from the portable display device, the operation data representing an operation on the operation image; and
an information processing unit for, on the basis of the operation data, executing information processing related to an image displayed on the predetermined display device, and
the portable display device includes:
an operation data transmission unit for transmitting data outputted by an operation unit provided in the portable display device as the operation data;
a second image reception unit for receiving the operation image from the information processing apparatus; and
a display unit for displaying the received operation image.

2. The information processing system according to claim 1, wherein,
the communication unit receives data representing a plurality of types of images,
the second image output unit outputs an operation image including the plurality of types of images to the portable display device,
the information processing unit performs as the information processing a process for selecting one of the plurality of types of images that is to be displayed on the predetermined display device on the basis of the operation data,
the communication unit transmits an acquisition request for the image selected by the information processing unit to the external device, and receives data for the image transmitted by the external device in response to the request, and
the first image output unit outputs the selected image to the predetermined display device.

3. The information processing system according to claim 2, wherein,
the information processing unit acquires a search keyword entered by the user, on the basis of the operation data,
the communication unit transmits the acquired search keyword to the external device and receives data representing the plurality of types of images from the external device as search result data for the search keyword, and
when the search result data is received, the second image output unit outputs an operation image including the plurality of types of images as an image representing search results.

4. The information processing system according to claim 2, wherein,
the communication unit acquires data representing a plurality of types of videos from a server having videos stored therein,
when the data representing a plurality of types of videos is acquired, the second image output unit outputs an operation image including the plurality of types of videos to the portable display device,
the communication unit makes an acquisition request to the server for a video selected by the information processing and receives data for that video from the server,
the first image output unit outputs the received video to the predetermined display device, and
when the received video is outputted to the predetermined display device, the second image output unit outputs an operation image at least representing an operation related to play of the video to the portable display device.

5. The information processing system according to claim 4, wherein,
the information processing unit executes the process for selecting a video to be displayed on the predetermined display device, whether or not the first image output unit is outputting any video to the predetermined display device,
the communication unit transmits an acquisition request for the video selected by the information processing unit to the external device, and receives data for the video transmitted by the external device in response to the request, and
when the communication unit receives data for a video while another video is being outputted to the predetermined display device, the first image output unit starts outputting the video received by the communication unit after completion of the output of the video to the predetermined display device.

6. The information processing system according to claim 2, wherein,
the communication unit receives data representing a plurality of product images from a server having stored therein information about a plurality of products,
the second image output unit outputs an operation image including the product images to the portable display device,
the information processing unit selects one of the product images that is to be displayed on the predetermined display device, and
the first image output unit outputs the selected product image to the predetermined display device.

7. The information processing system according to claim 6, wherein,
the information processing unit allows predetermined information for product purchase to be inputted, and
the second image output unit outputs an image including the inputted information to the portable display device.

8. The information processing system according to claim 1, wherein,
the portable display device includes a camera, and
the communication unit receives a video recorded by a camera included in an external device, and transmits a video recorded by the camera of the portable display device to the external device.

9. The information processing system according to claim 8, wherein,
the communication unit communicates with a plurality of external devices via the network, and receives a video from each of the external devices, and
the first image output unit outputs an image including the video received from each of the external devices.

10. The information processing system according to claim 1, wherein,
the communication unit receives a predetermined image and data for character information associated with the predetermined image,
the first image output unit outputs the predetermined image to the predetermined display device, and
the second image output unit outputs an operation image including the character information to the portable display device.

11. The information processing system according to claim 1, wherein, when the first image output unit outputs an image to the predetermined display device, the information processing unit controls the predetermined display device before the image is outputted, so that the predetermined display device is able to display the image.

12. The information processing system according to claim 1, wherein,
the predetermined display device is capable of receiving television broadcasting and displaying video of a television broadcast,
the communication unit receives data for a television program guide from the predetermined external device,
the second image output unit outputs an operation image including the received program guide to the portable display device, and
the information processing unit selects a program in the program guide included in the operation image on the basis of the operation data, and controls the predetermined display device to tune in to a channel of the selected program.

13. The information processing system according to claim 11, wherein,
the portable display device includes an infrared light emitting unit for emitting an infrared signal,
the predetermined display device includes an infrared light reception unit for receiving the infrared signal, and
the information processing unit outputs an instruction to the portable display device, thereby causing the infrared light emitting unit to output a control command for controlling the predetermined display device.

14. The information processing system according to claim 11, wherein the information processing apparatus transmits a control command to the predetermined display device in a wired or wireless manner, thereby controlling the predetermined display device.

15. The information processing system according to claim 1, wherein, in response to the user performing a predetermined operation, the second image output unit outputs a character input image to the portable display device, the character input image including key images which allow character input.

16. An information processing system, comprising a stationary information processing apparatus and a portable display device allowing a user to perform an input operation, wherein,
the information processing apparatus includes:
a program guide reception unit for receiving data for a television program guide from a predetermined external device via a network;
an operation image output unit for outputting an operation image including the program guide to the portable display device;
an operation data acquisition unit for acquiring operation data from the portable display device, the operation data representing an operation on the operation image; and
a control unit for selecting a program in the program guide included in the operation image on the basis of the operation data, and controlling the predetermined display device to tune in to a channel of the selected program, and
the portable display device includes:
an operation data transmission unit for transmitting data outputted by an operation unit provided in the portable display device as the operation data;
a second image reception unit for receiving the operation image from the information processing apparatus; and
a display unit for displaying the received operation image.

17. The information processing system according to claim 16, wherein the information processing apparatus further includes:
a program acquisition unit for, when the selected program satisfies a predetermined condition, making an acquisition request to the predetermined external device for that program, and acquiring the program via the network; and
a program output unit for, when the selected program is acquired via the network, outputting the program's image and audio to the predetermined display device.

18. An information processing apparatus capable of communicating with a portable display device allowing a user to perform an input operation, the apparatus comprising:
a communication unit connectable to a network and communicating with a predetermined external device via the network;
a first image output unit for outputting an image to a predetermined display device different from the portable display device, the image being included in reception data obtained by the communication unit;
a second image output unit for outputting an operation image to the portable display device, the operation image being used for performing an operation related to the image;
an operation data acquisition unit for acquiring operation data from the portable display device, the operation data representing an operation on the operation image; and
an information processing unit for, on the basis of the operation data, executing information processing related to an image displayed on the predetermined display device.

19. An information processing apparatus capable of communicating with a portable display device allowing a user to perform an input operation, the apparatus comprising:
a program guide reception unit for receiving data for a television program guide from a predetermined external device via a network;
an operation image output unit for outputting an operation image including the program guide to the portable display device, thereby displaying the operation image;
an operation data acquisition unit for acquiring operation data from the portable display device, the operation data representing an operation on the operation image; and
a control unit for selecting a program in the program guide included in the operation image on the basis of the operation data, and controlling the predetermined display device to tune in to a channel of the selected program.

20. A non-transitory computer-readable storage medium having stored therein an information processing program to be executed by a computer of an information processing apparatus capable of communicating with a portable display device allowing a user to perform an input operation, the information processing program causing the computer to perform:
communication with a predetermined external device via a network to which the information processing apparatus is connectable;
outputting an image to a predetermined display device different from the portable display device, the image being included in reception data obtained by the information processing apparatus via the network;
outputting an operation image to the portable display device, the operation image being used for performing an operation related to the image;
acquiring operation data from the portable display device, the operation data representing an operation on the operation image; and
executing information processing related to an image displayed on the predetermined display device on the basis of the operation data.

21. A non-transitory computer-readable storage medium having stored therein an information processing program to be executed by a computer of an information processing apparatus capable of communicating with a portable display device allowing a user to perform an input operation, the information processing program causing the computer to perform:
acquiring data for a television program guide from a predetermined external device via a network;
outputting an operation image including the program guide to the portable display device;
acquiring operation data from the portable display device, the operation data representing an operation on the operation image; and
selecting a program in the program guide included in the operation image on the basis of the operation data, and controlling the predetermined display device to tune in to a channel of the selected program.

22. An image display method to be performed in an information processing system including a stationary information processing apparatus and a portable display device allowing a user to perform an input operation, wherein,
the information processing apparatus performs:
outputting an image to a predetermined display device different from the portable display device, the image being included in reception data obtained by a predetermined external device via a network to which the information processing apparatus is connectable;
outputting an operation image to the portable display device, the operation image being used for performing an operation related to the image;
acquiring operation data from the portable display device, the operation data representing an operation on the operation image; and
executing information processing related to an image displayed on the predetermined display device on the basis of the operation data, and
the portable display device performs:
transmitting data outputted by an operation unit provided in the portable display device as the operation data;
receiving the operation image from the information processing apparatus; and
displaying the received operation image.

23. An image display method to be performed in an information processing system including a stationary information processing apparatus and a portable display device allowing a user to perform an input operation, wherein,
the information processing apparatus performs:
receiving data for a television program guide from a predetermined external device via a network;
outputting an operation image including the program guide to the portable display device;
acquiring operation data from the portable display device, the operation data representing an operation on the operation image; and
selecting a program in the program guide included in the operation image on the basis of the operation data, and controlling the predetermined display device to tune in to a channel of the selected program, and
the portable display device performs:
transmitting data outputted by an operation unit provided in the portable display device as the operation data;
receiving the operation image from the information processing apparatus; and
displaying the received operation image.
